(19) United States
(12) Patent Application Publication
(10) Pub. No.: US 2025/0091833 A1
(43) Pub. Date: Mar. 20, 2025

(54) WEB POSITION TRACKING

(71) Applicant: IBS AUSTRIA GMBH, Teufenbach-Katsch (AT)

(72) Inventors: Juha REUNANEN, North Vancouver, British Columbia (CA); Colin Peter BRIDGE, North Vancouver, British Columbia (CA)

(21) Appl. No.: 18/716,472

(22) PCT Filed: Dec. 8, 2022
(86) PCT No.: PCT/CA2022/051791

§ 371 Date: Jun. 4, 2024

Related U.S. Application Data
(60) Provisional application No. 63/287,675, filed on Dec. 9, 2021.

(51) Int. Cl. B65H 26/02; B65H 43/08

(52) U.S. Cl. CPC B65H 26/02; B65H 43/08; B65H 2553/42; B65H 2801/84

(57) ABSTRACT

A method for facilitating web position tracking is disclosed. The method involves receiving a representation of a plurality of first-stage anomaly locations representing locations of anomalies detected on a web at a first web processing stage, receiving a representation of a plurality of second-stage anomaly locations representing locations of anomalies detected on the web at a second web processing stage, for each of a plurality of different candidate location offsets: comparing the candidate location offset to the plurality of first-stage anomaly locations and the plurality of second-stage anomaly locations to determine a representation of a difference to be associated with the candidate location offset; and associating the representation of the difference with the candidate location offset, and identifying a determined location offset from the candidate location offsets based at least in part on the representations of the differences. Other methods, systems, and computer-readable media are disclosed.

### CROSS REFERENCES

This application claims the benefit of U.S. provisional patent application No. 63/287,675 entitled “WEB POSITION TRACKING”, filed on Dec. 9, 2021, which is hereby incorporated by reference herein in its entirety.

### BACKGROUND

### 1. Field

Embodiments of the present disclosure relate to position tracking and more particularly to facilitating web position tracking.

### 2. Description of Related Art

Web position tracking, such as, in paper mills or paper board producing plants, is important for web processing. For example, accurate web position tracking during unwinding and rewinding of a web on a winder machine may be helpful for identification and fixing of defects in the web during processing. Some known systems for web position tracking may use ink or laser markers adding code to the web at regular intervals and then later reading the code as representative of a position on the web. However, such systems may be messy, costly, dangerous, and/or may require continuous maintenance.

### SUMMARY

In accordance with various embodiments, there is provided a method for facilitating web position tracking, the method involving receiving a representation of a plurality of first-stage anomaly locations representing locations of anomalies detected on a web at a first web processing stage, receiving a representation of a plurality of second-stage anomaly locations representing locations of anomalies detected on the web at a second web processing stage, and for each of a plurality of different candidate location offsets: comparing the candidate location offset to the plurality of first-stage anomaly locations and the plurality of second-stage anomaly locations to determine a representation of a difference to be associated with the candidate location offset, and associating the representation of the difference with the candidate location offset. The method involves identifying a determined location offset from the candidate location offsets based at least in part on the representations of the differences.

Comparing the candidate location offset to the plurality of first-stage anomaly locations and the plurality of second-stage anomaly locations may involve applying the candidate location offset to the plurality of first-stage anomaly locations to determine a plurality of offset first-stage anomaly locations, and determining the difference between the plurality of offset first-stage anomaly locations and the plurality of second-stage anomaly locations.

Determining the difference may involve determining a respective offset difference for each of the plurality of offset first-stage anomaly locations.

Applying the candidate location offset may involve, for each of the plurality of first-stage anomaly locations, determining at least one candidate offset distance adjusted based on a location of the first-stage anomaly location and adding the at least one candidate offset distance to the first-stage anomaly location.

Comparing the candidate location offset to the plurality of first-stage anomaly locations and the plurality of second-stage anomaly locations may involve applying the candidate location offset to the plurality of second-stage anomaly locations to determine a plurality of offset second-stage anomaly locations, and determining the difference between the plurality of offset second-stage anomaly locations and the plurality of first-stage anomaly locations.

Determining the difference may involve determining a respective offset difference for each of the plurality of offset second-stage anomaly locations.

Applying the candidate location offset may involve, for each of the plurality of second-stage anomaly locations, determining at least one candidate offset distance adjusted based on a location of the second-stage anomaly location and adding the at least one candidate offset distance to the second-stage anomaly location.

Comparing the candidate location offset to the plurality of first-stage anomaly locations and the plurality of second-stage anomaly locations may involve, for each of the offset differences, determining a respective weighted offset difference based on the offset difference and an anomaly weight associated with the offset difference.

The method may involve, for each of the offset differences, determining the respective associated anomaly weight based on a severity of an anomaly from which the associated offset difference was determined.

Receiving the representation of the plurality of second-stage anomaly locations may involve receiving a representation of a plurality of candidate second-stage anomaly locations and determining the plurality of second-stage anomaly locations as a subset of the plurality of candidate second-stage anomaly locations.

Determining the plurality of second-stage anomaly locations may involve ranking the plurality of candidate second-stage anomaly locations and choosing the subset as one or more highest ranking candidate second-stage anomaly locations.

Ranking the plurality of candidate second-stage anomaly locations may involve ranking each of the plurality of candidate second-stage anomaly locations based at least in part on a proximity of the second-stage anomaly location to a location of the web currently at the second web processing stage.

Ranking the plurality of candidate second-stage anomaly locations may involve ranking each of the plurality of candidate second-stage anomaly locations based at least in part on a severity of an anomaly associated with the candidate second-stage anomaly location.

The second web processing stage may be downstream of the first web processing stage.

Identifying the determined location offset may involve identifying a candidate location offset of the plurality of candidate location offsets that is associated with a smallest one of the representations of the differences.

Receiving the representation of the plurality of first-stage anomaly locations may involve receiving one or more sets of first-stage images of the web at the first web processing stage, and determining the plurality of first-stage anomaly locations based at least in part on application of at least one first-stage anomaly identifying sensitivity to the one or more sets of first-stage images.

The one or more sets of first-stage images may include a first set of first-stage images and a second set of first-stage images and the at least one first-stage anomaly identifying sensitivity may include a first first-stage anomaly identifying sensitivity and a second first-stage anomaly identifying sensitivity, the second first-stage anomaly identifying sensitivity being different from the first first-stage anomaly identifying sensitivity. Determining the plurality of first-stage anomaly locations may involve determining a first set of first-stage anomaly locations based at least in part on application of the first first-stage anomaly identifying sensitivity to the first set of first-stage images, and determining a second set of first-stage anomaly locations based at least in part on application of the second first-stage anomaly identifying sensitivity to the second set of first-stage images.

Each of the first and second first-stage anomaly identifying sensitivities may include a plurality of anomaly identifying thresholds, each associated with a respective pixel position.

The method may involve determining at least one anomaly density associated with the first first-stage anomaly identifying sensitivity and determining the second first-stage anomaly identifying sensitivity based at least in part on the at least one anomaly density associated with the first first-stage anomaly identifying sensitivity and the first first-stage anomaly identifying sensitivity.

Determining the at least one anomaly density may involve determining a count of anomalies represented by the first set of the plurality of first-stage anomaly locations.

Determining the at least one anomaly density may involve determining at least one count of anomalous pixels included in anomalies represented by the first set of the plurality of first-stage anomaly locations.

The method may involve determining at least one difference between the at least one anomaly density associated with the first first-stage anomaly identifying sensitivity and a desired first-stage anomaly density and determining the second first-stage anomaly identifying sensitivity may involve determining the second first-stage anomaly identifying sensitivity based at least in part on the determined at least one difference.

Receiving the representation of the plurality of second-stage anomaly locations may involve receiving one or more sets of second-stage images of the web at the second web processing stage, and determining the plurality of second-stage anomaly locations based at least in part on application of at least one second-stage anomaly identifying sensitivity to the one or more sets of second-stage images. The one or more sets of second-stage images include a first set of second-stage images and a second set of second-stage images and the at least one second-stage anomaly identifying sensitivity may include a first second-stage anomaly identifying sensitivity and a second second-stage anomaly identifying sensitivity. Determining the plurality of second-stage anomaly locations may involve determining a first set of second-stage anomaly locations based at least in part on application of the first second-stage anomaly identifying sensitivity to the first set of second-stage images, and determining a second set of second-stage anomaly locations based at least in part on application of the second second-stage anomaly identifying sensitivity to the second set of second-stage images. The method may involve determining at least one anomaly density associated with the first second-stage anomaly identifying sensitivity and determining the second second-stage anomaly identifying sensitivity based at least in part on the at least one anomaly density associated with the first second-stage anomaly identifying sensitivity and the first second-stage anomaly identifying sensitivity. The method may involve determining a difference between the at least one anomaly density associated with the first second-stage anomaly identifying sensitivity and a desired second-stage anomaly density, the desired second-stage anomaly density being less than 90% of the desired first-stage anomaly density. Determining the second second-stage anomaly identifying sensitivity may involve determining the second second-stage anomaly identifying sensitivity based at least in part on the determined difference between the at least one anomaly density associated with the first second-stage anomaly identifying sensitivity and the desired second-stage anomaly density.

Determining the at least one anomaly density associated with the first second-stage anomaly identifying sensitivity may involve determining a count of anomalous pixels included in anomalies represented by the first set of the plurality of second-stage anomaly locations.

Determining the at least one anomaly density associated with the first second-stage anomaly identifying sensitivity may involve determining a count of anomalies represented by the first set of the plurality of second-stage anomaly locations.

Each of the first and second second-stage anomaly identifying sensitivities may include a plurality of anomaly identifying thresholds, each associated with a respective pixel position.

Receiving the representation of the plurality of second-stage anomaly locations may involve receiving one or more sets of second-stage images of the web at the second web processing stage, and determining the plurality of second-stage anomaly locations based at least in part on application of at least one second-stage anomaly identifying sensitivity to the one or more sets of second-stage images.

The one or more sets of second-stage images may include a first set of second-stage images and a second set of second-stage images and the at least one second-stage anomaly identifying sensitivity may include a first second-stage anomaly identifying sensitivity and a second second-stage anomaly identifying sensitivity, the second second-stage anomaly identifying sensitivity being different from the first second-stage anomaly identifying sensitivity. Determining the plurality of second-stage anomaly locations may involve determining a first set of second-stage anomaly locations based at least in part on application of the first second-stage anomaly identifying sensitivity to the first set of second-stage images, and determining a second set of second-stage anomaly locations based at least in part on application of the second second-stage anomaly identifying sensitivity to the second set of second-stage images.

Determining at least one anomaly density associated with the first second-stage anomaly identifying sensitivity and determining the second second-stage anomaly identifying sensitivity based at least in part on the at least one anomaly density associated with the first second-stage anomaly identifying sensitivity and the first second-stage anomaly identifying sensitivity.

Determining the at least one anomaly density may involve determining a count of anomalies represented by the first set of the plurality of second-stage anomaly locations.

Determining the at least one anomaly density may involve determining at least one count of anomalous pixels included in anomalies represented by the first set of the plurality of second-stage anomaly locations.

The method may involve determining at least one difference between the at least one anomaly density associated with the first second-stage anomaly identifying sensitivity and a desired second-stage anomaly density and determining the second second-stage anomaly identifying sensitivity may involve determining the second second-stage anomaly identifying sensitivity based at least in part on the determined at least one difference.

Each of the first and second first-stage anomaly identifying sensitivities may include a plurality of anomaly identifying thresholds, each associated with a respective pixel position.

The method may involve receiving a calibration set of first-stage images of the web at the first web processing stage, determining at least one first-stage calibration anomaly density based at least in part on application of a first-stage calibration anomaly identifying sensitivity to the calibration set of first-stage images, and determining a calibration-based first-stage anomaly identifying sensitivity based at least in part on the first-stage calibration anomaly identifying sensitivity and the at least one first-stage calibration anomaly density.

Determining the at least one first-stage calibration anomaly density may involve determining a first-stage calibration set of anomaly locations based at least in part on application of the calibration first-stage anomaly identifying sensitivity to the calibration set of first-stage images, and determining a count of anomalies represented by the first-stage calibration set of anomaly locations.

Determining the at least one first-stage calibration anomaly density may involve determining a count of anomalous pixels included in anomalies included in the calibration set of first-stage images.

Each of the first-stage calibration anomaly identifying sensitivity and the calibration-based first-stage anomaly identifying sensitivities may include a plurality of anomaly identifying thresholds, each associated with a respective pixel position.

Determining the calibration-based first-stage anomaly identifying sensitivity may involve determining at least one difference between the at least one first-stage calibration anomaly density and a desired first-stage calibration anomaly density and determining the calibration-based first-stage anomaly identifying sensitivity based at least in part on the determined at least one difference.

The first set of first-stage images may include at least one of the calibration set of first-stage images.

The first set of first-stage images and the calibration set of first-stage images may be the same images.

The method may involve receiving a representation of one or more detected first-stage defect locations representing locations of defects detected on the web at the first web processing stage, receiving a representation of a sensed second-stage location of the web at the second web processing stage, the sensed second-stage location representing a current location of the web at the second web processing stage, determining a defect proximity of the sensed second-stage location to at least one of the defects based on the determined location offset, the sensed second-stage location of the web, and the one or more detected first-stage defect locations, and producing signals to cause processing at the second web processing stage to be adjusted if the determined defect proximity meets threshold criteria.

Determining the defect proximity may involve applying the determined location offset to the one or more detected first-stage defect locations to determine one or more predicted second-stage defect locations representing locations of defects predicted for the web at the second web processing stage and comparing the one or more predicted second-stage defect locations to the sensed second-stage location.

Determining the defect proximity may involve applying the determined location offset to the sensed second-stage location to determine an offset sensed location and comparing the one or more detected first-stage defect locations to the offset sensed location

In accordance with various embodiments, there is provided a system for facilitating web position tracking, the system including at least one processor configured to perform any of the above methods.

In accordance with various embodiments, there is provided a non-transitory computer-readable medium having stored thereon codes that when executed by at least one processor cause the at least one processor to perform any of the above methods.

Other aspects and features of embodiments of the present disclosure will become apparent to those ordinarily skilled in the art upon review of the following description of specific embodiments of the present disclosure in conjunction with the accompanying figures.

### BRIEF DESCRIPTION OF THE DRAWINGS

In drawings which illustrate embodiments of the present disclosure,

FIG. 1 is a schematic view of a system for facilitating web position tracking, according to various embodiments;

FIG. 2 is a schematic view of a position tracker of the system shown in FIG. 1, including a processor circuit, in accordance with various embodiments;

FIG. 3 is a schematic view of a first anomaly detector of the system shown in FIG. 1, including a processor circuit, in accordance with various embodiments;

FIG. 4 is a schematic view of a second anomaly detector of the system shown in FIG. 1, including a processor circuit, in accordance with various embodiments;

FIG. 5 is a flowchart depicting blocks of code for directing the position tracker shown in FIG. 2 to perform facilitating web position tracking functions, in accordance with various embodiments;

FIG. 6 is a flowchart depicting blocks of code for directing the first anomaly detector shown in FIG. 3 to perform facilitating anomaly detection for web position tracking functions, in accordance with various embodiments;

FIG. 7 is a representation of a first-stage image received by the first anomaly detector shown in FIG. 3, in accordance with various embodiments;

FIG. 8 is a representation of first-stage anomaly location record that may be used in the system shown in FIG. 1, in accordance with various embodiments;

FIG. 9 is a flowchart depicting blocks of code that may be included in the flowchart shown in FIG. 6, in accordance with various embodiments;

FIG. 10 is a flowchart depicting blocks of code for directing the second anomaly detector shown in FIG. 3 to perform facilitating anomaly detection for web position tracking functions, in accordance with various embodiments;

FIG. 11 is a representation of a second-stage image received by the second anomaly detector shown in FIG. 4, in accordance with various embodiments;

FIG. 12 is a representation of a second-stage anomaly location record that may be used in the system shown in FIG. 1, in accordance with various embodiments;

FIG. 13 is a representation of a second-stage anomaly location record that may be used in the system shown in FIG. 1, in accordance with various embodiments;

FIG. 14 is a representation of a candidate location offset record that may be used in the system shown in FIG. 1, in accordance with various embodiments;

FIG. 15 is a flowchart depicting blocks of code that may be included in the flowchart shown in FIG. 5, in accordance with various embodiments;

FIG. 16 is a representation of an offset first-stage anomaly location record may be used in the system shown in FIG. 1, in accordance with various embodiments;

FIG. 17 is a representation of a candidate location offset differences record may be used in the system shown in FIG. 1, in accordance with various embodiments;

FIG. 18 is a representation of a candidate location offset record that may be used in the system shown in FIG. 1, in accordance with various embodiments;

FIG. 19 is a representation of a candidate location offset record that may be used in the system shown in FIG. 1, in accordance with various embodiments;

FIG. 20 is a representation of a determined location offset record that may be used in the system shown in FIG. 1, in accordance with various embodiments;

FIG. 21 is a representation of a determined location offset record that may be used in the system shown in FIG. 1, in accordance with various embodiments;

FIG. 22 is a flowchart depicting blocks of code that may be executed by the position tracker after or during execution of the flowchart shown in FIG. 5, in accordance with various embodiments;

FIG. 23 is a representation of a detected defect location record that may be used in the system shown in FIG. 1, in accordance with various embodiments;

FIG. 24 is a representation of a predicted defect location record that may be used in the system shown in FIG. 1, in accordance with various embodiments;

FIG. 25 is a flowchart depicting blocks of code that may be executed by the first anomaly detector shown in FIG. 3, in accordance with various embodiments; and

FIG. 26 is a representation of a first-stage calibration anomaly location record that may be used in the system shown in FIG. 1, in accordance with various embodiments.

FIG. 27 is a schematic view of a system for facilitating web position tracking, according to various embodiments;

FIG. 28 is a schematic view of a position tracker of the system shown in FIG. 27, including a processor circuit, in accordance with various embodiments;

FIG. 29 is a schematic view of a first anomaly detector of the system shown in FIG. 27, including a processor circuit, in accordance with various embodiments;

FIG. 30 is a schematic view of a second anomaly detector of the system shown in FIG. 27, including a processor circuit, in accordance with various embodiments;

FIG. 31 is a flowchart depicting blocks of code for directing the position tracker shown in FIG. 28 to perform facilitating web position tracking functions, in accordance with various embodiments;

FIG. 32 is a flowchart depicting blocks of code for directing the first anomaly detector shown in FIG. 29 to perform facilitating anomaly detection for web position tracking functions, in accordance with various embodiments;

FIG. 33 is a representation of a first-stage anomaly threshold record that may be used in the system shown in FIG. 27, in accordance with various embodiments;

FIG. 34 is a representation of an updated first-stage anomaly density record that may be used in the system shown in FIG. 27, in accordance with various embodiments;

FIG. 35 is a representation of a first-stage anomaly threshold record that may be used in the system shown in FIG. 27, in accordance with various embodiments;

FIG. 36 is a flowchart depicting blocks of code for directing the second anomaly detector shown in FIG. 29 to perform facilitating anomaly detection for web position tracking functions, in accordance with various embodiments;

FIG. 37 is a depiction of a block of code that may be included in the flowchart shown in FIG. 36, in accordance with various embodiments;

FIG. 38 is a representation of second-stage anomaly location severity record that may be used in the system shown in FIG. 1, in accordance with various embodiments;

FIG. 39 is a representation of second-stage anomaly location severity record that may be used in the system shown in FIG. 1, in accordance with various embodiments;

FIG. 40 is a depiction of blocks of code that may be included in the flowchart shown in FIG. 31, in accordance with various embodiments;

FIG. 41 is a depiction of blocks of code that may be included in the flowchart shown in FIG. 31, in accordance with various embodiments;

FIG. 42 is a representation of a candidate location offset record that may be used in the system shown in FIG. 27, in accordance with various embodiments;

FIG. 43 is a representation of an offset second-stage anomaly location record may be used in the system shown in FIG. 27, in accordance with various embodiments;

FIG. 44 is a representation of a candidate location offset differences record may be used in the system shown in FIG. 27, in accordance with various embodiments;

FIG. 45 is a representation of a weighted candidate location offset differences record may be used in the system shown in FIG. 27, in accordance with various embodiments;

FIG. 46 is a representation of a candidate location offset record that may be used in the system shown in FIG. 27, in accordance with various embodiments;

FIG. 47 is a representation of a determined location offset record that may be used in the system shown in FIG. 27, in accordance with various embodiments; and

FIG. 48 is a flowchart depicting blocks of code that may be executed by the position tracker after or during execution of the flowchart shown in FIG. 31, in accordance with various embodiments;

### DETAILED DESCRIPTION

Basic functions at web processing facilities, such as, for example, paper mills, may include processing, such as, paper production on a paper machine, where a portion of a web is wound up in large reels, and subsequently unwound and cut into smaller rolls, which may be rewound and may represent end products that are delivered to customers. In various embodiments, a web inspection system installed on the paper machine may detect defects such as holes and other defects, together with their web positions, and it may be important for the end product quality that the largest holes and other major defects be removed or patched between unwinding and rewinding of the web. In various embodiments, to facilitate this, the web position of a reel may be tracked during unwinding or converting so that previously identified defects may be predicted. In various embodiments, tracking the web position accurately may be difficult for various reasons including, for example, that operators may remove from a reel an unknown amount of product (e.g., tens or hundreds of meters).

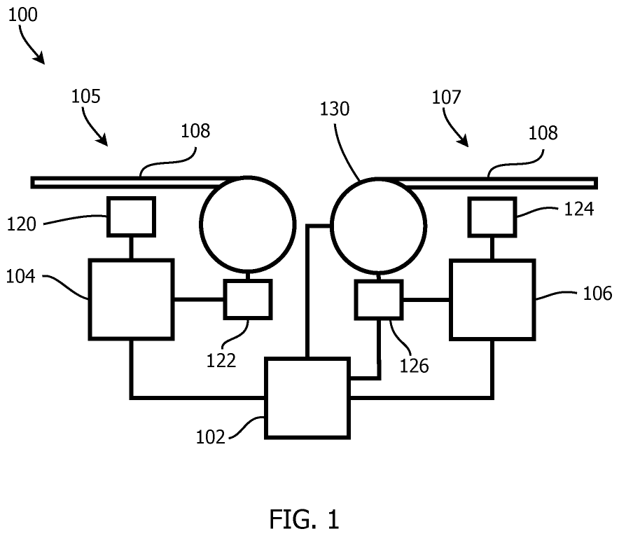

Referring to FIG. 1, there is provided a schematic view of a system 100 for facilitating web position tracking in accordance with various embodiments. The system 100 includes a position tracker 102 in communication with a first anomaly detector 104 and a second anomaly detector 106. In some embodiments, the first and second anomaly detectors 104 and 106 may be configured to detect or sense anomalies in a web or portion of a web 108 at first and second web processing stages 105 and 107, respectively. In various embodiments, the web 108 may be a portion of a larger web that is wound onto a reel at the first web processing stage 105. In various embodiments, while the web 108 is shown, for illustrative purposes, at both the first and second web processing stages 105 and 107 in FIG. 1, it will be understood that the web 108 may first be at the first web processing stage 105 and then after processing is complete at the first web processing stage, the web 108 may be moved to the second web processing stage 107. Accordingly, in various embodiments, the second web processing stage may be downstream of the first web processing stage.

In some embodiments, the anomalies sensed at the first and second web processing stages 105 and 107 may each represent minor imperfections in the web 108 and combined they may represent a unique fingerprint or anomaly location or position map of the web 108. In various embodiments, matching the fingerprint or anomaly location map at the first and second web processing stages 105 and 107 may facilitate tracking of positions at the second web processing stage 107 relative to positions sensed at the first web processing stage.

In some embodiments, the first anomaly detector 104 may be in communication with one or more first cameras 120 configured to image the web 108 while the web is being rolled onto a reel during paper production on a paper machine, which may act as the first web processing stage 105. In various embodiments, the first anomaly detector 104 may be in communication with a first location sensor 122 (such as for example, a rotary encoder configured to sense a roller position or a device that may estimate position by integrating a speed measurement, such as a tachometer reading), configured to sense a machine-direction web location or position to be associated with each of the images obtained by the one or more first cameras 120 of the first anomaly detector. In various embodiments, the machine-direction position may represent a position along the length of the web 108. In various embodiments, the machine-direction position may generally increase over time during processing of the web 108 at the first web processing stage 105. In various embodiments, the increasing machine-direction position may periodically be reset to zero, for example when a reel is completed on a paper machine, and/or rolling the paper onto a new reel is started. In various embodiments, the machine-direction position from just before the reset may be stored, such that it may later be available as an estimate of the total length of the web 108.

In some embodiments, the second anomaly detector 106 may be in communication with one or more second cameras 124 configured to image the web 108 during unwinding, which may act as the second web processing stage 107. In various embodiments, the second anomaly detector 106 may be in communication with a second location sensor 126 (which may be generally similar to the first location sensor 122 included in the first anomaly detector 104, for example), configured to sense a machine-direction web location or position to be associated with each of the images obtained by the one or more second cameras 124. In various embodiments, the position tracker 102 may be in communication with the second location sensor 126, such that the position tracker 102 may be configured to track a current web location at the second web processing stage 107.

In some embodiments, the system 100 may include a web processing driver 130 in communication with the position tracker 102. In various embodiments, the web processing driver 130 may be configured to control processing speed or movement of the web 108 in the second web processing stage 107. In some embodiments, the web processing driver 130 may include a programmable logic controller (PLC), for example.

In various embodiments, the position tracker 102 may be configured to facilitate web position tracking of the web 108 such that locations of features, such as, for example, defects or major defects, detected at the first web processing stage 105 can be converted into expected locations of the features at the second web processing stage 107. Accordingly, in various embodiments, the position tracker 102 may facilitate prediction of upcoming features during processing at the second web processing stage 107 based on their previous detection at the first web processing stage 105 and this predictive capability may facilitate improved processing of the web 108 using the system 100. In various embodiments, whereas anomalies as described herein may be numerous and represent minor imperfections, defects described herein may be less common and may represent features that may be relevant from a product quality point of view, such as, for example, grading of eventual paper rolls. In various embodiments, defects described herein may include defects that may represent features for which processing may need to be adjusted, such as, to allow fixing or removing of the defects.

Referring to FIG. 1, in various embodiments, the position tracker 102 may be configured to receive a representation of first-stage anomaly locations representing locations of anomalies detected on the web 108 at the first web processing stage 105. In various embodiments, the position tracker 102 may be configured to receive the representation of the first-stage anomaly locations from the first anomaly detector 104, and to store the first-stage anomaly locations in memory. In some embodiments, the anomalies may have been sensed during processing of the web 108 at the first web processing stage 105.

In some embodiments, the first anomaly detector 104 may be configured to receive from the one or more first cameras 120, one or more sets of first-stage images of the web 108 at the first web processing stage 105. In various embodiments, the first anomaly detector 104 may be configured to receive from the first location sensor 122, respective associated machine-direction positions for each image received. In various embodiments, the first anomaly detector 104 may be configured to identify anomalies in the images and to determine locations for each anomaly. In various embodiments, the location for each anomaly may include a machine-direction position and a cross-direction position. In various embodiments, the machine-direction position may represent a position along the length of the web 108 and the cross-direction may represent a position across or along a width of the web 108. In various embodiments, the machine-direction and cross-direction may be perpendicular to one another. In various embodiments, the machine-direction position may be determined based on a pixel location of the anomaly in the image and the associated machine-direction position for the image on which the anomaly was detected, such as, for example, by converting the pixel location to a real-world unit, such as meters, and then summing. In various embodiments, the cross-direction position may be determined based on the pixel location of the anomaly in the image and a calibrated mapping from (usually horizontal) pixel coordinates to real-world (e.g., meter or millimeter based) positions (for example, measured from some fixed zero point, and/or from the web edge(s)).

In various embodiments, the position tracker 102 may be configured to receive a representation of second-stage anomaly locations representing locations of anomalies detected on the web 108 at the second web processing stage 107. In various embodiments, the position tracker 102 may be configured to receive the representation of the second-stage anomaly locations from the second anomaly detector 106, and to store the second-stage anomaly locations in memory. In some embodiments, the anomalies may have been sensed during processing of the web 108 at the second web processing stage 107.

In some embodiments, the second anomaly detector 106 may be configured to receive from the one or more second cameras 124, one or more sets of second-stage images of the web 108 at the second web processing stage 107 and to receive from the second location sensor 126 associated machine-direction positions for each image. In various embodiments, the second anomaly detector 106 may be configured to identify anomalies in the images and to determine locations for each anomaly generally as described above having regard to the first web processing stage 105. In some embodiments, because portions of the web 108 are analyzed in reverse order at the second web processing stage 107 (due to this stage involving an unwinding of the reel that was wound at the first web processing stage 105), whereas machine-direction position may increase over time during imaging of the first web processing stage 105, the anomalies may appear in reverse order at the second web processing stage and the machine-direction position in the second web processing stage may decrease over time during imaging. In various embodiments, the second location sensor 126 may provide increasing machine-direction positions as the web 108 is processed at the second web processing stage and the position tracker 102 may be configured to calculate corresponding decreasing machine-direction positions by subtracting each increasing machine-direction position from an estimate for a total length of the web 108, which may be previously provided or may be sensed at the first web processing stage 105, for example.

In various embodiments, the position tracker 102 may be configured to match up the anomaly location fingerprints or maps from the first and second web processing stages 105 and 107 to determine a location offset that may be applied to the first-stage anomaly locations such that the anomaly location map at the second web processing stage 107 aligns with or matches up with an offset version of a portion of the anomaly location map from the first web processing stage 105.

In various embodiments, the position tracker 102 may be configured to, for each of a plurality of different candidate location offsets, compare the candidate location offset to the first-stage anomaly locations and the second-stage anomaly locations to determine a representation of a difference to be associated with the candidate location offset and associate the representation of the difference with the candidate location offset. For example, in some embodiments, the position tracker 102 may be configured to apply the candidate location offset to the first-stage anomaly locations to determine offset first-stage anomaly locations, determine a difference between the offset first-stage anomaly locations and the second-stage anomaly locations, and associate a representation of the difference with the candidate location offset. Alternatively, in some embodiments, the position tracker 102 may be configured to apply the candidate location offset to the second-stage anomaly locations to determine a plurality of offset second-stage anomaly locations and determine the difference between the offset second-stage anomaly locations and the first-stage anomaly locations.

In various embodiments, trying different candidate location offsets and checking a representation of the difference between the resulting offset anomaly locations and the second-stage anomaly locations may facilitate reduced processing power requirements for arriving at an accurate determined location offset. In some embodiments, the difference may include a distance. In various embodiments, comparing discrete location offsets as applied to Boolean anomalies having associated anomaly locations (either they exist or do not exist) instead of other comparisons such as, for example, quantitative anomaly signals, may facilitate tracking that is not very dependent on specific light conditions, light angles, camera angles, and other factors that may vary between the first and second web processing stages 105 and 107. In various embodiments, it may be advantageous that there may be reduced need for efforts towards making such factors be generally similar between the two processing stages. In various embodiments, comparing discrete location offsets as applied to Boolean anomalies having associated anomaly locations may facilitate less variability depending on changes in the material, such as, for example, where the web 108 is paper, the paper drying between the first and second web processing stages 105 and 107.

In some embodiments, the position tracker 102 may be configured to determine the representation of the difference using a cost function. In various embodiments, the position tracker 102 may be configured to identify a determined location offset based at least in part on the representations of the differences.

In some embodiments, the position tracker 102 may be configured to identify a candidate location offset of the plurality of candidate location offsets that is associated with a smallest one of the representations of the differences. In various embodiments, the identified candidate location offset may be the best offset to use as the determined location offset for position tracking. In various embodiments, the determined location offset may be used to facilitate position tracking of the web at the second web processing stage 107, relative to position tracking at the first web processing stage 105. For example, in some embodiments, the determined location offset may facilitate mapping between locations of the web 108 at the first web processing stage 105 to locations on the web 108 at the second web processing stage 107 and/or vice versa. In some embodiments, the position tracker 102 may be configured to apply or add the determined location offset to locations of features on the web 108 at the first web processing stage 105, to convert the locations of the features at the first web processing stage 105 to updated locations, which correspond to locations of those same features at the second web processing stage 107. In various embodiments, the ability to convert between first web processing stage locations and second web processing stage locations may facilitate adaptive processing of the web 108 at the second web processing stage 107 in view of what has been detected at the first web processing stage.

In some embodiments, the position tracker 102 may be configured to receive a representation of one or more detected first-stage defect locations representing locations of defects detected on the web 108 at the first web processing stage 105 and to receive a representation of a sensed second-stage location of the web 108 at the second web processing stage, the sensed second-stage location representing a current location of the web 108 at the second web processing stage 107. In various embodiments, the position tracker 102 may be configured to determine a defect proximity of the sensed second-stage location to at least one of the defects based on the determined location offset, the sensed second-stage location of the web, and the one or more detected first-stage defect locations and to produce signals to cause processing at the second web processing stage 107 to be adjusted if the determined defect proximity meets threshold criteria. For example, in some embodiments, the threshold criteria may include threshold distance criteria and the defect proximity may meet the threshold criteria if the defect proximity is less than a threshold distance.

In various embodiments, a defect may be a major defect for which processing may need to be adjusted. In some embodiments, the position tracker 102 may be configured to determine the defect proximity by applying the determined location offset to the one or more detected first-stage defect locations to determine one or more predicted second-stage defect locations representing locations of defects predicted for the web at the second web processing stage and comparing the one or more predicted second-stage defect locations to the sensed second-stage location. For example, the position tracker may compare by determining a difference or distance between a closest upcoming one of the one or more predicted second-stage defect locations and the sensed second-stage location. In various embodiments, the position tracker 102 may be configured to produce signals for causing the web processing driver 130 shown in FIG. 1 to slow down when the sensed second-stage location of the web 108 is within a threshold distance in advance of one of the predicted second-stage defect locations. In some embodiments, the position tracker 102 may be configured to produce signals for causing the web processing driver 130 to stop at or before each of the predicted defect locations. In various embodiments, this slowing down and/or stopping may facilitate patching and/or removal of defects from the web 108 at the second web processing stage 107.

### Tracker-Processor Circuit

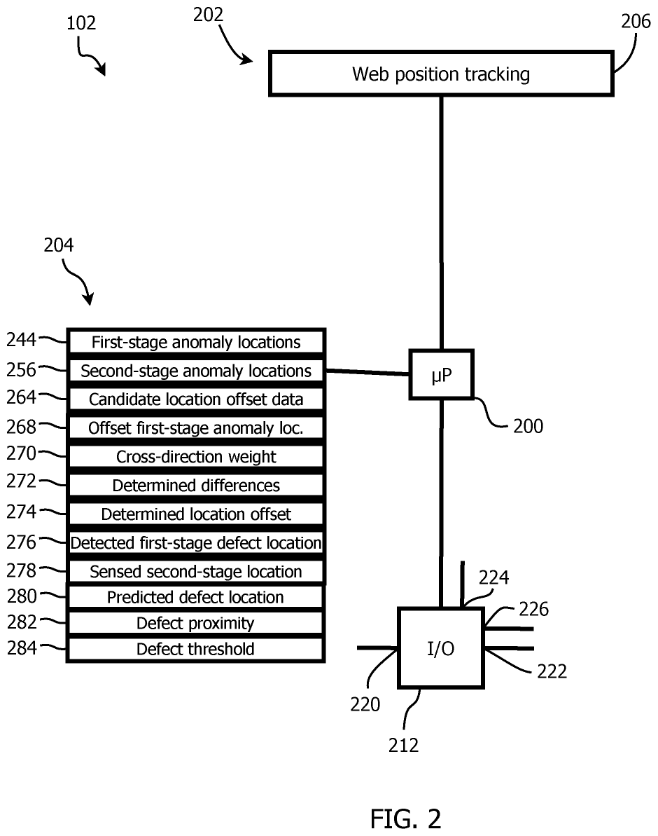

Referring now to FIG. 2, a schematic view of the position tracker 102 of the system 100 shown in FIG. 1 according to various embodiments is shown. Referring to FIG. 2, the position tracker 102 includes a processor circuit including a tracker processor 200 and a program memory 202, a storage memory 204, and an input/output (I/O) interface 212, all of which are in communication with the tracker processor 200. In various embodiments, the tracker processor 200 and/or similar processors disclosed herein may include one or more processing units, such as for example, a central processing unit (CPU), a graphics processing unit (GPU), and/or a field programmable gate array (FPGA). In some embodiments, any or all of the functionality of the position tracker 102 described herein may be implemented using one or more FPGAs.

The I/O interface 212 includes interfaces 220 and 222 for communicating with the first and second anomaly detectors 104 and 106 shown in FIG. 1, respectively. In various embodiments, the I/O interface 212 may include an interface 224 for communicating with the web processing driver 130 shown in FIG. 1 and an interface 226 for communicating with the second location sensor 126. In some embodiments, the I/O interface 212 and/or similar interfaces disclosed herein may include an interface for facilitating networked communication through a network such as a Local Area Network or the Internet and/or one or more interfaces for enabling user input via one or more user interface devices, such as, for example, a pointer and/or keyboard. In some embodiments, any or all of the interfaces and/or similar interfaces disclosed herein may facilitate wireless and/or wired communication. In some embodiments, each of the interfaces and/or similar interfaces disclosed herein may include one or more interfaces and/or some or all of the interfaces may be implemented as combined interfaces or a single interface.

In some embodiments, where a device is described herein as receiving or sending information, it may be understood that the device receives signals representing the information via an interface of the device or produces signals representing the information and transmits the signals to the other device via an interface of the device.

Processor-executable program codes for directing the tracker processor 200 to carry out various functions are stored in the program memory 202. Referring to FIG. 2, the program memory 202 includes a block of codes 206 for directing the position tracker 102 to perform facilitating web position tracking functions. In this specification, it may be stated that certain encoded entities such as applications or modules perform certain functions. Herein, when an application, module or encoded entity is described as taking an action, as part of, for example, a function or a method, it will be understood that at least one processor (e.g., the tracker processor 200) is directed to take the action by way of programmable codes or processor-executable codes or instructions defining or forming part of the application.

The storage memory 204 includes a plurality of storage locations including location 244 for storing first-stage anomaly location data, location 256 for storing second-stage anomaly location data, location 264 for storing candidate location offset data, location 268 for storing offset first-stage anomaly location data, location 270 for storing cross-direction weight data, location 272 for storing determined difference data, location 274 for storing determined location offset data, location 276 for storing detected defect location data, location 278 for storing sensed second-stage location data, location 280 for storing predicted defect location data, location 282 for storing defect proximity data, and location 284 for storing defect threshold data. In various embodiments, the storage locations may be stored in a database in the storage memory 204.

In various embodiments, the block of codes 206 and/or any similar blocks of code disclosed herein may be integrated into a single block of codes or portions of the block of codes 206 may include one or more blocks of code stored in one or more separate locations in the program memory 202. In various embodiments, any or all of the locations 244, 256, 264, and 268-284 and/or any similar locations disclosed herein may be integrated and/or each may include one or more separate locations in the storage memory 204.

Each of the program memory 202 and the storage memory 204 and/or similar memory disclosed herein may be implemented as one or more storage devices including random access memory (RAM), a hard disk drive (HDD), a solid-state drive (SSD), a network drive, flash memory, a memory stick or card, any other form of non-transitory computer-readable memory or storage medium, and/or a combination thereof. In some embodiments, the program memory 202, the storage memory 204, any similar memory disclosed herein, and/or any portion thereof may be included in a device separate from the position tracker 102 and in communication with the position tracker 102 via the I/O interface 212, for example. In some embodiments, the functionality of the tracker processor 200 and/or the position tracker 102 and/or similar processors or devices as described herein may be implemented using a plurality of processors and/or a plurality of devices.

### First Anomaly Detector—Processor Circuit

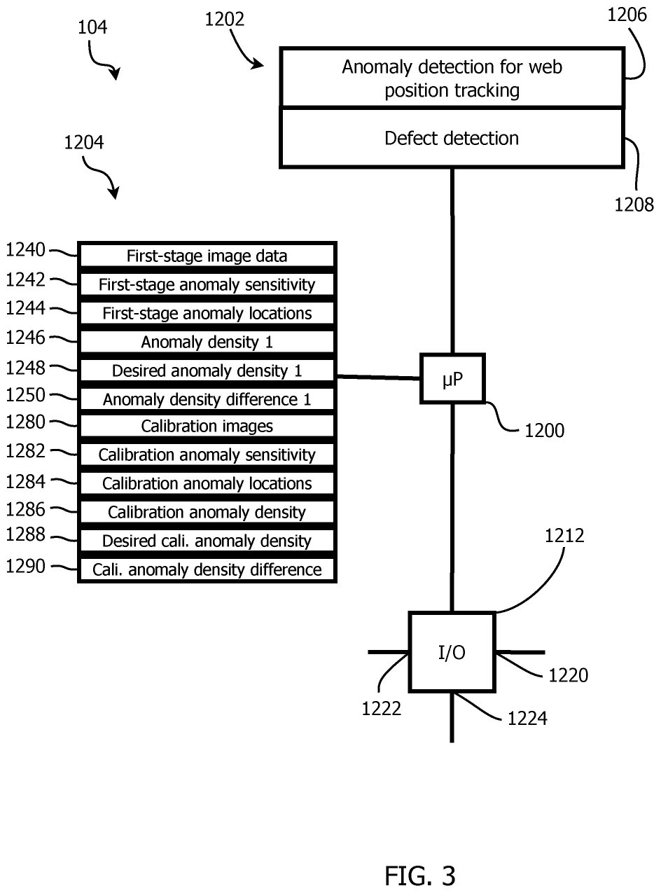

Referring now to FIG. 3, a schematic view of the first anomaly detector 104 of the system 100 shown in FIG. 1 according to various embodiments is shown. Referring to FIG. 3, the first anomaly detector 104 includes a processor circuit including a detector processor 1200 and a program memory 1202, a storage memory 1204, and an input/output (I/O) interface 1212, all of which are in communication with the detector processor 1200. In various embodiments, the detector processor 1200 and/or similar processors disclosed herein may include one or more processing units, such as for example, a central processing unit (CPU), a graphics processing unit (GPU), and/or a field programmable gate array (FPGA). In some embodiments, any or all of the functionality of the first anomaly detector 104 described herein may be implemented using one or more FPGAs.

The I/O interface 1212 includes interfaces 1220 and 1222 for communicating with the one or more first cameras 120 and the first location sensor 122 shown in FIG. 1 and an interface 1224 for communicating with the position tracker 102 shown in FIG. 1. In some embodiments, any or all of the interfaces and/or similar interfaces disclosed herein may facilitate wireless and/or wired communication. In some embodiments, each of the interfaces and/or similar interfaces disclosed herein may include one or more interfaces and/or some or all of the interfaces may be implemented as combined interfaces or a single interface.

Processor-executable program codes for directing the detector processor 1200 to carry out various functions are stored in the program memory 1202. Referring to FIG. 3, the program memory 1202 includes a block of codes 1206 for directing the first anomaly detector 104 to perform facilitating anomaly detection for web position tracking functions and a block of codes 1208 for directing the first anomaly detector 104 to detect defects.

The storage memory 1204 includes a plurality of storage locations including location 1240 for storing first-stage image data, location 1242 for storing first-stage anomaly identifying sensitivity data, location 1244 for storing first-stage anomaly location data, location 1246 for storing first-stage anomaly density data, location 1248 for storing desired first-stage anomaly density data, location 1250 for storing first-stage anomaly density difference data, location 1280 for storing calibration image data, location 1282 for storing calibration anomaly identifying sensitivity data, location 1284 for storing calibration anomaly location data, location 1286 for storing calibration anomaly density data, location 1288 for storing desired calibration anomaly density data, and location 1290 for storing calibration anomaly density difference data. In various embodiments, the storage locations may be stored in a database in the storage memory 1204.

In various embodiments, the block of codes 1206 and/or the block of codes 1208 and/or any similar blocks of code disclosed herein may be integrated into a single block of codes or portions of the block of codes 1206 and/or the block of codes 1208 may include one or more blocks of code stored in one or more separate locations in the program memory 1202. In various embodiments, any or all of the locations 1240-1250 and 1280-1290 and/or any similar locations disclosed herein may be integrated and/or each may include one or more separate locations in the storage memory 1204.

Each of the program memory 1202 and the storage memory 1204 and/or similar memory disclosed herein may be implemented as one or more storage devices including random access memory (RAM), a hard disk drive (HDD), a solid-state drive (SSD), a network drive, flash memory, a memory stick or card, any other form of non-transitory computer-readable memory or storage medium, and/or a combination thereof. In some embodiments, the program memory 1202, the storage memory 1204, any similar memory disclosed herein, and/or any portion thereof may be included in a device separate from the first anomaly detector 104 and in communication with the first anomaly detector 104 via the I/O interface 1212, for example. In some embodiments, the functionality of the detector processor 1200 and/or the first anomaly detector 104 and/or similar processors or devices as described herein may be implemented using a plurality of processors and/or a plurality of devices.

### Second Anomaly Detector—Processor Circuit

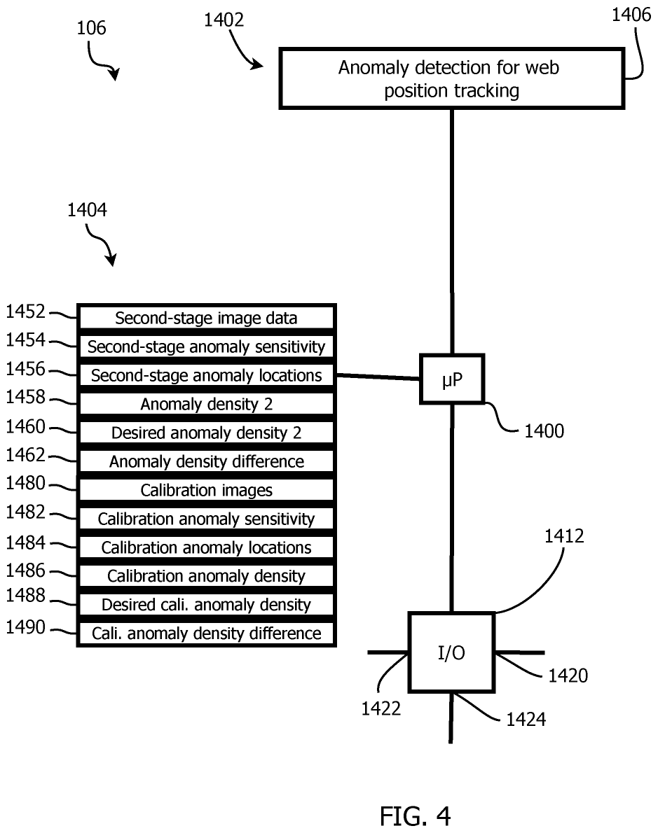

Referring now to FIG. 4, a schematic view of the second anomaly detector 106 of the system 100 shown in FIG. 1 according to various embodiments is shown. In various embodiments, the second anomaly detector 106 may include elements generally similar to those included in the first anomaly detector 104 shown in FIG. 3. Referring to FIG. 4, the second anomaly detector 106 includes a processor circuit including a detector processor 1400 and a program memory 1402, a storage memory 1404, and an input/output (I/O) interface 1412, all of which are in communication with the detector processor 1400. In various embodiments, the detector processor 1400 and/or similar processors disclosed herein may include one or more processing units, such as for example, a central processing unit (CPU), a graphics processing unit (GPU), and/or a field programmable gate array (FPGA). In some embodiments, any or all of the functionality of the second anomaly detector 106 described herein may be implemented using one or more FPGAs.

The I/O interface 1412 includes interfaces 1420 and 1422 for communicating with the one or more second cameras 124 and the second location sensor 126 shown in FIG. 1 and an interface 1424 for communicating with the position tracker 102 shown in FIG. 1. In some embodiments, any or all of the interfaces and/or similar interfaces disclosed herein may facilitate wireless and/or wired communication. In some embodiments, each of the interfaces and/or similar interfaces disclosed herein may include one or more interfaces and/or some or all of the interfaces may be implemented as combined interfaces or a single interface.

Processor-executable program codes for directing the detector processor 1400 to carry out various functions are stored in the program memory 1402. Referring to FIG. 4, the program memory 1402 includes a block of codes 1406 for directing the second anomaly detector 106 to perform facilitating anomaly detection for web position tracking functions.

The storage memory 1404 includes a plurality of storage locations including location 1452 for storing second-stage image data, location 1454 for storing second-stage anomaly identifying sensitivity data, location 1456 for storing second-stage anomaly location data, location 1458 for storing second-stage anomaly density data, location 1460 for storing desired second-stage anomaly density data, location 1462 for storing second-stage anomaly density difference data, location 1480 for storing calibration image data, location 1482 for storing calibration anomaly identifying sensitivity data, location 1484 for storing calibration anomaly location data, location 1486 for storing calibration anomaly density data, location 1488 for storing desired calibration anomaly density data, and location 1490 for storing calibration anomaly density difference data. In various embodiments, the storage locations may be stored in a database in the storage memory 1404.

In various embodiments, the block of codes 1406 and/or any similar blocks of code disclosed herein may be integrated into a single block of codes or portions of the block of codes 1406 may include one or more blocks of code stored in one or more separate locations in the program memory 1402. In various embodiments, any or all of the locations 1452-1462 and 1480-1490 and/or any similar locations disclosed herein may be integrated and/or each may include one or more separate locations in the storage memory 1404.

Each of the program memory 1402 and the storage memory 1404 and/or similar memory disclosed herein may be implemented as one or more storage devices including random access memory (RAM), a hard disk drive (HDD), a solid-state drive (SSD), a network drive, flash memory, a memory stick or card, any other form of non-transitory computer-readable memory or storage medium, and/or a combination thereof. In some embodiments, the program memory 1402, the storage memory 1404, any similar memory disclosed herein, and/or any portion thereof may be included in a device separate from the second anomaly detector 106 and in communication with the second anomaly detector 106 via the I/O interface 1412, for example. In some embodiments, the functionality of the detector processor 1400 and/or the second anomaly detector 106 and/or similar processors or devices as described herein may be implemented using a plurality of processors and/or a plurality of devices.

### Operation

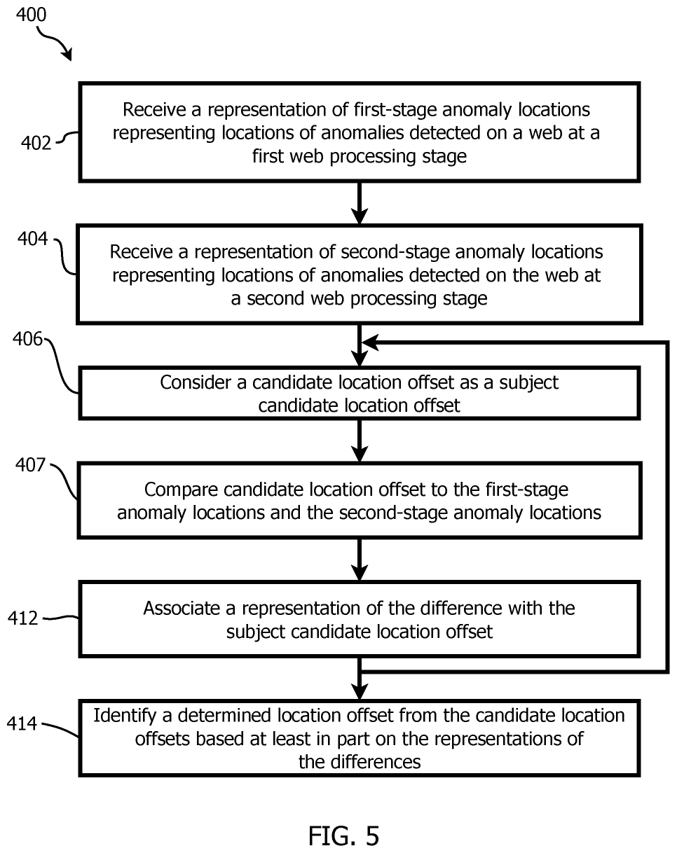

As discussed above, in various embodiments, the position tracker 102 shown in FIGS. 1 and 2 may be configured to facilitate web position tracking. Referring to FIG. 5, a flowchart depicting blocks of code for directing the tracker processor 200 shown in FIG. 2 to perform facilitating web position tracking in accordance with various embodiments is shown generally at 400. In various embodiments, the blocks of code included in the flowchart 400 may be encoded in the block of codes 206 of the program memory 202 shown in FIG. 2.

Referring to FIG. 5, the flowchart 400 begins with block 402, which directs the tracker processor 200 to receive a representation of first-stage anomaly locations representing locations of anomalies detected on a web at a first web processing stage. In some embodiments, block 402 may direct the tracker processor 200 to receive the representation of first-stage anomaly locations from the first anomaly detector 104. In some embodiments, the first anomaly detector 104 may be configured to receive one or more sets of first-stage images and machine-direction position information associated with each of the images, and to analyze the images to determine the first-stage anomaly locations. In some embodiments, the first anomaly detector 104 may be configured to send the representation of the first-stage anomaly locations to the position tracker 102.

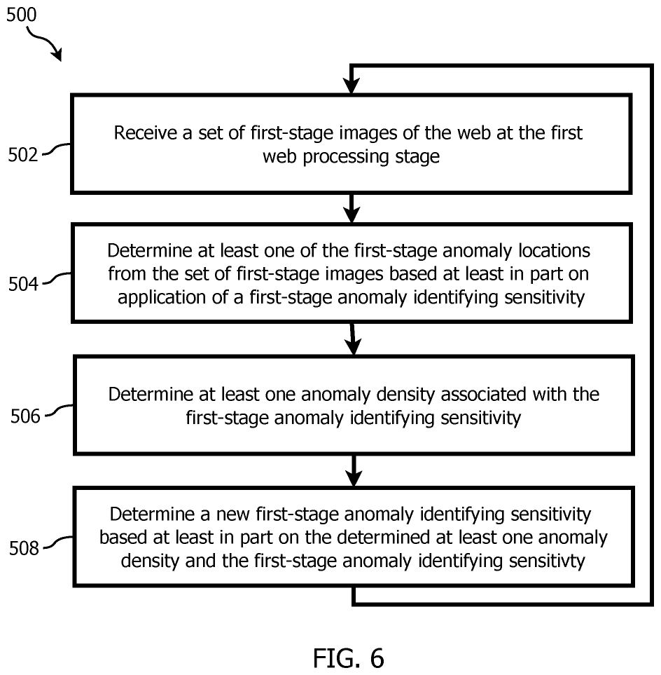

Referring to FIG. 6, a flowchart 500 is shown, depicting blocks of code for directing the detector processor 1200 shown in FIG. 3 to perform facilitating anomaly detection for web position tracking in accordance with various embodiments. In various embodiments, the blocks of code included in the flowchart 500 may be encoded in the block of codes 1206 of the program memory 1202 shown in FIG. 3.

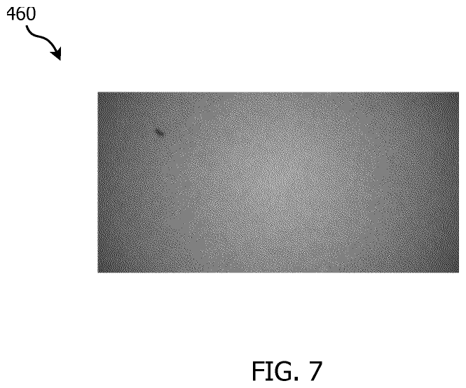

Referring to FIG. 6, the flowchart 500 begins with block 502, which directs the detector processor 1200 to receive a set of first-stage images of the web 108 at the first web processing stage 105. In some embodiments, block 502 may direct the detector processor 1200 to receive, via the interface 1220 of the I/O interface 1212 shown in FIG. 3, the set of first-stage images from the one or more first cameras 120 of the system 100 shown in FIG. 1. In various embodiments, the one or more first cameras 120 may be configured to, during processing at the first web processing stage 105, generate first-stage images of the web 108 at the first web processing stage 105, including a first set of first-stage images representing a first machine-direction length of the web 108, the first set of first-stage images including a first-stage image as shown at 460 in FIG. 7.

In some embodiments, such as for example, when using matrix cameras, the first-stage images may include some redundant or overlapping image areas, to avoid machine-direction gaps in imaging the web 108, and/or to facilitate other functionality such as being able to tell if some anomaly is a defect that moves together with the web, or is a piece of paper that is suspended in the air, for example.

In various embodiments, block 502 may direct the detector processor 1200 to receive the first set of first-stage images including the first-stage image 460 from the one or more first cameras 120 and to store the first set of first-stage images in the location 1240 of the storage memory 1204 shown in FIG. 3. In various embodiments, block 502 may direct the detector processor 1200 to receive an associated machine-direction position from the first location sensor 122 shown in FIG. 1, for each of the images included in the first set of first-stage images and to store the associated machine-direction position in association with each image of the first set of first-stage images stored in the location 1240 of the storage memory 1204.

In some embodiments, the first set of first-stage images received at block 502 may represent a portion of the web 108, such as, for example, a machine-direction length of the web 108. For example, in some embodiments, the first set of first-stage images may represent a first 1000 m of the web 108.

In various embodiments, considering the web 108 one set of images and thus one portion at a time may facilitate adjusting of an anomaly identifying sensitivity for each portion along the length of the web 108. In various embodiments, this may facilitate more consistent observed anomaly density along the machine-direction length of the web 108 despite possibly changing properties of the web along its length, and/or changing imaging conditions (such as, for example, camera housing building up dirt) over time. In various embodiments, this may facilitate better web tracking and/or more consistent and/or accurate determining of a determined location offset record as described below.

Referring to FIG. 6, block 504 directs the detector processor 1200 to determine at least one of the first-stage anomaly locations based at least in part on application of a first-stage anomaly identifying sensitivity to the set of first-stage images. In various embodiments, block 504 may direct the detector processor 1200 to determine a first set of first-stage anomaly locations based on application of a first first-stage anomaly identifying sensitivity to the first set of first-stage images. In various embodiments, the first first-stage anomaly identifying sensitivity may include an anomaly identifying threshold and may be stored in the location 1242 of the storage memory 1204 shown in FIG. 3. In some embodiments, the first first-stage anomaly identifying threshold may have been initialized to a value that may be pre-set and chosen by a user. For example, in some embodiments, the first first-stage anomaly identifying threshold may be set to a value between 1 and 100. In some embodiments, the first first-stage anomaly identifying threshold stored in the location 1242 may be 25, for example.

In various embodiments, block 504 may direct the detector processor 1200 to determine an anomalousness index value for each pixel or pixel location in each of the first set of first-stage images, the anomalousness index value representative of whether there may be an anomaly at the pixel location. In some embodiments, block 504 may direct the detector processor 1200 to identify pixel groups that are associated with an anomalousness index value greater than the first first-stage anomaly identifying threshold stored in the location 1242 of the storage memory 1204. In various embodiments, block 504 may direct the detector processor 1200 to determine the identified pixel groups to represent anomalies. In various embodiments, block 504 may direct the detector processor 1200 to use a combination of a position of the identified pixel groups and the machine-direction position for the image that the pixel groups were identified in to determine a location for each anomaly.

In some embodiments, block 504 may direct the detector processor 1200 to maintain a reference image as a moving average of a field of view. In some embodiments, block 504 may direct the detector processor 1200 to use exponential smoothing or Fair Exponential Smoothing with Small Alpha (FESSA) (as described, for example, in Reunanen, Juha. (2015). Fair Exponential Smoothing with Small Alpha. 10.13140/RG.2.1.2181.1923). In various embodiments, block 504 may direct the detector processor 1200 to, for each image, calculate the difference between the image and the reference image.

In some embodiments, block 504 may direct the detector processor 1200 to calculate the difference as: new pixel value/reference pixel value−1=(new pixel value-reference pixel value)/reference pixel value. In some embodiments, before doing this calculation, block 504 may direct the detector processor 1200 to set the reference pixel values to be strictly positive; for example, by setting reference pixel value=max (reference pixel value; ε), where ε is a small number, e.g. 0.1. In various embodiments, an absolute value of the determined difference may be used as the anomalousness index value. In various embodiments, dividing by the reference pixel value may improve robustness against vignetting, for example.

In various embodiments, block 504 may direct the detector processor 1200 to compare the anomalousness index value to the first first-stage anomaly identifying threshold. Pixels where the anomalousness index value exceeds the first first-stage anomaly identifying threshold may be considered anomalous.

In various embodiments, block 504 may direct the detector processor 1200 to group nearby pixels associated with anomalousness indices that exceed the first first-stage anomaly identifying threshold. In various embodiments, block 504 may direct the detector processor 1200 to calculate a center, and/or a bounding box, and/or a boundary of each group of anomalous pixels, each group acting as a representation of an anomaly. In various embodiments, each center may act as a first-stage anomaly location of the determined first set of first-stage anomaly locations.

In various embodiments, block 504 may direct the detector processor 1200 to determine the center as the center of the bounding box, and/or the center of mass of the pixels that are part of the group. In various embodiments, block 504 may direct the detector processor 1200 to, in the center-of-mass calculation, weight individual pixels by how much they exceeded the first first-stage anomaly identifying threshold level.

In some embodiments, block 504 may direct the detector processor 1200 to classify each group of anomalous pixels using rules. In various embodiments, block 504 may direct the detector processor 1200 to classify based at least in part on size, shape, and pixel value distribution of the anomalous group of pixels. In some embodiments, such class information may be used in a cost function that may be used to determine a location offset and estimate the position in the second web processing stage 107.

In various embodiments, each of the determined anomaly locations may include a machine-direction location and a cross-direction location in meters, for example.

In various embodiments, alternative or additional anomaly identifying processes may be used.

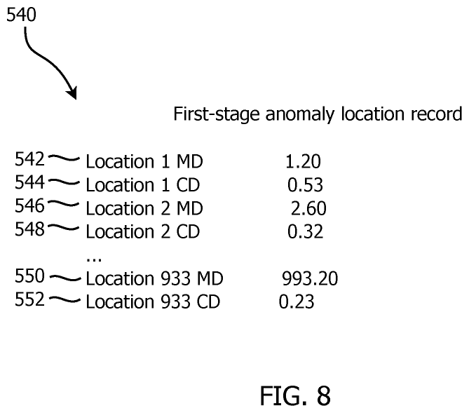

In various embodiments, block 504 may direct the detector processor 1200 to store the determined first set of first-stage anomaly locations in a first-stage anomaly location record 540 as shown in FIG. 8 and to store the first-stage anomaly location record 540 in the location 1244 of the storage memory 1204 shown in FIG. 3. Referring to FIG. 8, the first-stage anomaly location record 540 includes anomaly location fields for storing machine-direction and cross-direction locations for each anomaly. For example, referring to FIG. 8, though not all of the anomaly location fields are shown in FIG. 8, the first-stage anomaly location record 540 may include first-stage anomaly location fields 542 and 544 for storing a machine-direction location and a cross-direction location respectively of a first anomaly, second-stage anomaly location fields 546 and 548 for storing a machine-direction location and a cross-direction location respectively of a second anomaly, and 933rd anomaly location fields 550 and 552 for storing a machine-direction location and a cross-direction location respectively of a 933rd anomaly.

In some embodiments, the flowchart 500 and/or the block 504 may include a block of codes for directing the detector processor 1200 to send a representation of the first-stage anomaly locations to the position tracker 102. For example, in some embodiments, the flowchart 500 may include a block directing the detector processor 1200 to cause signals representing the first-stage anomaly location record 540 shown in FIG. 8 to be transmitted to the position tracker 102 via the interface 1224 of the I/O interface 1212 shown in FIG. 3.

Referring to FIG. 6, in some embodiments, the flowchart 500 may include blocks 506 and 508, which may direct the detector processor 1200 to determine a second first-stage anomaly identifying sensitivity for application to a second set of first-stage images. In various embodiments, the second first-stage anomaly identifying sensitivity may be different from the first first-stage anomaly identifying sensitivity. Referring to FIG. 6, block 506 directs the detector processor 1200 to determine at least one anomaly density associated with the first-stage anomaly identifying sensitivity. In various embodiments, block 506 may direct the detector processor 1200 to determine an anomaly density associated with the first first-stage anomaly identifying sensitivity. In some embodiments, the anomaly density may be an anomaly count density. In various embodiments, the anomaly count density may be determined as anomalies per length of the web 108 or as anomalies per area of the web. In various embodiments, block 506 may direct the detector processor 1200 to determine the anomaly density by counting how many anomalies have been detected within a sampling machine-direction proximity of the most recent image included in the first set of first-stage images. For example, in some embodiments, the sampling machine-direction proximity may be 20,000 meters. Accordingly, in various embodiments, the sampling machine-direction proximity may be greater than the machine-direction length of the portion of the web 108 represented by the first set of first-stage images.

In various embodiments, when the web 108 has been imaged for less than the sampling machine-direction proximity, block 506 may direct the detector processor 1200 to determine the anomaly density based on all first-stage images of the web 108 received. For example, in some embodiments, the first set of first-stage images may be the only first-stage images received by the detector processor 1200 and so block 506 may direct the detector processor 1200 to determine the anomaly density based on the first set of first-stage images.

In various embodiments, block 506 may direct the detector processor 1200 to determine a count of anomalies represented by the first set of first-stage anomaly locations. For example, in some embodiments, block 506 may direct the detector processor 1200 to read the first-stage anomaly location record 540 from the location 1244 of the storage memory 1204 and to determine a count of the locations represented by the first-stage anomaly location record 540.

In various embodiments, where the sampling machine-direction proximity is greater than the machine-direction length represented by the first set of first-stage images, and the location 1244 stores further first-stage anomaly location records, block 506 may direct the detector processor 1200 to add to the count of the locations represented by the first-stage anomaly location record 540, a count of any additional locations represented by anomaly location records wherein the locations are within the sampling machine-direction proximity of the most recent (greatest machine-direction position) image of the first set of first-stage images.

In various embodiments, block 506 may direct the detector processor 1200 to determine the anomaly density by dividing the determined count by the machine-direction length represented by the first-stage images from which the locations were considered, which may in some embodiments, such as where only the first set of first-stage images have been analyzed, be 1000 m, for example. In some embodiments, the anomaly density may be determined by dividing the determined count by the corresponding web area, such as the width of the imaged web 108 integrated over the relevant machine-direction length.

In various embodiments, block 506 may direct the detector processor 1200 to store the determined anomaly density in the location 1246 of the storage memory 1204. For example, in some embodiments, block 506 may direct the detector processor 1200 to store a first anomaly density of 0.933 anomalies per meter of the web 108 in the location 1246 of the storage memory 1204.

Referring to FIG. 6, block 508 directs the detector processor 1200 to determine a new first-stage anomaly identifying sensitivity based at least in part on the determined at least one anomaly density and the first-stage anomaly identifying sensitivity. In various embodiments, block 508 may direct the detector processor 1200 to read the first first-stage anomaly identifying sensitivity and the anomaly density from the locations 1242 and 1246 of the storage memory 1204 and to determine a second first-stage anomaly identifying sensitivity based at least in part on the first first-stage anomaly identifying sensitivity and the first anomaly density. In various embodiments, block 508 may direct the detector processor 1200 to store the second first-stage anomaly identifying sensitivity in the location 1242 of the storage memory 1204.

In various embodiments, block 508 may direct the detector processor 1200 to adjust the anomaly identifying sensitivity such that the second first-stage anomaly identifying sensitivity is more sensitive (and thus a lower threshold value, for example) if fewer anomalies than desired are represented by the first anomaly density or to adjust the anomaly identifying sensitivity such that the second first-stage anomaly identifying sensitivity is less sensitive (and thus a higher threshold, for example) if more anomalies than desired are represented by the first anomaly density.

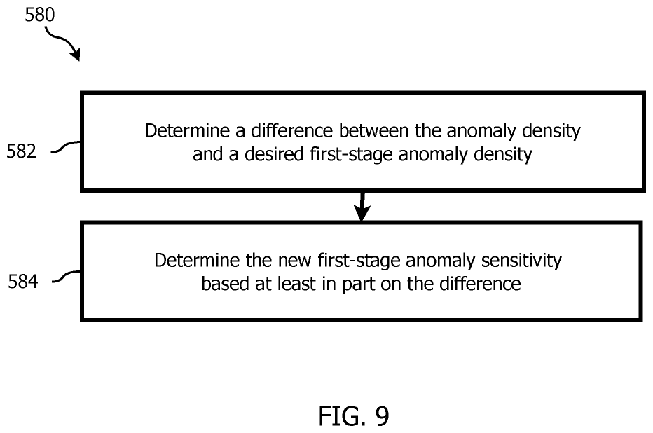

Referring to FIG. 9, there is shown a flowchart 580 depicting blocks of code that may be included in the block 508 of the flowchart 500 shown in FIG. 6, in accordance with various embodiments. The flowchart 580 begins with block 582, which directs the detector processor 1200 to determine a difference between the anomaly density and a desired first-stage anomaly density. In some embodiments, the desired first-stage anomaly density may have been previously set and stored in the location 1248 of the storage memory 1204. In some embodiments, the desired first-stage anomaly density may be set based on a desired anomaly density relative to a machine-direction length, which may facilitate web position tracking using the position tracker 102. For example, in some embodiments, the desired first-stage anomaly density may be 1.000 anomalies per meter of machine-direction length. In various embodiments, the desired first-stage anomaly density may have been previously set by a user and/or may be adjusted, for example, such that enough anomalies are detected for starting to track early, but at the same time not too many anomalies are detected, which might cause processing capacity issues, for example.

Referring to FIG. 9, in various embodiments, block 582 may direct the detector processor 1200 to subtract the desired first-stage anomaly density stored in the location 1248 of the storage memory from the anomaly density stored in the location 1246 of the storage memory 1204 to determine the difference and block 582 may direct the detector processor 1200 to store the difference in the location 1250 of the storage memory 1204.

Referring back to FIG. 9, block 584 of the flowchart 580 may direct the detector processor 1200 to determine the new first-stage anomaly sensitivity based at least in part on the difference determined at block 582. In some embodiments, block 584 may direct the detector processor 1200 to adjust the sensitivity to be more sensitive if fewer anomalies than desired were found and to adjust the sensitivity to be less sensitive if more anomalies than desired were found.

In various embodiments, block 584 of the flowchart 580 may direct the detector processor 1200 to determine the second first-stage anomaly sensitivity based at least in part on the difference determined at block 582. In various embodiments, the first and second first-stage anomaly identifying sensitivities may include first and second first-stage anomaly thresholds and block 584 may direct the detector processor 1200 to determine the second first-stage anomaly threshold using the following equation:

$${T}_{12} = {T}_{11} \cdot exp ( {a}_{1} \cdot {D}_{1} )$$

where T₁₂ is the second first-stage anomaly threshold, T₁₁ is the first first-stage anomaly threshold, a₁ is a scaling factor, and D₁ is a relative difference determined by dividing the difference determined at block 582 and stored in the location 1250 of the storage memory 1204 shown in FIG. 3 by the desired first-stage anomaly density from the location 1248 of the storage memory 1204. In some embodiments, a₁ may be set to a small number, such as 0.0001, for example, when the first set of first-stage images represents 1000 m in machine-direction length of the web 108.

In various embodiments, block 584 may direct the detector processor 1200 to store the value determined using the above equation as the second first-stage anomaly threshold in the location 1242 of the storage memory 1204 shown in FIG. 3.

Referring to FIG. 6, in various embodiments, after block 508 has been completed, the detector processor 1200 may return to block 502 and a further set of first-stage images may be received. For example, in various embodiments, at a subsequent execution of block 502, a second set of first-stage images may be received. In various embodiments, block 504 may be executed by applying the second first-stage anomaly identifying sensitivity stored in the location 1242 of the storage memory 1204 to the second set of first-stage images. In various embodiments, a second first-stage anomaly location record having generally similar format to the first-stage anomaly location record 540 shown in FIG. 8 may be generated and stored in the location 1244 of the storage memory 1204. In various embodiments, blocks 506 and 508 may be executed to determine a third first-stage anomaly identifying sensitivity.

In various embodiments, blocks 502-508 may be executed for each set of first-stage images, representing respective portions of the web 108. In various embodiments, after execution of the flowchart 500 is complete, one or more first-stage anomaly location records representing anomaly locations may be stored in the location 1244 of the storage memory 1204.

Referring to FIG. 1, in various embodiments, the flowchart 500 may be executed during processing of the web 108 at the first web processing stage 105. Referring back to FIG. 5, in various embodiments, block 402 may direct the tracker processor 200 to receive, via the interface 220 of the I/O interface 212, representations of the first-stage anomaly location records stored in the location 1244 of the storage memory 1204 from the first anomaly detector 104 and to store the first-stage anomaly location records in the location 244 of the storage memory 204.

In various embodiments, after processing at the first web processing stage has been completed, the web 108 may be moved to the second web processing stage 107, and the web 108 may be further processed there. In various embodiments, after or during processing of the web at the second web processing stage 107, block 404 of the flowchart shown in FIG. 5 may be executed.

Referring to FIG. 5, in various embodiments, the flowchart 400 continues at block 404, which directs the tracker processor 200 to receive a representation of second-stage anomaly locations representing locations of anomalies detected on the web 108 at the second web processing stage 107 shown in FIG. 1. In various embodiments, block 404 may direct the tracker processor 200 to receive, via the interface 222 of the I/O interface 212 shown in FIG. 2, the representation of second-stage anomaly locations from the second anomaly detector 106.

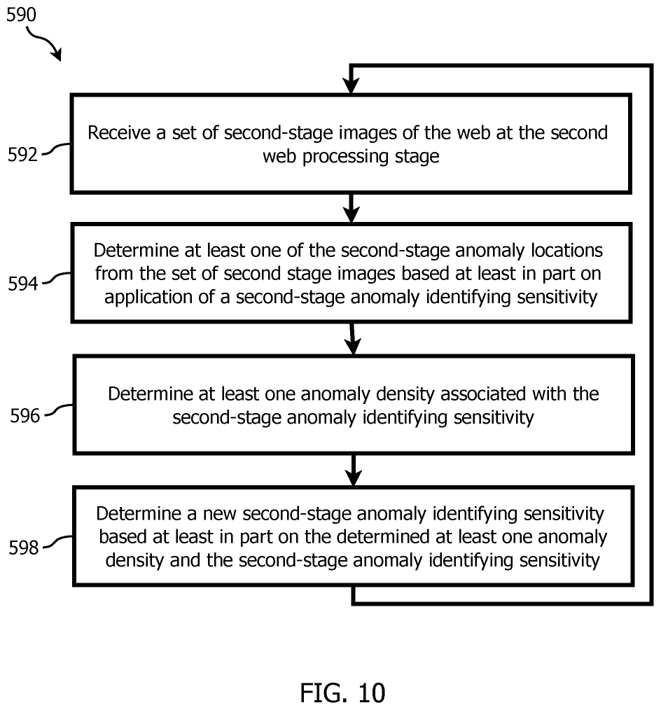

In various embodiments, the second anomaly detector 106 may be configured generally similarly to the first anomaly detector 104. Referring to FIG. 10, there is shown a flowchart 590 depicting blocks of code for directing the detector processor 1400 shown in FIG. 4 to perform facilitating anomaly detection for web position tracking in accordance with various embodiments. In various embodiments, the blocks of code included in the flowchart 590 may be encoded in the block of codes 1406 of the program memory 1402 shown in FIG. 4. In various embodiments, the flowchart 590 may include blocks of code generally similar to those included in the flowchart 500 shown in FIG. 6.

In some embodiments, block 404 may direct the tracker processor 200 to execute block 406 once a minimum length of the web 108 is represented by the second-stage anomaly locations received at block 404. For example, the minimum length may be about 50 m. In some embodiments, block 404 may direct the tracker processor 200 to execute block 406 once a minimum number of second-stage anomaly locations have been received. For example, in some embodiments, the minimum number of second-stage anomaly locations may be 50.

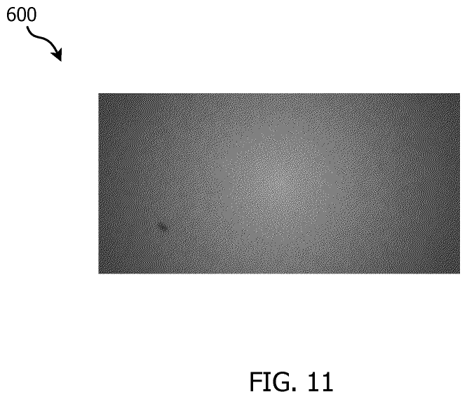

Referring to FIG. 10, the flowchart 590 begins with block 592, which directs the detector processor 1400 to receive a set of second-stage images of the web 108 at the second web processing stage 107. In various embodiments, block 592 may direct the detector processor 1400 to receive a first set of second-stage images of the web 108 at the second web processing stage 107, the first set of second-stage images including the second image 600 shown in FIG. 11, from the one or more second cameras 124 shown in FIG. 1. In various embodiments, block 592 may direct the detector processor 1400 to receive associated machine-direction positions for each of the second-stage images from the second location sensor 126 shown in FIG. 1.

In various embodiments, block 592 may direct the detector processor 1400 to store the first set of second-stage images in the location 1452 of the storage memory 1404. In various embodiments, the first set of second-stage images may include images of a recently imaged threshold distance of the web 108. For example, in some embodiments, block 592 may direct the detector processor 1400 to receive and store images of the most recent 1000 m of the web 108 as the first set of second-stage images in the location 1452 of the storage memory 1404.

Referring to FIG. 10, block 594 directs the detector processor 1200 to determine at least one of the second-stage anomaly locations based at least in part on application of a second-stage anomaly identifying sensitivity to the set of second-stage images. In various embodiments, block 594 may direct the detector processor 1400 to determine a first set of second-stage anomaly locations based on application of a first second-stage anomaly identifying sensitivity to the first set of second-stage images. In some embodiments, the first second-stage anomaly identifying sensitivity may be stored in the location 1454 and may be 25, for example.

In various embodiments, blocks 592 and 594 may be executed concurrently such that for each second-stage image received at block 592 the image is analyzed for second-stage anomaly locations, without waiting for the full set of second-stage images to be received. In various embodiments, separating the images into sets may facilitate application of varying second-stage anomaly identifying sensitivities to the web 108, with each sensitivity used for a different set of images.

In various embodiments, the position tracker 102 may be able to request and/or receive the representations of the second-stage anomaly locations at any time and/or a block of codes may be executed by the detector processor 1400 for continuously sending determined second-stage anomaly locations to the position tracker 102 as they are determined. For example, in some embodiments, block 594 may include a block of codes for directing the detector processor 1400 to cause signals representing a second-stage anomaly location record to be transmitted to the position tracker 102 via the interface 1424 of the I/O interface 1412 shown in FIG. 4 when the second-stage anomaly location record is determined or updated with a new anomaly location. Accordingly, in various embodiments, the position tracker 102 may continuously receive second-stage anomaly locations before full sets of second-stage images are received at block 592 of the flowchart 590.

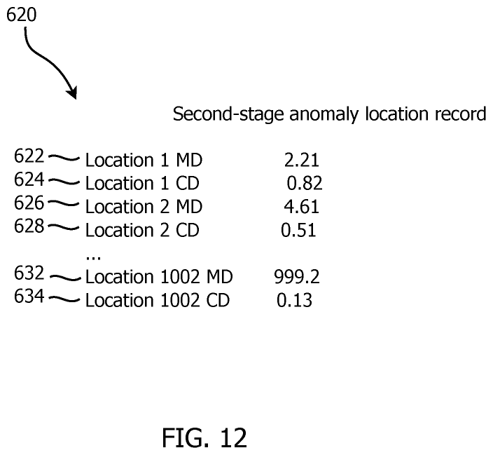

In various embodiments, block 594 may direct the detector processor 1400 to store the determined first set of second-stage anomaly locations in a second-stage anomaly location record 620 as shown in FIG. 12 and to store the second-stage anomaly location record 620 in the location 1456 of the storage memory 1404 shown in FIG. 4. Referring to FIG. 12, the second-stage anomaly location record 620 includes anomaly location fields for storing machine-direction and cross-direction locations for each anomaly. For example, referring to FIG. 12, the second-stage anomaly location record 620 may include anomaly location fields, including, for example, first second-stage anomaly location fields 622 and 624 for storing an increasing machine-direction location and a cross-direction location respectively of a first anomaly, second second-stage anomaly location fields 626 and 628 for storing an increasing machine-direction location and a cross-direction location respectively of a second anomaly, and 1002nd anomaly location fields 632 and 634 for storing an increasing machine-direction location and a cross-direction location respectively of a 1002nd anomaly.

Referring to FIG. 11, in some embodiments, the flowchart 590 may include blocks 596 and 598, which may direct the detector processor 1400 to determine a second second-stage anomaly identifying sensitivity for application to a second set of second-stage images. In various embodiments, the second second-stage anomaly identifying sensitivity may be different from the first second-stage anomaly identifying sensitivity. In various embodiments, block 596 may direct the detector processor 1400 to determine an anomaly density associated with the second-stage anomaly identifying sensitivity. In various embodiments, block 596 may direct the detector processor 1400 to determine an anomaly density associated with the first second-stage anomaly identifying sensitivity. In some embodiments, the anomaly density may be an anomaly count density. In various embodiments, block 596 may direct the detector processor 1400 to count how many anomalies have been detected within a sampling machine-direction proximity of the most recent image included in the first set of second-stage images. For example, in some embodiments, the sampling machine-direction proximity may be 10,000 m. In some embodiments, the sampling machine-direction proximity for the second web processing stage 107 may be less than the sampling machine-direction proximity for the first web processing stage 105. In various embodiments, this may facilitate improved tracking in the second web processing stage 107 where the reels received from the first web processing stage 105 may be processed in a different order and/or in reverse, so, for example, changes that may appear relatively gradual and/or smooth in the first web processing stage 105, such as, for example, grade changes on a paper machine, may appear abrupt in the second web processing stage 107.

In various embodiments, block 596 may direct the detector processor 1400 to determine a count of anomalies represented by the first set of second-stage anomaly locations. For example, in some embodiments, block 596 may direct the detector processor 1400 to read the second-stage anomaly location record 620 from the location 1456 of the storage memory 1404 and to determine a count of the locations represented by the second-stage anomaly location record 620.

In various embodiments, where the sampling machine-direction proximity is greater than the machine-direction length represented by the first set of second-stage anomaly locations, and the location 1456 stores further second-stage anomaly location records, block 596 may direct the detector processor 1400 to add to the count of the locations represented by the second-stage anomaly location record 620, a count of any additional locations represented by anomaly location records wherein the locations are within the sampling machine-direction proximity of the most recent (greatest increasing machine-direction position) image of the first set of second-stage images.

In various embodiments, block 596 may direct the detector processor 1400 to determine the anomaly density by dividing the determined count by the machine-direction length represented by the second-stage images from which the locations were considered, which may in some embodiments, such as where only the first set of second-stage images have been analyzed, be 1000 m, for example. In various embodiments, block 596 may direct the detector processor 1400 to store the determined anomaly density in the location 1458 of the storage memory 1404. For example, in some embodiments, block 596 may direct the detector processor 1400 to store an anomaly density of 1.002 anomalies per meter in the location 1458 of the storage memory 1404.

Referring to FIG. 10, in various embodiments, block 598 may direct the detector processor 1400 to determine a second second-stage anomaly identifying sensitivity based at least in part on the determined anomaly density and the first second-stage anomaly identifying sensitivity. In various embodiments, block 598 may include code generally similar to block 508 of the flowchart 500 shown in FIG. 6 and/or blocks 582 and 584 of the flowchart 580 shown in FIG. 9. In various embodiments, block 598 may direct the detector processor 1400 to determine a difference between the anomaly density stored in the location 1458 of the storage memory 1404 and a desired second-stage anomaly density stored in the location 1460 of the storage memory 1404. In various embodiments, block 598 may direct the detector processor 1400 to store the determined difference in the location 1462 of the storage memory 1404.

In various embodiments, false anomalies may be expected. In some embodiments, a false anomaly may appear as a dark spot in a camera image, without being a property of the web 108. For example, in various embodiments, there may be a piece of paper suspended in the air between the web 108 and the one or more first cameras 120. In some embodiments, the expected rate of false anomalies may be higher in the first web processing stage 105 than in the second web processing stage 107. Accordingly, in order to try to detect approximately similar amounts of true anomalies (i.e., actual anomalies in the web 108), in various embodiments, the desired second-stage anomaly density may be less than the desired first-stage anomaly density. For example, in some embodiments, the desired second-stage anomaly density may be less than 90% of the desired first-stage anomaly density. In various embodiments, the desired second-stage anomaly density being less than 90% of the desired first-stage anomaly density may facilitate matching and/or tracking despite a lower expected rate of false anomalies in the second web processing stage 107. In some embodiments, for example, the desired second-stage anomaly density may be about 0.800 anomalies per meter and the desired first-stage anomaly density may be about 1.000 anomalies per meter.

In various embodiments, block 598 may direct the detector processor 1400 to determine the second second-stage anomaly threshold using the following equation:

$${T}_{22} = {T}_{21} \cdot exp ( {a}_{2} \cdot {D}_{2} )$$

where T₂₂ is the second second-stage anomaly threshold, T₂₁ is the first second-stage anomaly threshold, a₂ is a scaling factor, and D₂ is a relative difference determined by dividing the difference stored in the location 1462 of the storage memory 1404 shown in FIG. 4 by the desired anomaly density from the location 1460 of the storage memory 1404. In some embodiments, a₂ may be set to a small number, such as 0.0001, for example, when the first set of second-stage images represents 1000 m in machine-direction length of the web 108.

In various embodiments, block 598 may direct the detector processor 1400 to store the value determined using the above equation as the second second-stage anomaly threshold in the location 1454 of the storage memory 1404 shown in FIG. 4. Referring to FIG. 10, in various embodiments, after block 598 has been completed, the detector processor 1400 may return to block 592 and a second set of second-stage images may be received and blocks 594-598 may be executed for the second set of second-stage images, applying the second second-stage anomaly identifying sensitivity to the second set of first-stage images. In various embodiments, a further second-stage anomaly location record may be generated and stored in the location 1456 of the storage memory 1204. In various embodiments, blocks 592-598 may be repeatedly or continuously executed during processing of the web at the second web processing stage 107.

In various embodiments, block 404 may direct the tracker processor 200 to receive, via the interface 222 of the I/O interface 212 shown in FIG. 2, from the second anomaly detector 106 representations of the second-stage anomaly location records stored in the location 1456 of the storage memory 1404. In various embodiments, block 404 may direct the tracker processor 200 to store the representations in one or more second-stage anomaly location records representing anomaly locations in the location 256 of the storage memory 204 shown in FIG. 2. In some embodiments, block 404 may direct the tracker processor 200 to update the stored second-stage anomaly location records such that only the most recently detected anomalies are considered. For example, in some embodiments, block 404 may direct the tracker processor 200 to remove anomaly location records that are not among the latest 2000 anomaly location records.

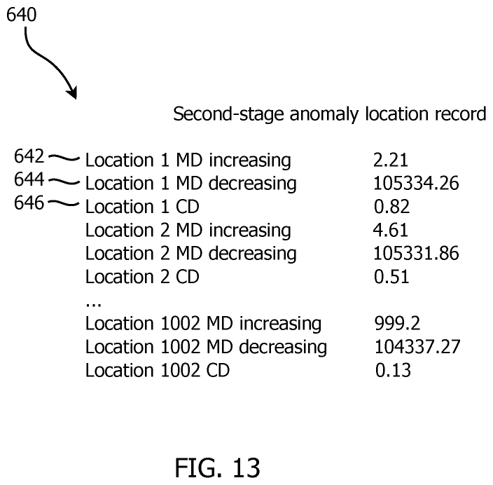

In some embodiments, block 404 may direct the tracker processor 200 to receive a representation of the second-stage anomaly location record 620 shown in FIG. 12 from the second anomaly detector 106. In some embodiments, block 404 may direct the tracker processor 200 to generate and store an updated or revised second-stage anomaly location record 640 as shown in FIG. 13 in the location 256 of the storage memory 204 shown in FIG. 2. Referring to FIG. 13, in various embodiments, block 404 may direct the tracker processor 200 to include a first increasing machine-direction location field 642 for storing an increasing machine-direction taken from the location field 622 of the second-stage anomaly location record 620 shown in FIG. 12 and a first decreasing machine-direction location field 644 for storing a decreasing machine-direction location, which may be based on the increasing machine-direction location. In some embodiments, block 404 may direct the tracker processor 200 to determine a decreasing machine-direction location for each increasing machine-direction location included in the second-stage anomaly location record 620 shown in FIG. 12 and to include the determined decreasing machine-directions in the second-stage anomaly location record 640 shown in FIG. 13.

In various embodiments, block 404 may direct the tracker processor 200 to determine each decreasing machine-direction location by subtracting the associated increasing machine-direction location from a total length of the web 108. In some embodiments, the total length of the web 108 may have been previously provided and stored in the storage memory 204. In some embodiments, a total length of the web 108 may have been sensed or determined by the first location sensor 122 and/or the first anomaly detector 104 shown in FIG. 1 and block 404 may direct the tracker processor 200 to receive a representation of the sensed total length of the web 108 and to store the sensed total length of the web 108 in the storage memory 204. For example, in some embodiments, the stored total length of the web 108 may be 105,336.47 m and block 404 may direct the tracker processor 200 to determine each decreasing machine-direction location by subtracting the associated increasing machine-direction location from 105,336.47 m.

In various embodiments, the second-stage anomaly location record 640 may include respective cross-direction location fields including a cross-direction location field 646 for storing a first cross-direction location taken from the location field 624 of the second-stage anomaly location record 620 shown in FIG. 12.

In various embodiments, the locations stored in the decreasing machine-direction location fields and the associated cross-direction location fields of the second-stage anomaly location record 640 shown in FIG. 13 may act as the second-stage anomaly locations representing locations of anomalies detected on the web 108 at the second web processing stage 107.

Referring back to FIG. 5, in various embodiments, block 404 may be executed continually while the web 108 is processed at the second web processing stage 107 shown in FIG. 1. However, in various embodiments, during or after block 404 has been executed, the tracker processor 200 may be directed to execute block 406. In various embodiments, block 406 directs the tracker processor 200 to consider a candidate location offset as a subject candidate location offset. In some embodiments, block 406 may direct the tracker processor 200 to determine the candidate location offset to be used by utilizing a grid search technique. In some embodiments, block 406 may direct the tracker processor 200 to establish a first grid of machine-direction and cross-direction offsets. For example, in some embodiments, machine-direction offsets between −100 and 1000 meters may be considered. The grid step size in the machine-direction could be 0.5 m, for example. In the cross-direction, offsets between −0.5 m and +0.5 m may be considered, for example. The grid step size in the cross-direction may be 0.1 m, for example. In various embodiments, block 406 may direct the tracker processor 200 to set the subject candidate location offset by choosing a first candidate location offset from the possible offset pairs from the first grid.

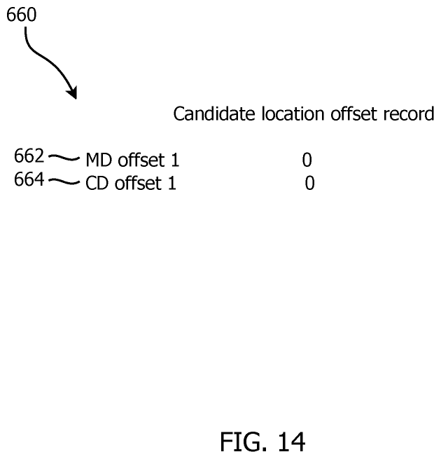

In various embodiments, block 406 may direct the tracker processor 200 to store the subject candidate location offset in a subject candidate location offset record in the location 264 of the storage memory 204 shown in FIG. 2. In various embodiments, block 406 may direct the tracker processor 200 to store the subject candidate location offset record 660 shown in FIG. 14 in the location 264 of the storage memory 204. Referring to FIG. 14, the subject candidate location offset record 660 includes a machine-direction offset field 662 and a cross-direction offset field 664 for storing respective candidate location offsets in the machine-direction and cross-direction.

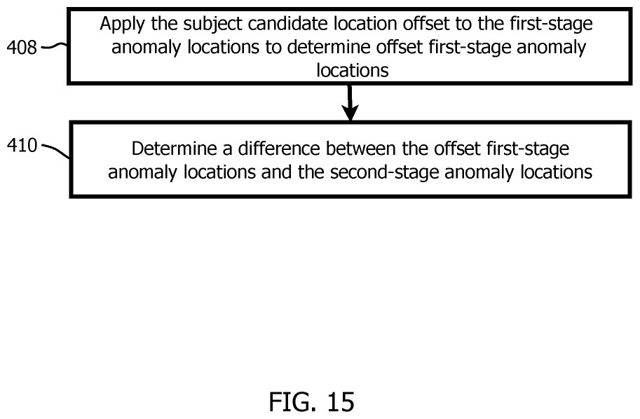

Block 407 then directs the tracker processor 200 to compare the subject candidate location offset to the first-stage anomaly locations and the second-stage anomaly locations to determine a representation of a difference to be associated with the candidate location offset. In some embodiments, the representation of the difference may represent how well the subject candidate location offset is able to map locations or positions of the web 108 at the first web processing stage 105 shown in FIG. 1 to the same locations or positions of the web 108 at the second web processing stage 107. In some embodiments, the representation of the difference may represent how well the subject candidate location offset is able to convert first-stage anomaly locations into second-stage anomaly locations. For example, in some embodiments, block 407 may include code for directing the tracker processor 200 to apply or add the candidate location offset to the first-stage anomaly locations to determine offset first-stage anomaly locations, and determine a difference between the offset first-stage anomaly locations and the second-stage anomaly locations and so block 407 may include the blocks of code 408 and 410 shown in FIG. 15.

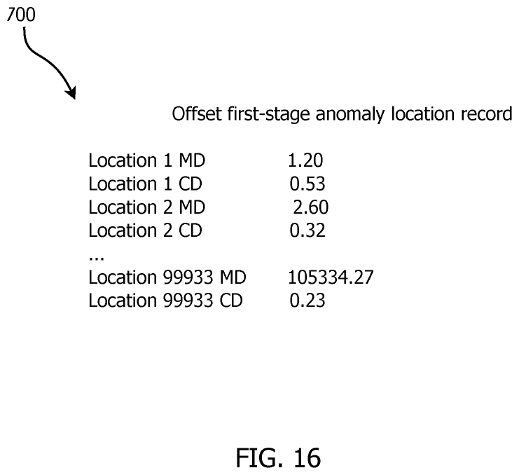

Referring to FIG. 15, block 408 directs the tracker processor 200 to apply the subject candidate location offset to the first-stage anomaly locations to determine a plurality of offset first-stage anomaly locations. In some embodiments, block 408 may direct the tracker processor 200 to read the one or more first-stage anomaly location records (including the first-stage anomaly location record 540 shown in FIG. 8, for example) from the location 244 of the storage memory 204 and the subject candidate location offset record 660 (shown in FIG. 14) from the location 264 of the storage memory 204. Block 408 may direct the tracker processor 200 to add the offset from the machine-direction offset field 662 to each of the machine-direction location fields included in the first-stage anomaly location records. Block 408 may direct the tracker processor 200 to add the offset from the cross-direction offset field 664 to each of the cross-direction location fields included in the first-stage anomaly location records. Block 408 may direct the tracker processor 200 to store the result in an offset first-stage anomaly location record (shown at 700 in FIG. 16) in the location 268 of the storage memory 204 shown in FIG. 2.

Referring to FIG. 15, block 410 directs the tracker processor 200 to determine a difference between the offset first-stage anomaly locations and the second-stage anomaly locations. In some embodiments, block 410 may direct the tracker processor 200 to read the one or more second-stage anomaly location records (including the second-stage anomaly location record 640 shown in FIG. 13) from the location 256 of the storage memory 204 shown in FIG. 2 and to read the offset first-stage anomaly location record (shown at 700 in FIG. 16) from the location 268 of the storage memory 204 shown in FIG. 2.

In various embodiments, block 410 may direct the tracker processor 200 to match each location (using the decreasing machine-direction locations) in the second-stage anomaly location record 640 with a location in the offset first-stage anomaly location record 700 and to determine a respective difference between each of the matched locations. In some embodiments, the locations may be matched by determining, for each decreasing machine-direction location in the second-stage anomaly location record 640, a location in the offset first-stage anomaly location record 700 that is closest, and using that as the matched location. In various embodiments, identifying the closest offset first-stage anomaly for each second-stage anomaly may be implemented efficiently using a quadtree or FLANN (see Muja, Marius and Lowe, David G. (2019). Fast Approximate Nearest Neighbors with Automatic Algorithm Configuration. In International Conference on Computer Vision Theory and Applications (VISAPP'09)), for example.

In some embodiments, block 410 may direct the tracker processor 200 to determine a weighted squares distance for each pair of matched locations, wherein the weighted squares distance is defined as follows:

$$D = {Δ}_{M D}^{2} + {W}_{C D} \times {Δ}_{C D}^{2}$$

Where Δ_{MD} is the difference in machine-direction values for the matched locations, W_{CD} is a cross-direction weight, and Δ_{CD} is the difference in cross-direction values for the matched locations. In some embodiments, W_{CD} may be set to 10, for example. In various embodiments, a value to be used as W_{CD} may be previously set and stored in the location 270 of the storage memory and block 410 may direct the tracker processor 200 to retrieve the W_{CD} from the location 270 of the storage memory 204 shown in FIG. 2. In some embodiments, it may be advantageous to weigh the difference in cross-direction values relatively more, because the cross-direction positions may have been measured relatively more accurately, and therefore giving them relatively more weight may facilitate improved tracking, for example.

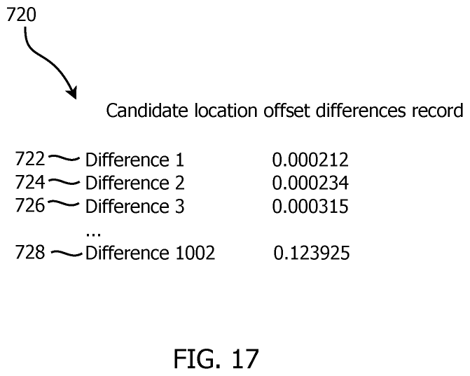

In various embodiments, block 410 may direct the tracker processor 200 to store the determined weighted squares distance in a candidate location offset differences record 720 shown in FIG. 17 in the location 272 of the storage memory 204. Referring to FIG. 17, in various embodiments, the candidate location offset differences record may include a difference field (e.g., difference fields 722, 724, 726, and 728) for storing the determined weighted squares distance for each of the matched locations. In some embodiments, block 410 may direct the tracker processor 200 to sort the candidate location offset differences record 720 in ascending order of the values stored in the differences fields.

Referring back to FIG. 5, in various embodiments, block 412 may direct the tracker processor 200 to associate a representation of the difference with the candidate location offset. In various embodiments, block 412 may direct the tracker processor 200 to determine a representation of the difference by aggregating or summing lowest ones of the differences stored in the candidate location offset differences record 720. In some embodiments, block 412 may direct the tracker processor 200 to sum a representative subset of the determined differences, for example. In some embodiments, the representative subset may be a fraction of the differences that are the lowest values. For example, in some embodiments, the fraction may be 10%. In some embodiments, the number of differences included in the representative subset may be the greatest of the fraction and a minimum number, which may be previously determined and set to a value, such as, for example 20.

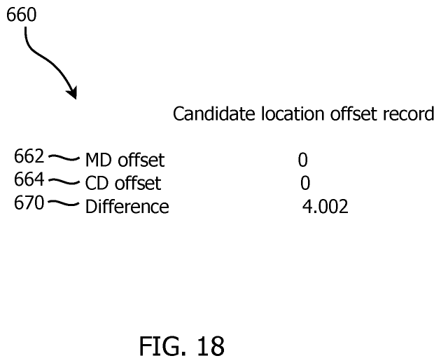

In various embodiments, the sum may act as the representation of the difference. Block 412 may direct the tracker processor 200 to update the subject candidate location offset record (shown at 660 in FIG. 14) in the location 264 of the storage memory 204 shown in FIG. 2 to include a representative difference field 670 storing the determined representation of the difference, as shown in FIG. 18.

In various embodiments, after block 412 has been executed, the tracker processor 200 may be directed to return to block 406 of the flowchart 400 shown in FIG. 5 to consider a new candidate location offset as the subject candidate location offset and to repeat blocks 406, 407, and 412 with the new candidate location offset. In various embodiments, block 406 may direct the tracker processor 200 to identify a new candidate location offset from the first grid as described above.

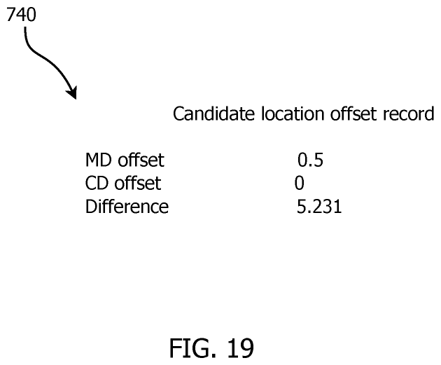

In various embodiments, after executing blocks 407 and 412 for the new candidate location offset there may be stored a further candidate location offset record 740 as shown in FIG. 19 in the location 264 of the storage memory 204 shown in FIG. 2.

In various embodiments, blocks 406, 407, and 412 may be repeated for further candidate location offsets. In some embodiments, once all grid locations in the first grid have been considered, the tracker processor 200 may be directed to proceed to block 414. In various embodiments, this may result in many candidate location offset records having format generally similar to the candidate location offset record 660 shown in FIG. 18 being stored in the location 264 of the storage memory 204 shown in FIG. 2. For example, in some embodiments, there may be 22,011 candidate location offset records stored in the location 264 of the storage memory 204.

Referring to FIG. 5, in various embodiments, after blocks 406, 407, and 412 have been executed and more than one candidate location offset record is stored in the location 264 of the storage memory 204, the tracker processor 200 may proceed to block 414. Block 414 directs the tracker processor 200 to identify a determined location offset from the candidate location offsets based at least in part on the representations of the differences.

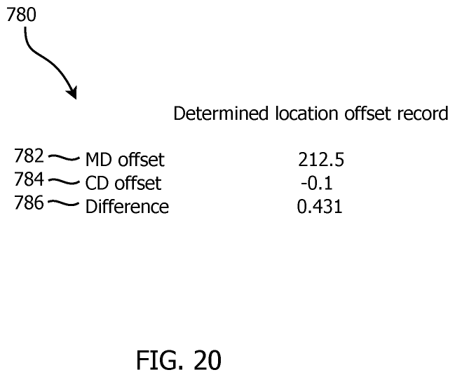

In some embodiments, block 414 may direct the tracker processor 200 to identify the determined location offset by identifying a candidate location offset of the plurality of candidate location offsets that is associated with a smallest or minimum one of the representations of the differences. In various embodiments, block 414 may direct the tracker processor 200 to identify from the candidate location offset records stored in the location 264 of the storage memory 204 shown in FIG. 2, a candidate location offset record having the lowest value stored in the difference field. In various embodiments, block 414 may direct the tracker processor 200 to store the identified candidate location offset record as a determined location offset record 780 as shown in FIG. 20 and to store the determined location offset record 780 in the location 274 of the storage memory 204 shown in FIG. 2.

Referring to FIG. 20, in various embodiments, the determined location offset record 780 may include a machine-direction offset field 782, a cross-direction offset field 784, and a representative difference field 786. In various embodiments, the machine-direction offset stored in the machine-direction offset field 782, and the cross-direction offset stored in the cross-direction offset field 784 may be used to locate anomalies in the second web processing stage 107 during processing.

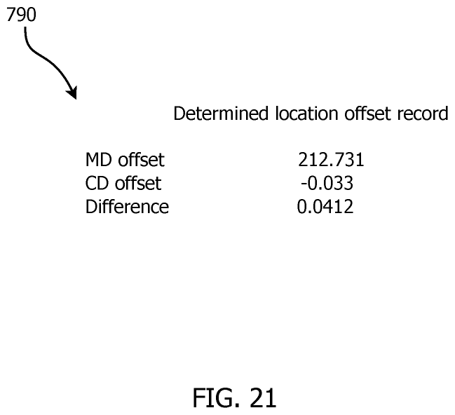

In some embodiments, after block 414 of the flowchart 400 shown in FIG. 5 has been completed, the tracker processor 200 may be directed to return to block 406 and consider further candidate location offsets near the determined location offset. In various embodiments, block 406, 407, and 412 may be repeated with a second denser grid near the determined location offset, and a new determined location offset may be found when block 414 is executed once more. In some embodiments, further denser grids having smaller grid step sizes may be used and a more accurate determined location offset record 790 as shown in FIG. 21, may be stored in the location 274 of the storage memory 204.

In various embodiments, after block 414 has been executed, additional representations of second-stage anomaly locations may be received by the position tracker 102 and blocks 404-414 may be repeatedly executed to update the determined location offset record as the web 108 is processed at the second web processing stage 107 shown in FIG. 1.

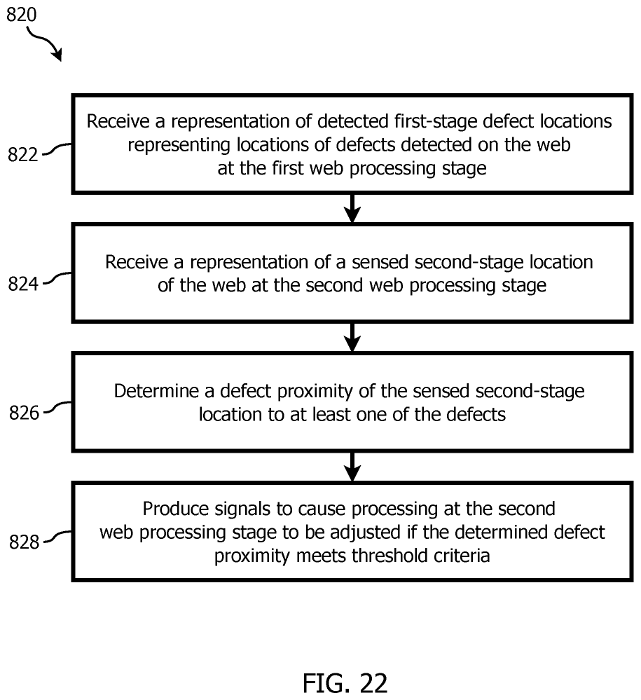

Referring to FIG. 22, there is shown a flowchart 820 depicting blocks of code that in various embodiments may be executed after or during execution of the flowchart 400 shown in FIG. 5. In various embodiments, the blocks of code included in the flowchart 820 may be included in the block of codes 206 of the program memory 202 shown in FIG. 2. In some embodiments, the flowchart 820 may be continuously executed as the web 108 is processed at the second web processing stage 107 shown in FIG. 1.

Referring to FIG. 22, the flowchart 820 begins with block 822, which directs the tracker processor 200 to receive a representation of detected first-stage defect locations representing locations of defects detected on the web 108 at the first web processing stage 105. In various embodiments, the representation of detected first-stage defect locations may come in the form of images from the one or more first cameras 120 or in a representation of defect location records received from a defect detector.

In some embodiments, the first anomaly detector 104 may act as a defect detector and may analyze the first-stage images stored in the location 1240 to determine the first-stage defect locations before sending the first-stage defect locations to the tracker processor 200. For example, in some embodiments, the first anomaly detector 104 may include the block of codes 1208 shown in FIG. 3 for directing the detector processor 1200 to detect defects. In various embodiments, the block of codes 1208 may include code generally similar to elements included in the flowchart 500 shown in FIG. 6, but with higher thresholds and/or other detection parameters leading to lower detection sensitivity, such that only or primarily defects that are relevant from the product quality point of view and/or defects for which processing at the second web processing stage 107 may need to be adjusted are identified as defects.

In various embodiments, the block of codes 1208 may direct the detector processor 1200 to receive the first-stage images including the first-stage image 460 shown in FIG. 7 and an associated machine-direction position for each image and to determine the detected defect locations from the images and machine-direction position information. In some embodiments, the first-stage images may be stored in the location 1240 of the storage memory 1204.

In various embodiments, block 1208 may direct the detector processor 1200 to apply a defect detection process to the first-stage images to identify the defects. For example, in some embodiments, block 1208 may direct the detector processor 1200 to determine defect index values for each pixel in the first set of first-stage images, and identify groups of pixels that are associated with defect index values greater than a defect threshold value. In various embodiments, the defect index value may be determined similarly to the anomalousness index value, and the defect threshold value may be greater than the threshold used to identify anomalies at block 504 of the flowchart 500 shown in FIG. 6 and so fewer defects may be identified compared to anomalies. In various embodiments, alternative processes and/or additional criteria for finding defects may be used, such as, for example, defect detecting processes where a minimum size for a defect is required for it to be identified as a defect. In some embodiments, block 1208 may direct the detector processor 1200 to generate at least one detected defect location record and to cause signals representing the detected defect location record to be transmitted to the position tracker 102 via the interface 1224 of the first anomaly detector 104 shown in FIG. 3.

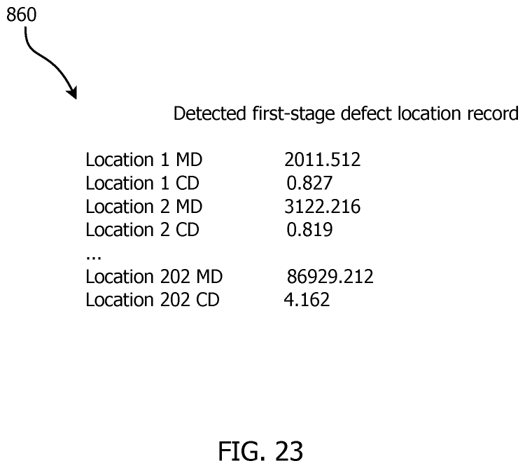

In various embodiments, block 822 may direct the tracker processor 200 to receive, via the interface 220 of the I/O interface 212 shown in FIG. 2, a representation of at least one detected first-stage defect location record from the first anomaly detector 104 and to store the detected first-stage defect location records in the location 276 of the storage memory 204 shown in FIG. 2. Referring to FIG. 23, there is shown an exemplary detected first-stage defect location record 860 that may be stored in the location 276 of the storage memory 204 shown in FIG. 2.

Referring back to FIG. 22, block 824 directs the tracker processor 200 to receive a representation of a sensed second-stage location of the web at the second web processing stage, the sensed second-stage location representing a current location of the web 108 at the second web processing stage 107 shown in FIG. 1. In various embodiments, the sensed second-stage location may represent a current or near current location of the web 108 being processed at the second web processing stage 107. In various embodiments, block 824 may direct the tracker processor 200 to receive a representation of the sensed second-stage location, which may, for example, include a value representing the sensed second-stage location in meters, via the interface 226 shown in FIG. 2 from the second location sensor 126 shown in FIG. 1. In various embodiments, block 824 may direct the tracker processor 200 to convert an increasing machine-direction location from the received sensed second-stage location to a decreasing machine-direction location as described herein having regard to block 404 of the flowchart 400 shown in FIG. 5 before storing the sensed second-stage location in the location 278 of the storage memory 204 shown in FIG. 2.

Referring to FIG. 22, block 826 directs the tracker processor 200 to determine a defect proximity of the sensed second-stage location to at least one of the defects based on the determined location offset, the sensed second-stage location of the web, and the one or more detected first-stage defect locations. In some embodiments, the defect proximity may represent how close the location of the web 108 currently being processed at the second web processing stage 107 is to a predicted defect in the web 108.

In some embodiments, block 826 may direct the tracker processor 200 to apply the determined location offset to the one or more detected first-stage defect locations to determine one or more predicted second-stage defect locations representing locations of defects predicted for the web 108 at the second web processing stage 107. Block 826 may then direct the tracker processor 200 to compare the one or more predicted second-stage defect locations to the sensed second-stage location.

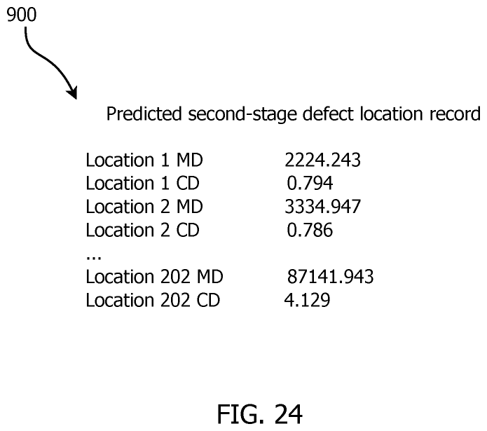

In various embodiments, block 826 may direct the tracker processor 200 to read the determined location offset record 790 shown in FIG. 21 from the location 274 and the detected first-stage defect location record 860 shown in FIG. 23 from the location 276 of the storage memory 204 shown in FIG. 2, to add the value from the machine-direction offset field of the determined location offset record 790 to each machine-direction location field in the detected first-stage defect location record 860, and, in some embodiments, to add the value from the cross-direction offset field of the determined location offset record 790 to each cross-direction location field in the detected first-stage defect location record 860. In various embodiments, block 826 may direct the tracker processor 200 to store the result as a predicted second-stage defect location record 900 shown in FIG. 24 in the location 280 of the storage memory 204 shown in FIG. 2.

In various embodiments, block 826 may direct the tracker processor 200 to identify one of the predicted second-stage defect locations represented by the predicted defect location record 900 shown in FIG. 24 as a closest defect location to the sensed second-stage location stored in the location 278 of the storage memory 204 shown in FIG. 2. In various embodiments, block 826 may direct the tracker processor 200 to identify the closest defect location as a closest upcoming defect location by requiring that the identified location have a lower machine-direction location than the sensed second-stage location. Block 826 may direct the tracker processor 200 to determine the defect proximity to be the difference or distance between the sensed second-stage location and the identified closest defect location. In some embodiments, block 826 may direct the tracker processor 200 to determine the defect proximity based only on machine-direction locations and so block 826 may direct the tracker processor 200 to determine the defect proximity as the machine-direction difference or machine-direction distance between the sensed second-stage location and the identified closest defect location. In various embodiments, block 826 may direct the tracker processor 200 to store the determined defect proximity in the location 282 of the storage memory 204 shown in FIG. 2.

Referring back to FIG. 22, in various embodiments, block 828 directs the tracker processor 200 to produce signals to cause processing at the second web processing stage 107 shown in FIG. 1 to be adjusted if the determined defect proximity meets threshold criteria. For example, in some embodiments, block 828 may direct the tracker processor 200 to determine whether the defect proximity meets threshold criteria by determining whether the defect proximity is greater than a threshold distance, which in some embodiments may have been provided or generated and stored in the location 284 of the storage memory 204. In various embodiments, block 828 may direct the tracker processor 200 to produce signals to cause processing at the second web processing stage 107 to be adjusted at each of the predicted defect locations. In various embodiments, block 828 may direct the tracker processor 200 to, if the defect proximity is less than the threshold distance, send control signals to the web processing driver 130 via the interface 224 for causing the web processing driver to slow down. In various embodiments, this may facilitate slowing down the web 108 when the current second web processing stage location enters within a threshold distance in advance of any of the locations identified in the predicted defect location record 900 shown in FIG. 24. In some embodiments, the tracker processor 200 may continuously and/or repeatedly execute code from blocks 824, 826, and 828 to check the current second web processing stage location, update the predicted defect location record 900 shown in FIG. 24 (for example, if the determined location offset is updated), update the defect proximity, and check whether the defect proximity is less than the threshold distance. In some embodiments, code from blocks 824-828 may be executed continuously during processing at the second web processing stage 107. In some embodiments, the threshold distance may be 2500 m and block 828 may direct the tracker processor 200 to cause the web processing driver 130 to start slowing down when the current second web processing stage is within 2500 m of the next location identified in the predicted defect location record, for example.

In various embodiments, the threshold distance or proximity may be dependent on a speed at which the web 108 is traveling. For example, in some embodiments, block 828 may direct the tracker processor 200 to receive a current speed of the web 108 from the second location sensor 126 and to determine the threshold distance based on the current speed. For example, from kinematic equations, the threshold distance may be determined as v²/2a, where a is a desired deceleration rate and v is the current speed that the web 108 is traveling at. For slitter winder machines, typical values may be a=0.5 m/s² and v=30 m/s, for example. However, in practical applications, deceleration cannot be abruptly changed from zero to 0.5 m/s², or vice versa; instead, it may need to be ramped up and down smoothly. Therefore, in some embodiments, two additional terms b+c may be added to the threshold distance. In various embodiments, b and c may depend on the desired (constant) acceleration rate a and a desired jerk rate j, and in addition b may also depend on the initial speed v and the initial acceleration rate. For example, assuming that the initial acceleration is zero and b=v*4 s and c=2 m, when starting to decelerate from a constant speed 1800 m/min, the threshold distance may be b+v²/2a+c=120 m+900 m+2 m=1022 m, where the 120 m corresponds to ramping up the deceleration, the 900 m corresponds to a period of constant deceleration, and the 2 m corresponds to ramping down the deceleration. Accordingly, in various embodiments, the faster the web 108 is traveling at the moment, the earlier the web processing driver 130 may need to start decelerating the web 108 in order to stop it in time. In some embodiments, there may be a need to calculate the threshold distance when the initial speed is not constant. In various such embodiments, the threshold distance may in addition to the current speed depend also on the current acceleration or deceleration of the web 108. Therefore, in various embodiments, the tracker processor 200 may be configured to estimate a current acceleration or deceleration from the current-speed values received, for example. In various embodiments, the higher the current acceleration is, the earlier the web processing driver 130 may need to start decelerating the web 108 in order to stop it in time. Similarly, if the web is already decelerating, then the threshold distance may in various embodiments be shorter, when compared to a situation where the initial speed is constant.

In various embodiments, the tracker processor 200 causing the web processing driver 130 to slow down may facilitate patching and/or removal of defects from the web 108. In some embodiments, the web processing driver 130 shown in FIG. 1 may normally operate at around 2000 m/min or more and the tracker processor 200 may be configured to cause the driver to slow down to about 5 m/min, for example, to allow patching or removal of defects to occur without completely stopping the web 108. In various such embodiments, block 828 may direct the tracker processor 200 to add a constant value to the threshold distance, such that the goal is to reach a low crawl speed in advance of the predicted defect position, such as, for example, 3 meters before the predicted defect position. In various embodiments, this may facilitate both fast processing and the ability to remove or repair defects in the web 108 at the second web processing stage 107.

In various embodiments, the tracker processor 200 may be configured to produce signals for causing the driver 130 to completely stop moving the web 108 whenever a defect is predicted to be in a position where it may be convenient for an operator or a machine to patch or remove it. In some embodiments, the tracker processor 200 may be configured to cause the driver 130 to either completely stop, or only slow down, depending on a class associated with the predicted defect.

In some embodiments, when a defect is removed from the web 108, this may involve removing or altering a section of web 108 and so the previously considered second-stage images and related determined location offset may no longer be applicable or accurate. Accordingly, in various embodiments, the flowchart 820 shown in FIG. 22 may include a block of codes that directs the tracker processor 200 to, after the current web location indicates that a detected defect location has passed, update the second-stage anomaly locations stored in the location 256 for consideration in determining the location offset. For example, the block may direct the tracker processor 200 to update the second-stage anomaly locations stored in the location 256 to include only second-stage anomaly locations that represent locations after the detected defect location has passed. In some embodiments, for example, the block may direct the tracker processor 200 to, whenever a predicted defect location from the predicted defect location record 900 is passed, to remove all second-stage anomaly location records from the location 256 of the storage memory 204.

### Calibration

In various embodiments, first-stage anomaly identifying sensitivities and/or second-stage anomaly identifying sensitivities may be determined and/or updated using alternative and/or additional processes. In some embodiments, the anomaly identifying sensitivities may be set through standalone calibration processes instead of during analysis of previously identified anomalies. In some embodiments, the calibration processes may involve identifying anomaly locations that would not be later used for determining the determined location offset.

In some embodiments, for example, the first first-stage anomaly identifying sensitivity may be initially determined or set using a standalone calibration process, which may involve analysis of the first set of first-stage images itself and/or images of adjacent portions of the web 108.

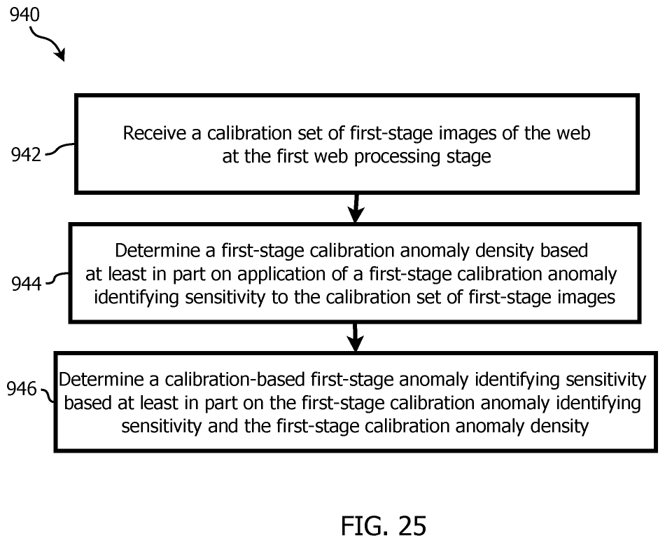

Referring now to FIG. 25, there is shown a flowchart 940 depicting blocks of code that may be executed by the detector processor 1200 prior to execution of the flowchart 500 shown in FIG. 6, in accordance with various embodiments. For example, in some embodiments, the blocks included in the flowchart 940 may be executed prior to execution of block 502 of the flowchart 500 shown in FIG. 6, to determine the first first-stage anomaly identifying sensitivity before the flowchart 500 shown in FIG. 6 is executed.

Referring to FIG. 24, the flowchart begins with block 942, which directs the detector processor 1200 to receive a calibration set of first-stage images of the web 108 at the first web processing stage 105 shown in FIG. 1. In some embodiments, the first set of first-stage images may include at least one of the calibration set of first-stage images. In some embodiments, the first set of first-stage images may include the calibration set of first-stage images. In some embodiments, the calibration set of first-stage images and the first set of first-stage images may be the same set of images.

In various embodiments, using the first set of first-stage images as the calibration set of first-stage images to determine a calibration-based first-stage anomaly identifying sensitivity to act as a first first-stage anomaly identifying sensitivity may facilitate excellent calibration, such that a desired anomaly density for the first set of first-stage images is achievable. In some embodiments, the calibration set of first-stage images may include images representing at least one portion of the web 108 adjacent to the portion represented by the first set of first-stage images.

In some embodiments, block 942 may include code generally similar to block 502 of the flowchart 500 shown in FIG. 6 and may direct the detector processor 1200 to receive the calibration set of first-stage images and a machine-direction location associated with each image. In various embodiments, block 942 may direct the detector processor 1200 to store the calibration set of first-stage images and associated locations in the location 1280 of the storage memory 1204 shown in FIG. 3.

Referring to FIG. 25, block 944 directs the detector processor 1200 to determine a first-stage calibration anomaly density based at least in part on application of a first-stage calibration anomaly identifying sensitivity to the calibration set of first-stage images.

In various embodiments, block 944 may include code generally similar to that included in blocks 504 and 506 of the flowchart 500 shown in FIG. 6. In various embodiments, block 944 may direct the detector processor 1200 to determine a first-stage calibration set of anomaly locations based at least in part on application of the calibration first-stage anomaly identifying sensitivity to the calibration set of first-stage images and to determine a count of anomalies represented by the first-stage calibration set of anomaly locations.

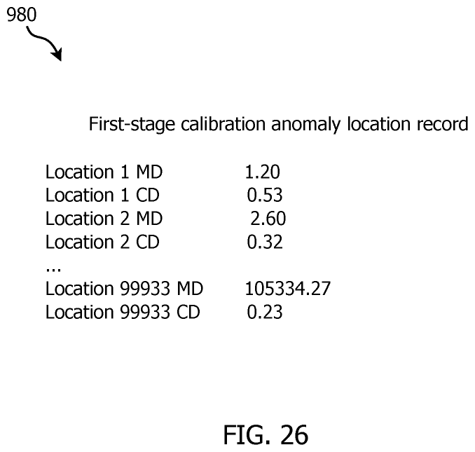

In some embodiments, the first-stage calibration anomaly identifying sensitivity may include a first-stage calibration anomaly identifying threshold that may have been previously initialized and stored in the location 1282 of the storage memory 1204 shown in FIG. 3. In some embodiments, for example, the first-stage calibration anomaly identifying sensitivity may include an anomaly identifying threshold value set to 25 and block 944 may direct the detector processor 1200 to identify any group of pixels having an anomalousness index value greater than 25 as representing anomalies. In various embodiments, block 944 may direct the detector processor 1200 to generate a first-stage calibration anomaly location record 980 as shown in FIG. 26 and to store the first-stage calibration anomaly location record 980 in the location 1284 of the storage memory 1204 shown in FIG. 3. In various embodiments, block 944 may direct the detector processor 1200 to count how many locations are stored in the first-stage calibration anomaly location record 980 to determine a count of anomalies. In various embodiments, block 944 may direct the detector processor 1200 to determine the first-stage calibration anomaly density by dividing the count of anomalies by the machine-direction length of the portion of the web 108 represented by the calibration set of first-stage images. In various embodiments, block 944 may direct the detector processor 1200 to store the determined first-stage calibration anomaly density in the location 1286 of the storage memory 1204.

Referring to FIG. 25, block 946 directs the detector processor 1200 to determine a calibration-based first-stage anomaly identifying sensitivity based at least in part on the first-stage calibration anomaly identifying sensitivity and the first-stage calibration anomaly density. In some embodiments, the calibration-based first-stage anomaly identifying sensitivity may be later used as the first first-stage anomaly identifying sensitivity described above having regard to the flowchart 500 shown in FIG. 6. In various embodiments, block 946 may include code generally similar to block 508 of the flowchart 500 shown in FIG. 6 and blocks 582 and 584 of the flowchart 580 shown in FIG. 9. In various embodiments, block 946 may direct the detector processor 1200 to determine a difference between the first-stage calibration density and a desired first-stage calibration density and to determine the first-stage calibration anomaly identifying sensitivity based at least in part on the determined difference. In various embodiments, the desired first-stage calibration density may have been previously stored in the location 1288 of the storage memory 1204. In various embodiments, block 946 may direct the detector processor 1200 to store the determined difference in the location 1290 of the storage memory 1204.

In some embodiments, the calibration-based first-stage anomaly identifying sensitivity may include a calibration-based first-stage anomaly threshold. In various embodiments, block 946 may direct the detector processor 1200 to determine the calibration-based first-stage anomaly threshold using the following equation:

$${T}_{11} = {T}_{1 c} \cdot exp ( {a}_{c} \cdot {D}_{c} )$$

where T₁₁ is the calibration-based first-stage anomaly threshold, T_{1c} is the first-stage calibration anomaly threshold, a_{c} is a scaling factor, and D_{c} is a relative difference determined by dividing the difference stored in the location 1290 of the storage memory 1204 shown in FIG. 3 by the desired anomaly density from the location 1288 of the storage memory 1204. In some embodiments, a_{c} may be set to a small number, such as 0.0001, for example, when the calibration set of first-stage images represents 1000 m in machine-direction length of the web 108.

In various embodiments, block 946 may direct the detector processor 1200 to store the value determined using the above equation as the first first-stage anomaly threshold in the location 1242 of the storage memory 1204 shown in FIG. 3. In various embodiments, after block 946 has been completed, the detector processor 1200 may execute the flowchart 500 shown in FIG. 6.

In various embodiments, the second anomaly detector 106 shown in FIG. 4 may be configured to execute code generally similar to the code included in the flowchart 940 before executing the flowchart 590 shown in FIG. 10, such that an initial setting for the first second-stage anomaly identifying sensitivity is determined and stored in the location 1454 of the storage memory 1404.

### Various Embodiments

In some embodiments, the system 100 shown in FIG. 1 or a system generally similar to the system 100 may be implemented according to various alternative or additional embodiments.

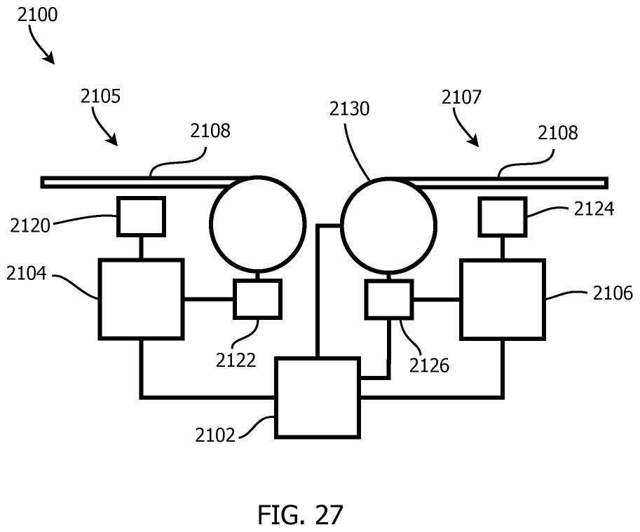

For example, referring to FIG. 27, there is provided a schematic view of a system 2100 for facilitating web position tracking in accordance with various embodiments. In various embodiments, the system 2100 may include some similar elements to elements included in the system 100 shown in FIG. 1. The system 2100 includes a position tracker 2102 in communication with a first anomaly detector 2104 and a second anomaly detector 2106. In some embodiments, the first and second anomaly detectors 2104 and 2106 may be configured to detect or sense anomalies in a web or portion of a web 2108 at first and second web processing stages 2105 and 2107, respectively.

In some embodiments, the first anomaly detector 2104 may be in communication with one or more first cameras 2120 and a first location sensor 2122 configured to sense a machine-direction web location or position to be associated with each of the images obtained by the one or more first cameras 2120. In some embodiments, the second anomaly detector 2106 may be in communication with one or more second cameras 2124 and a second location sensor 2126 configured to sense a machine-direction web location or position to be associated with each of the images obtained by one or more second cameras 2124. In various embodiments, the position tracker 2102 may be in communication with the second location sensor 2126, such that the position tracker 2102 may be configured to track a current web location at the second web processing stage 2107. In some embodiments, the system 2100 may include a web processing driver 2130 in communication with the position tracker 2102.

In various embodiments, the position tracker 2102, the first anomaly detector 2104, the second anomaly detector 2106, first and second web processing stages 2105 and 2107, the web 2108, the cameras 2120 and 2124 and the first and second location sensors 2122 and 2126, and the web processing driver 2130 may include some generally similar elements and/or functionality to some elements included in the position tracker 102, the first anomaly detector 104, the second anomaly detector 106, the first and second web processing stages 105 and 107, the web 108, the cameras 120 and 124 and the first and second location sensors 122 and 126, and the web processing driver 130 shown in FIG. 1 and described herein.

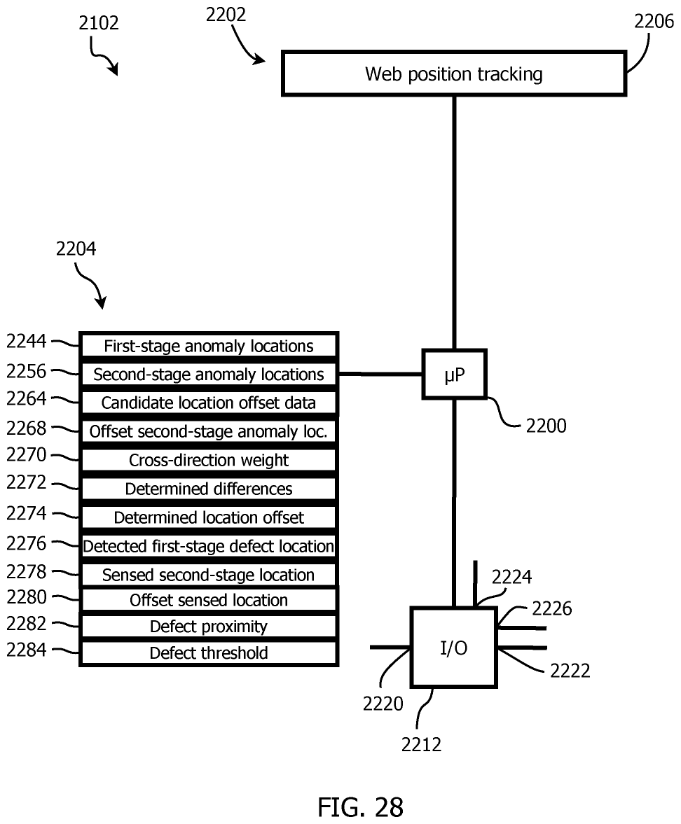

Referring to FIGS. 28, 29, and 30 schematic views of the position tracker 2102, the first anomaly detector 2104, and the second anomaly detector 2106 of the system 2100 shown in FIG. 27 according to various embodiments are shown. In various embodiments, the position tracker 2102, the first anomaly detector 2104, and the second anomaly detector 2106 shown in FIGS. 28, 29, and 30 may include generally similar elements to elements included in the position tracker 102, the first anomaly detector 104, and the second anomaly detector 106 shown in FIGS. 2, 3, and 4 and described herein.

Referring to FIG. 28, the position tracker 2102 includes a processor circuit including a tracker processor 2200 and a program memory 2202, a storage memory 2204, and an input/output (I/O) interface 2212, all of which are in communication with the tracker processor 2200.

The I/O interface 212 includes interfaces 2220 and 2222 for communicating with the first and second anomaly detectors 2104 and 2106 shown in FIG. 27, respectively. In various embodiments, the I/O interface 2212 may include an interface 2224 for communicating with the web processing driver 2130 shown in FIG. 27 and an interface 2226 for communicating with the second location sensor 2126.

Processor-executable program codes for directing the tracker processor 2200 to carry out various functions are stored in the program memory 2202. Referring to FIG. 2, the program memory 2202 includes a block of codes 2206 for directing the position tracker 2102 to perform facilitating web position tracking functions.

The storage memory 2204 includes a plurality of storage locations including location 2244 for storing first-stage anomaly location data, location 2256 for storing second-stage anomaly location data, location 2264 for storing candidate location offset data, location 2268 for storing offset first-stage anomaly location data, location 2270 for storing cross-direction weight data, location 2272 for storing determined difference data, location 2274 for storing determined location offset data, location 2276 for storing detected defect location data, location 2278 for storing sensed second-stage location data, location 2280 for storing offset sensed second-stage location data, location 2282 for storing defect proximity data, and location 2284 for storing defect threshold data. In various embodiments, the storage locations may be stored in a database in the storage memory 2204.

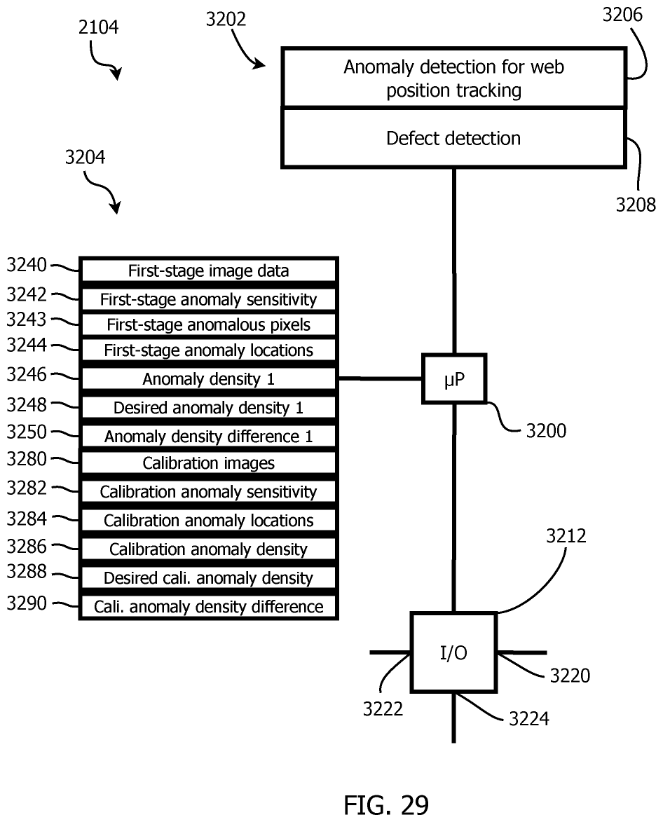

Referring now to FIG. 29, a schematic view of the first anomaly detector 2104 of the system 2100 shown in FIG. 27 according to various embodiments is shown. Referring to FIG. 29, the first anomaly detector 2104 includes a processor circuit including a detector processor 3200 and a program memory 3202, a storage memory 3204, and an input/output (I/O) interface 3212, all of which are in communication with the detector processor 3200.

The I/O interface 3212 includes interfaces 3220 and 3222 for communicating with the one or more first cameras 2120 and the first location sensor 2122 shown in FIG. 27 and an interface 1224 for communicating with the position tracker 2102 shown in FIG. 27.

Processor-executable program codes for directing the detector processor 3200 to carry out various functions are stored in the program memory 3202. Referring to FIG. 3, the program memory 3202 includes a block of codes 3206 for directing the first anomaly detector 2104 to perform facilitating anomaly detection for web position tracking functions and a block of codes 3208 for directing the first anomaly detector 2104 to detect defects.

The storage memory 3204 includes a plurality of storage locations including location 3240 for storing first-stage image data, location 3242 for storing first-stage anomaly identifying sensitivity data, location 3243 for storing first-stage anomalous pixels data, location 3244 for storing first-stage anomaly location data, location 3246 for storing first-stage anomaly density data, location 3248 for storing desired first-stage anomaly density data, location 3250 for storing first-stage anomaly density difference data, location 3280 for storing calibration image data, location 3282 for storing calibration anomaly identifying sensitivity data, location 3284 for storing calibration anomaly location data, location 3286 for storing calibration anomaly density data, location 3288 for storing desired calibration anomaly density data, and location 3290 for storing calibration anomaly density difference data. In various embodiments, the storage locations may be stored in a database in the storage memory 3204.

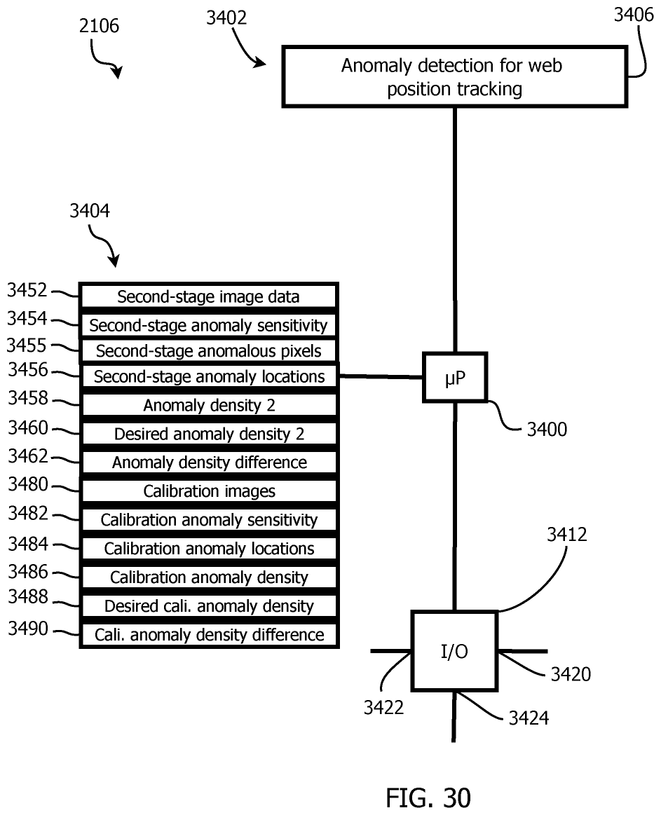

Referring to FIG. 30, a schematic view of the second anomaly detector 2106 of the system 2100 shown in FIG. 27 according to various embodiments is shown. In various embodiments, the second anomaly detector 2106 may include elements generally similar to those included in the first anomaly detector 2104 shown in FIG. 29. Referring to FIG. 30, the second anomaly detector 2106 includes a processor circuit including a detector processor 3400 and a program memory 3402, a storage memory 3404, and an input/output (I/O) interface 3412, all of which are in communication with the detector processor 3400.

The I/O interface 3412 includes interfaces 3420 and 3422 for communicating with the one or more second cameras 2124 and the second location sensor 2126 shown in FIG. 27 and an interface 3424 for communicating with the position tracker 2102 shown in FIG. 27.

Processor-executable program codes for directing the detector processor 3400 to carry out various functions are stored in the program memory 3402. Referring to FIG. 30, the program memory 3402 includes a block of codes 3406 for directing the second anomaly detector 2106 to perform facilitating anomaly detection for web position tracking functions.

The storage memory 3404 includes a plurality of storage locations including location 3452 for storing second-stage image data, location 3454 for storing second-stage anomaly identifying sensitivity data, location 3455 for storing second-stage anomalous pixels data, location 3456 for storing second-stage anomaly location data, location 3458 for storing second-stage anomaly density data, location 3460 for storing desired second-stage anomaly density data, location 3462 for storing second-stage anomaly density difference data, location 3480 for storing calibration image data, location 3482 for storing calibration anomaly identifying sensitivity data, location 3484 for storing calibration anomaly location data, location 3486 for storing calibration anomaly density data, location 3488 for storing desired calibration anomaly density data, and location 3490 for storing calibration anomaly density difference data. In various embodiments, the storage locations may be stored in a database in the storage memory 3404.

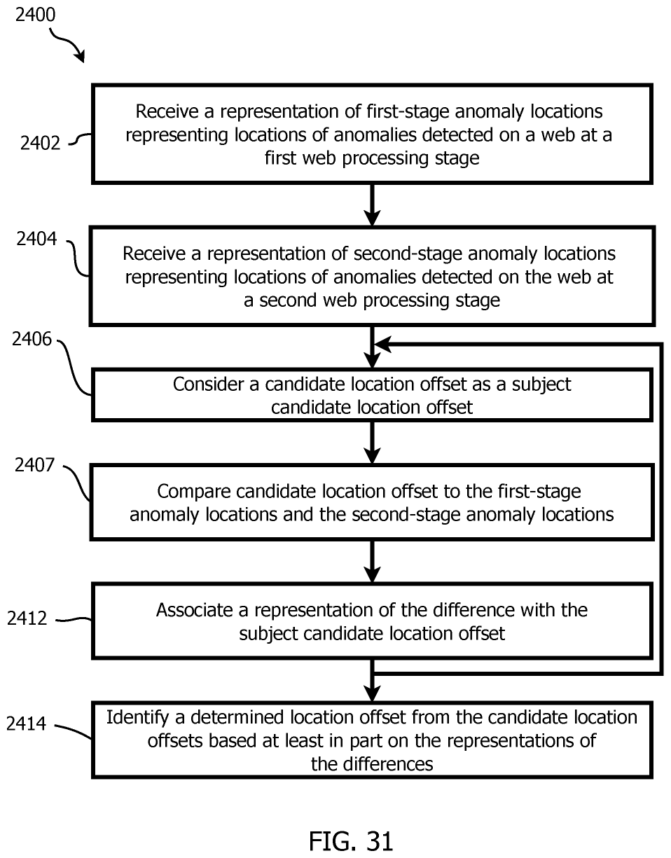

Referring to FIG. 31, a flowchart depicting blocks of code for directing tracker processor 2200 of the position tracker 2102 shown in FIG. 28 to perform facilitating web position tracking in accordance with various embodiments is shown generally at 2400. In various embodiments, the blocks of code included in the flowchart 2400 may be encoded in the block of codes 2206 of the program memory 2202 of the position tracker 2102 shown in FIG. 28.

Referring to FIG. 31, the flowchart 2400 begins with block 2402, which directs the tracker processor 2200 to receive a representation of first-stage anomaly locations representing locations of anomalies detected on a web at a first web processing stage. In some embodiments, block 2402 may be generally similar to block 402 of the flowchart 400 shown in FIG. 5.

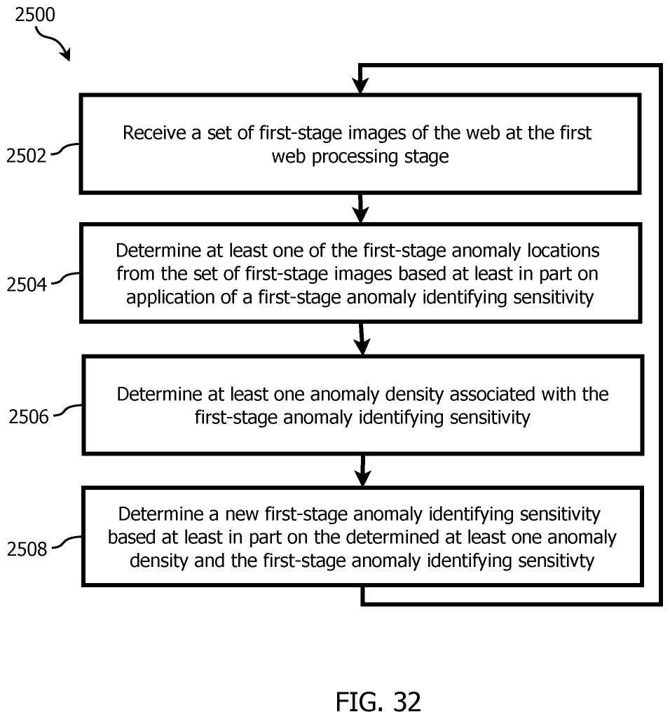

Referring to FIG. 32, a flowchart 2500 is shown, depicting blocks of code for directing the detector processor 3200 of the first anomaly detector 2104 shown in FIG. 29 to perform facilitating anomaly detection for web position tracking in accordance with various embodiments. In various embodiments, the blocks of code included in the flowchart 2500 may be encoded in the block of codes 3206 of the program memory 3202 of the first anomaly detector 2104 shown in FIG. 29.

Referring to FIG. 32, the flowchart 2500 begins with block 2502, which directs the detector processor 3200 to receive a set of first-stage images of the web 2108 at the first web processing stage 2105. In various embodiments, block 2502 may be generally similar to block 502 of the flowchart 500 shown in FIG. 6.

In some embodiments, block 2502 may direct the detector processor 3200 to receive, via the interface 3220 of the I/O interface 3212 shown in FIG. 29, a first set of first-stage images from the one or more first cameras 2120 of the system 2100 shown in FIG. 27 and to store the first set of first-stage images in the location 3240 of the storage memory 3204 shown in FIG. 29. In various embodiments, block 2502 may direct the detector processor 3200 to receive an associated machine-direction position from the first location sensor 2122 shown in FIG. 27, for each of the images included in the first set of first-stage images and to store the associated machine-direction position in association with each image of the first set of first-stage images stored in the location 3240 of the storage memory 3204.

Referring to FIG. 32, block 2504 directs the detector processor 3200 to determine at least one of the first-stage anomaly locations at least in part on application of a first-stage anomaly identifying sensitivity to the set of first-stage images. In various embodiments, block 2504 may direct the detector processor 1200 to determine a first set of first-stage anomaly locations based on application of a first first-stage anomaly identifying sensitivity to the first set of first-stage images.

In various embodiments, the first first-stage anomaly identifying sensitivity may include a plurality of anomaly identifying thresholds, each associated with a respective pixel position. In some embodiments, using different anomaly identifying thresholds each associated with a respective pixel position may facilitate fewer false identifications of anomalies, and/or more sensitive detection of true but relatively weak anomalies, and/or result in a generally more uniform distribution of detected anomalies across camera sensor(s) and/or in cross-direction, which may further facilitate better matching and/or tracking. In some embodiments, the anomaly identifying thresholds may be stored in the location 3242 of the storage memory 3204 of the first anomaly detector 2104 shown in FIG. 29. For example, in some embodiments, the first-stage images may include 1600×800 pixels and the first first-stage anomaly identifying sensitivity may include 1280000 anomaly identifying thresholds, each associated with a respective pixel.

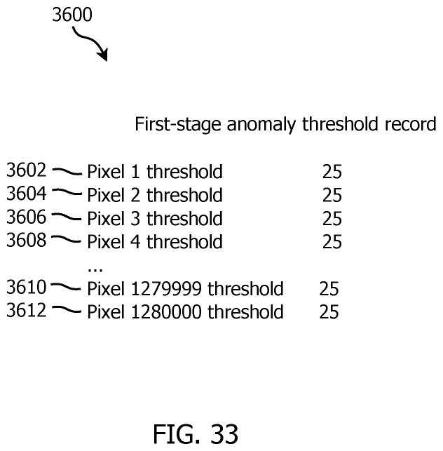

In some embodiments, the first first-stage anomaly identifying sensitivity may include a first-stage anomaly threshold record 3600 shown in FIG. 33, for example, and the first-stage anomaly threshold record may be stored in the location 3242 of the storage memory 3204 of the first anomaly detector 2104 shown in FIG. 29. Referring to FIG. 33, the first first-stage anomaly identifying sensitivity includes threshold fields 3602-3612 storing respective thresholds, each associated with a respective pixel position.

In some embodiments, the anomaly identifying thresholds may have been initialized to values that may be pre-set and chosen by a user. For example, in some embodiments, the thresholds may each be set to a value between 1 and 100. In some embodiments, the thresholds stored in the location 1242 may each be initially set to 25, for example.

In various embodiments, block 2504 may direct the detector processor 3200 to determine an anomalousness index value for each pixel generally similarly to as described with reference to block 504 of the flowchart 500 shown in FIG. 6 and described herein. In various embodiments, block 2504 may direct the detector processor 3200 to compare the anomalousness index value for each pixel to the first-stage anomaly identifying threshold from the first-stage anomaly threshold record 3600 associated with that pixel. Pixels where the anomalousness index value exceeds the associated first-stage anomaly identifying threshold may be identified as anomalous or considered anomalous. In some embodiments, block 2504 may direct the detector processor 3200 to consider any pixels within a threshold anomaly distance of a pixel having an anomalousness index value that exceeds the associated first-stage anomaly identifying threshold as anomalous. In some embodiments, where certain parts of the image may at times exhibit higher anomaly densities (because of true anomalies in the product, and/or false anomalies caused by lighting conditions, for example), this may, for example, help the detector processor 3200 better adapt the first-stage anomaly threshold record 3600, such that the first-stage anomaly density record 3640 may overall become more uniform across the different pixels, or otherwise better suited for the purpose, without undue delays. For example, in some embodiments, the threshold anomaly distance may be a pixel width and all 8 pixels adjacent to a pixel having an anomalousness index value that exceeds the associated first-stage anomaly identifying threshold may be identified as anomalous.

In various embodiments, block 2504 may direct the detector processor to store a first-stage anomalous pixels identifier storing an identification of each anomalous pixel, for each first-stage image stored in the location 3240, in the location 3243 of the storage memory 3203. For example, in some embodiments, each of the first-stage anomalous pixels identifiers may include a binary image and block 2504 may direct the detector processor to store a binary image for each of the first-stage images stored in the location 3240, the binary image storing a non-zero value or a zero value in association with each pixel position, with a non-zero value, such as 1 or 255, for example, identifying the pixel associated with that pixel position as an anomalous pixel, and a zero-value, such as 0, identifying the pixel with that pixel position as a non-anomalous pixel.

In some embodiments, the anomaly identifying sensitivity and/or the per-camera-pixel thresholds may be automatically adjusted such that the sensitivity of the second anomaly detector 106 may be automatically decreased whenever the line speed in the second web processing stage 107 is low. In some embodiments, the sensitivity may be decreased in proportion to how much the line speed is below a preconfigured threshold speed (or left unmodified if the line speed is not below the preconfigured threshold). In various embodiments, such as on winder machines in the paper industry, this desensitization may help prevent detection of false anomalies, for example when unwinding is first started. In some embodiments, sensitivity can be similarly decreased when the tension of the paper web or a similar product is low, for similar reasons.

In various embodiments, block 2504 of the flowchart 2500 shown in FIG. 32 may direct the detector processor 3200 to determine anomaly locations based on the identified anomalous pixels and their associated locations generally similarly to as described herein having regard to block 504 of the flowchart 500 shown in FIG. 6. Block 2504 may direct the detector processor 3200 to store the determined first set of first-stage anomaly locations in a first-stage anomaly location record the location 3244 of the storage memory 3204 shown in FIG. 29.

In some embodiments, the flowchart 2500 and/or the block 2504 may include a block of codes for directing the detector processor 3200 to send a representation of the first-stage anomaly locations to the position tracker 2102 shown in FIG. 28. For example, in some embodiments, the flowchart 2500 may include a block directing the detector processor 3200 to cause signals representing a first-stage anomaly location record to be transmitted to the position tracker 2102 via the interface 3224 of the I/O interface 3212 shown in FIG. 29.

Referring to FIG. 32, in some embodiments, the flowchart 2500 may include blocks 2506 and 2508, which may direct the detector processor 3200 to determine a second first-stage anomaly identifying sensitivity for application to a second set of first-stage images. In various embodiments, the second first-stage anomaly identifying sensitivity may be different from the first first-stage anomaly identifying sensitivity.

Referring to FIG. 32, block 2506 directs the detector processor 3200 to determine at least one anomaly density associated with the first-stage anomaly identifying sensitivity. In various embodiments, block 2506 may direct the detector processor 3200 to proceed generally as described herein for block 506 of the flowchart 500 shown in FIG. 6, except determining a plurality of anomaly densities, each associated with a respective pixel position. In various embodiments, the anomaly density may be an anomalous pixel density. In various embodiments, the anomaly density may be determined for each pixel position as a count of anomalous pixels identified per length of the web 2108, for example. In various embodiments, block 2506 may direct the detector processor 1200 to determine each anomaly density by counting how many anomalies have been detected at a pixel position within a sampling machine-direction proximity of the most recent image included in the first set of first-stage images. Block 2506 may direct the detector processor 3200 to determine the anomaly densities based on the first-stage anomalous pixels identifiers stored in the location 3243 of the storage memory 3204.

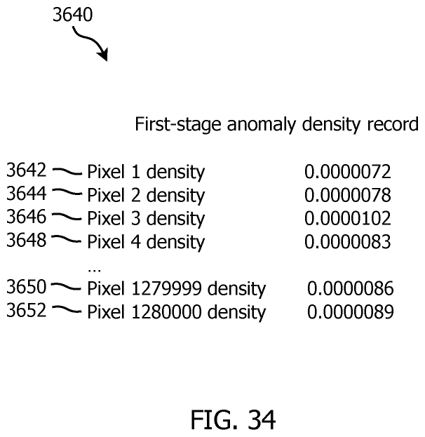

In various embodiments, block 2506 may direct the detector processor 3200 to store the anomaly densities in a first-stage anomaly density record 3640 shown in FIG. 34 and block 2506 may direct the detector processor 3200 to store the first-stage anomaly density record 3640 in location 3246 of the storage memory 3204.

Referring to FIG. 32, block 2508 directs the detector processor 3200 to determine a new first-stage anomaly identifying sensitivity based at least in part on the determined at least one anomaly density and the first-stage anomaly identifying sensitivity. In various embodiments, block 2508 may include code generally similar to that included in the block 508 of the flowchart 500 shown in FIG. 6 except that block 2508 may direct the detector processor 3200 to determine a plurality of new first-stage anomaly thresholds, each associated with a respective pixel position.

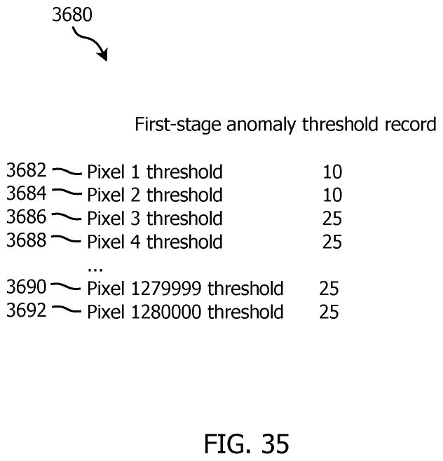

In various embodiments, block 2508 may direct the detector processor 3200 to read the first-stage anomaly threshold record 3600 shown in FIG. 33 and the first-stage anomaly density record 3640 shown in FIG. 34 from the locations 3242 and 3246 of the storage memory 3204 shown in FIG. 29 and to determine a second first-stage anomaly threshold record 3680 as shown in FIG. 35 based at least in part on first-stage anomaly threshold record 3600 and the first-stage anomaly density record 3640. In various embodiments, block 2508 may direct the detector processor 3200 to store the second first-stage anomaly threshold record 3680 as a second first-stage anomaly identifying sensitivity in the location 3242 of the storage memory 3204.

In various embodiments, block 2508 may include code generally similar to the blocks of the flowchart 580 shown in FIG. 9, for determining each first-stage anomaly threshold to be included in the second first-stage anomaly threshold record 3680 shown in FIG. 35. In various embodiments, block 2508 may direct the detector processor 3200 to, for each pixel position, subtract a desired first-stage anomaly density stored in the location 3248 of the storage memory 3204 shown in FIG. 29 from an anomaly density field value of the first-stage anomaly density record 3640 shown in FIG. 34 and stored in the location 3248 of the storage memory 3204 to determine a difference and block 2508 may direct the detector processor 3200 to store the difference in the location 3250 of the storage memory 3204.

In some embodiments, the desired first-stage anomaly density may have been previously set and stored in the location 3248 of the storage memory 1204. In some embodiments, the desired first-stage anomaly density may be set based on a desired anomaly density relative to a machine-direction length, which may facilitate web position tracking using the position tracker 2102. For example, in some embodiments, the desired first-stage anomaly density may be 0.00001 anomalous pixels per meter of machine-direction length. In various embodiments, the desired first-stage anomaly density may have been previously set by a user and/or may be adjusted, for example, such that enough anomalies are detected for starting to track early, but at the same time not too many anomalies are detected, as many of them might be false and/or otherwise not detectable in the second web processing stage 107, for example.

In some embodiments, block 2508 may direct the detector processor 3200 to determine each of the new first-stage anomaly thresholds, which may act as second first-stage anomaly thresholds, using the following equation:

$${T}_{12} = {T}_{11} \cdot exp ( {a}_{1} \cdot {D}_{1} )$$

where T₁₂ is the second first-stage anomaly threshold, T₁₁ is the first first-stage anomaly threshold, a₁ is a scaling factor, and D₁ is a relative difference determined by dividing the difference determined and stored in the location 3250 of the storage memory 3204 shown in FIG. 29 by the desired first-stage anomaly density from the location 3248 of the storage memory 1204. In some embodiments, a₁ may be set to a small number, such as 0.0001, for example, when the first set of first-stage images represents 1000 m in machine-direction length of the web 2108.

In various embodiments, block 2508 may direct the detector processor 3200 to store each of the values determined using the above equation in a first-stage anomaly threshold field of a second first-stage anomaly threshold record 3680 shown in FIG. 35 and to store the second first-stage anomaly threshold record 3680 in the location 3242 of the storage memory 3204 shown in FIG. 29.

Referring to FIG. 32, in various embodiments, after block 2508 has been completed, the detector processor 3200 may return to block 2502 and a further set of first-stage images may be received. In various embodiments, block 2504 may be executed by applying the second first-stage anomaly identifying sensitivity including the second first-stage anomaly threshold record 3680 shown in FIG. 35 and stored in the location 3242 of the storage memory 3204 to the second set of first-stage images.

In various embodiments, blocks 2502-2508 of the flowchart 2500 shown in FIG. 32 may be executed for each set of first-stage images, representing respective portions of the web 2108. In various embodiments, after execution of the flowchart 2500 is complete, one or more first-stage anomaly location records representing anomaly locations may be stored in the location 3244 of the storage memory 3204.

Referring to FIG. 27, in various embodiments, the flowchart 2500 shown in FIG. 32 may be executed during processing of the web 2108 at the first web processing stage 2105. Referring back to FIG. 31, in various embodiments, block 2402 may direct the tracker processor 2200 to receive, via the interface 2220 of the I/O interface 2212 shown in FIG. 28, representations of the first-stage anomaly location records stored in the location 3244 of the storage memory 3204 from the first anomaly detector 2104 and to store the first-stage anomaly location records in the location 2244 of the storage memory 2204.

In various embodiments, after processing at the first web processing stage has been completed, the web 2108 may be moved to the second web processing stage 2107, and the web 2108 may be further processed there. In various embodiments, after or during processing of the web at the second web processing stage 2107, block 2404 of the flowchart shown in FIG. 31 may be executed.

Referring to FIG. 31, in various embodiments, the flowchart 2400 continues at block 2404, which directs the tracker processor 2200 to receive a representation of second-stage anomaly locations representing locations of anomalies detected on the web 2108 at the second web processing stage 2107 shown in FIG. 27. In various embodiments, block 2404 may direct the tracker processor 2200 to receive, via the interface 2222 of the I/O interface 2212 shown in FIG. 28, the representation of second-stage anomaly locations from the second anomaly detector 2106.

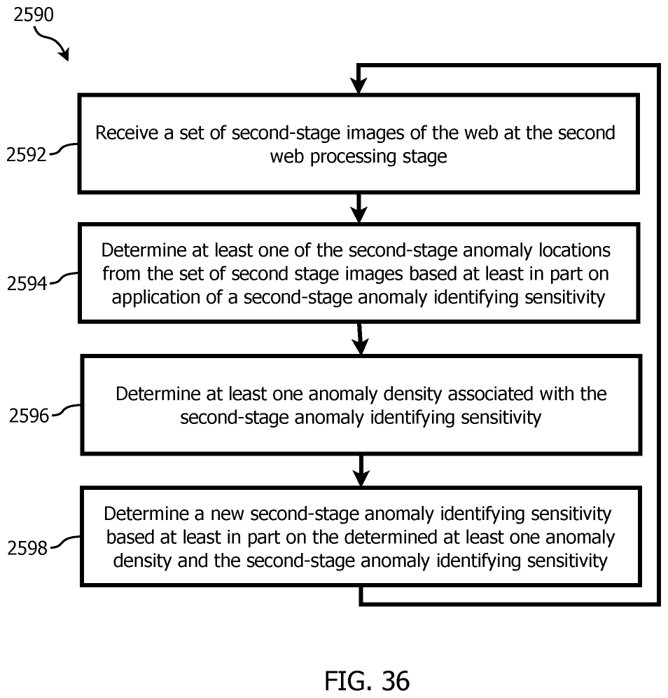

In various embodiments, the second anomaly detector 2106 may be configured generally similarly to the first anomaly detector 2104. Referring to FIG. 36, there is shown a flowchart 2590 depicting blocks of code 2592, 2594, 2596, and 2598 for directing the detector processor 3400 shown in FIG. 30 to perform facilitating anomaly detection for web position tracking in accordance with various embodiments. In various embodiments, the blocks of code included in the flowchart 2590 may be encoded in the block of codes 3406 of the program memory 3402 shown in FIG. 30. In various embodiments, the flowchart 2590 may include blocks of code generally similar to those included in the flowchart 590 shown in FIG. 10, except adapted to apply pixel specific thresholds generally similarly to as described herein regarding the flowchart 2500 shown in FIG. 32.

In some embodiments, the expected rate of false anomalies may be higher in the first web processing stage 2105 than in the second web processing stage 2107. Thus, in various embodiments, the desired second-stage anomaly density may be less than the desired first-stage anomaly density. For example, in some embodiments, the desired second-stage anomaly density may be less than 90% of the desired first-stage anomaly density. For example, in some embodiments, the desired second-stage anomaly density may be about 0.000008 anomalies per meter and the desired first-stage anomaly density may be about 0.00001 anomalies per meter.

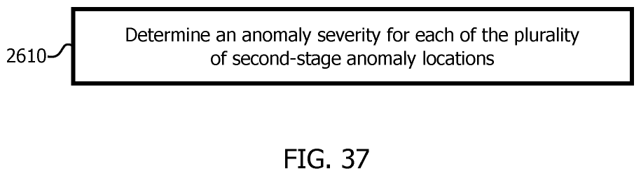

In some embodiments, the flowchart 2590 may include a block of codes 2610 shown in FIG. 37 for directing the detector processor 3400 shown in FIG. 30 to determine an anomaly severity for each of the plurality of second-stage anomaly locations. In some embodiments, block 2610 may be included in the block of codes 2594 or executed concurrently with the block of codes 2594 of the flowchart 2590 shown in FIG. 36.

In various embodiments, the anomaly severity may include an anomaly intensity value and block 2610 may direct the detector processor 3400 to determine the intensity value as an aggregate value of the anomalousness index values of the pixels that are part of the anomaly. For example, in some embodiments, the intensity value may be determined as the sum of the anomalousness index values of the pixels that are part of the anomaly. Alternatively, in some embodiments, the intensity value may be determined as the maximum anomalousness index value over the pixels that are part of the anomaly.

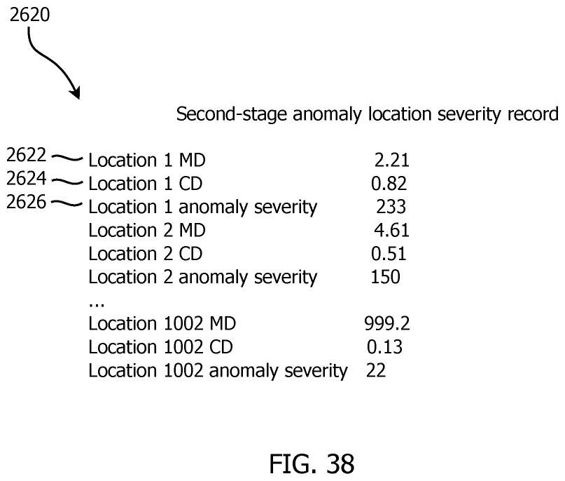

In various embodiments, block 2610 may direct the detector processor 3400 to generate and store a second-stage anomaly location severity record 2620 as shown in FIG. 38 in the location 3456 of the storage memory 3404 shown in FIG. 30. In various embodiments, the second-stage anomaly location severity record 2620 includes first second-stage anomaly location fields 2622 and 2624 for storing an increasing machine-direction location and a cross-direction location respectively of a first anomaly and a first anomaly severity field 2626 for storing an anomaly severity associated with the first anomaly and the second-stage anomaly location fields 2622 and 2624. In various embodiments, the second-stage anomaly location severity record 2620 includes additional second-stage anomaly location fields and associated anomaly severity fields.

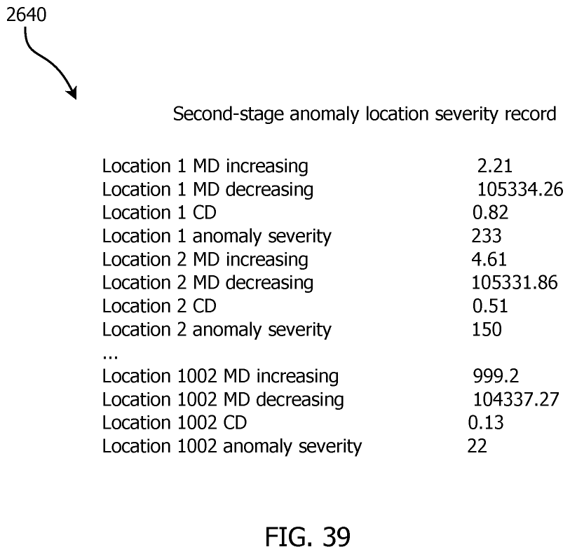

Referring back to FIG. 31, block 2404 directs the tracker processor 2200 to receive a representation of second-stage anomaly locations representing locations of anomalies detected on the web 2108 at the second web processing stage 2107 shown in FIG. 27. In some embodiments, block 2404 may direct the tracker processor 2200 to receive a respective anomaly severity associated with each of the second-stage anomaly locations. In some embodiments, block 2404 may direct the tracker processor 2200 to receive a representation of the second-stage anomaly location severity record 2620 shown in FIG. 38 from the second anomaly detector 2106 via the interface 2222 shown in FIG. 28 and to store the second-stage anomaly location severity record 2620 in the location 2256 of the storage memory 2204 shown in FIG. 28. In some embodiments, block 2404 may direct the tracker processor 200 to generate and store in the location 2256 an updated second-stage anomaly location severity record 2640 shown in FIG. 39 including decreasing machine-direction fields based on the second-stage anomaly location severity record 2620 shown in FIG. 38, generally as described herein having regard to block 404 of the flowchart 400 shown in FIG. 5 and the second-stage anomaly location record 640 shown in FIG. 13.

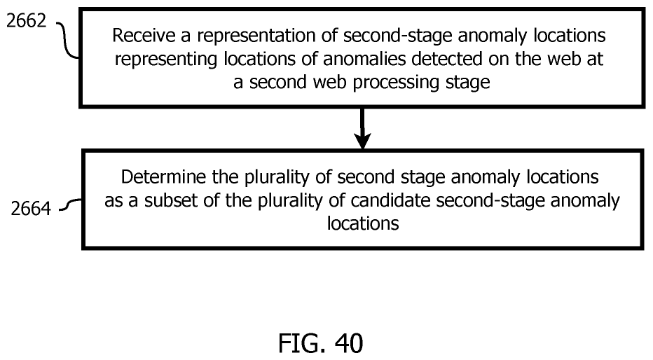

In some embodiments, the second-stage anomaly locations initially received at block 2404 of the flowchart 2400 shown in FIG. 31 and stored in the second-stage anomaly location severity record 2640 shown in FIG. 39 may act as candidate second-stage anomaly locations and the flowchart 2400 may include blocks of code for directing the tracker processor 2200 to disregard at least one of the received candidate second-stage anomaly locations. For example, in various embodiments, block 2404 of the flowchart 2400 shown in FIG. 31 may include blocks of code 2662 and 2664 as shown in FIG. 40. In various embodiments, disregarding at least one of the received candidate second-stage anomaly locations may facilitate improved, such as faster and/or more accurate, offset determining.

Referring to FIG. 40, in various embodiments, block 2662 may direct the tracker processor 2200 to receive a representation of a plurality of candidate second-stage anomaly locations. In some embodiments, block 2662 may direct the tracker processor 2200 to receive a representation of the second-stage anomaly location severity record 2620 shown in FIG. 38 from the second anomaly detector 2106 via the interface 2222 shown in FIG. 28 and to generate and store the second-stage anomaly location severity record 2640 shown in FIG. 39 in the location 2256 of the storage memory 2204 shown in FIG. 28.

Referring still to FIG. 40, block 2664 directs the tracker processor 2200 to determine the plurality of second-stage anomaly locations as a subset of the plurality of candidate second-stage anomaly locations. In various embodiments, block 2664 may direct the tracker processor 2200 to rank the plurality of candidate second-stage anomaly locations and choose the subset as one or more highest ranking candidate second-stage anomaly locations. In some embodiments, ranking the candidate second-stage anomaly locations and then choosing a subset based on the ranking may facilitate faster and/or more accurate offset determining later on.

In some embodiments, block 2664 may direct the tracker processor 2200 to rank each of the plurality of candidate second-stage anomaly locations based at least in part on a proximity of the second-stage anomaly location to a location of the web currently at the second web processing stage. In some embodiments, this may facilitate faster and/or more accurate offset determining because more recently detected anomaly locations may be more important for consideration when determining how offset the web 2108 shown in FIG. 27 is at the second web processing stage 2107 compared to at the first web processing stage 2105.

In some embodiments, block 2664 may direct the tracker processor 2200 to rank each of the plurality of candidate second-stage anomaly locations based at least in part on a severity of an anomaly associated with the candidate second-stage anomaly location. In some embodiments, this may facilitate faster and/or more accurate offset determining because more severe or larger anomalies may be more accurately sensed and therefore more important for consideration when determining the offset.

In some embodiments, block 2664 may direct the tracker processor 2200 to determine an anomaly importance score for association with each of the candidate second-stage anomaly locations. For example, in some embodiments, block 2664 may direct the tracker processor 2200 to determine the anomaly importance score as follows:

$${I}_{a} = {S}_{a} \times {D}_{a}$$

Where Iₐ is the anomaly importance score, Sₐ is the anomaly severity associated with the anomaly, and Dₐ is the increasing machine-direction location for the second-stage anomaly location (e.g., as determined from the second-stage anomaly location severity record or by subtracting a decreasing machine-direction location from a determined total length of the web 108). In various embodiments a higher increasing machine-direction location may correspond with the anomaly being in closer proximity to the location of the web 2108 currently at the second web processing stage.

In various embodiments, block 2664 may direct the tracker processor 2200 to rank the candidate second-stage anomaly locations according to their anomaly importance scores and block 2664 may direct the tracker processor 2200 to generate a new second-stage anomaly location severity record having fields generally similar to the second-stage anomaly location severity record 2640 but including a subset of the candidate second-stage anomaly locations. For example, in some embodiments, block 2664 may direct the tracker processor 200 to include only a threshold number of the candidate second-stage anomaly locations, based on anomaly importance score. For example, in some embodiments, the top threshold number may be a top 500 anomaly locations as ranked based on the anomaly importance scores. In some embodiments, the top threshold number may be 2000.

In various embodiments, block 2664 may direct the tracker processor 2200 to store the determined subset of second-stage anomaly locations in an updated second-stage anomaly location severity record in the location 2256 of the storage memory 2204 shown in FIG. 28.

Referring to FIG. 31, in various embodiments, block 2404 may be executed continually while the web 2108 is processed at the second web processing stage 2107 shown in FIG. 27. In some embodiments, blocks 2662 and 2664 may be executed repeatedly, such as, for example, after each representation of a second-stage anomaly location is received.

In various embodiments, during or after block 2404 has been executed, the tracker processor 2200 may be directed to test candidate location offsets to determine a location offset. Accordingly, in various embodiments, during or after block 2404 has been executed, the tracker processor 2200 may be directed to proceed to block 2406. In various embodiments, block 2406 directs the tracker processor 200 to consider a candidate location offset as a subject candidate location offset. In some embodiments, block 2406 may include some elements generally similar to those included in block 406 of the flowchart 400 shown in FIG. 2.

In some embodiments, the web 2108 shown in FIG. 27 may stretch, shrink, and/or otherwise deform between the first web processing stage 2105 and the second web processing stage 2107. Alternatively or in addition, the first and second location sensors 2122 and 2126 may have not been properly calibrated relative to each other, and/or another factor may cause perceived stretching, shrinking and/or deformation between the first and second web processing stages 2105 and 2107. Accordingly, in some embodiments, the subject candidate location offset may include at least one candidate scale factor for accounting for any true and/or perceived stretching, shrinking, and/or deformation between the first and second web processing stages 2105 and 2107.

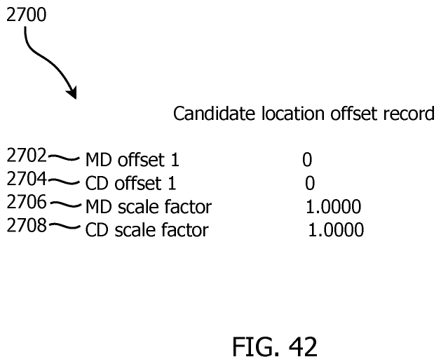

Referring to FIG. 42, there is shown a subject candidate location offset record 2700 that may be stored in the location 2264 in accordance with various embodiments. In some embodiments, the subject candidate location offset record 2700 includes a machine-direction offset field 2702 and a cross-direction offset field 2704 for storing respective candidate location offsets in the machine-direction and cross-direction. In some embodiments, the subject candidate location offset record 2700 includes a machine-direction scale factor field 2706 for storing a scale factor to be used to account for perceived stretching, shrinking, and/or deformation of the web 2108 in the machine direction. In some embodiments, the subject candidate location offset record 2700 includes a cross-direction scale factor field 2708 for storing a scale factor to be used to account for perceived stretching, shrinking, and/or deformation of the web 2108 in the cross-direction. In various embodiments, the scale factors may be used to scale or adjust the machine-direction offset and/or the cross-direction offsets, before being added to the second-stage anomaly locations, depending on a location of the second-stage anomaly location to which it is to be added.

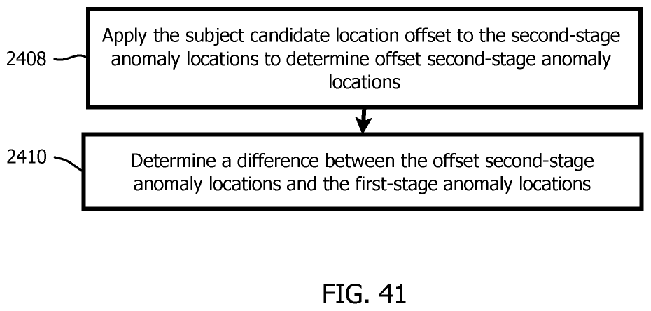

Block 2407 then directs the tracker processor 2200 to compare the subject candidate location offset to the first-stage anomaly locations and the second-stage anomaly locations to determine a representation of a difference to be associated with the candidate location offset. In some embodiments, block 2407 may include code for directing the tracker processor 200 to apply the candidate location offset to the second-stage anomaly locations to determine offset second-stage anomaly locations, and determine a difference between the offset second-stage anomaly locations and the first-stage anomaly locations and so block 2407 may include the blocks of code 2408 and 2410 shown in FIG. 41. In various embodiments, block 2408 and 2410 shown in FIG. 41 may be generally similar to blocks 408 and 410 of the flowchart 400 shown in FIG. 15 except for some differences, including, for example, that blocks 2408 and 2410 may account for scaling and may direct the tracker processor 2200 to apply the candidate location offset to the second-stage anomaly locations instead of the first-stage anomaly locations when checking the candidate offsets.

In various embodiments, it may be advantageous to match the anomaly locations by determining, for each location in the second-stage anomaly location record, a location in the (offset) first-stage anomaly location record that is closest-instead of the other way around, i.e. by determining for each first-stage anomaly a corresponding second-stage anomaly. In some embodiments, this may be the case because it may be more likely that no corresponding second-stage anomaly is found for a first-stage anomaly, than the other way around (i.e., that no corresponding first-stage anomaly would be found for a second-stage anomaly). For example, there may be more pieces of paper suspended in the air in the dry end of a paper machine at the first web processing stage 2105, than there is generally on a winder machine at the second web processing stage 2107. In some embodiments, using a quadtree or FLANN based search or similar, it may be advantageous to match the anomaly locations by determining, for each location in the second-stage anomaly location record, a location in the (offset) first-stage anomaly location record that is closest-instead of the other way around.

Referring to FIG. 41, in various embodiments, block 2408 directs the tracker processor 2200 to apply the subject candidate location offset to the second-stage anomaly locations to determine a plurality of offset second-stage anomaly locations.

In various embodiments, block 2408 may direct the tracker processor 2200 to, for each of the plurality of second-stage anomaly locations, determine at least one candidate offset distance adjusted based on a location of the second-stage anomaly location and to add the at least one candidate offset distance to the second-stage anomaly location. For example, in some embodiments, block 2408 may direct the tracker processor 2200 to determine a machine-direction offset distance, for each of the second-stage anomaly locations, as follows:

$$M {D}_{d} = M {D}_{o} + {S}_{f} \times M {D}_{s}$$

Where MD_{d} is the machine-direction offset distance, MDₒ is the machine-direction offset from the machine-direction offset field 2702 shown in FIG. 42, S_{f} is the machine-direction scale factor from the machine-direction scale factor field 2706 shown in FIG. 42, and MDₛ is the decreasing machine-direction location acting as the second-stage anomaly location.

In various embodiments, block 2408 may direct the tracker processor 2200 to determine a cross-direction offset distance generally similarly.

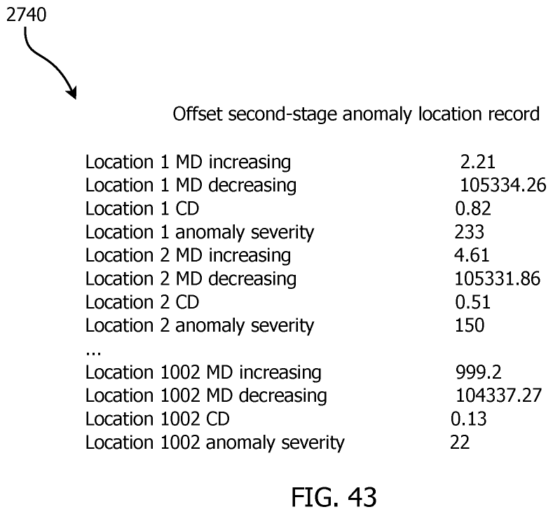

In various embodiments, block 2408 may direct the tracker processor 2200 to determine and add a respective machine-direction offset distance and cross-direction offset distance to each of the second-stage anomaly locations of the second-stage anomaly location record stored in the location 2256 of the storage memory 2204 shown in FIG. 28. In various embodiments, block 2408 may direct the tracker processor 2200 to store a resulting offset second-stage anomaly location record 2740 shown in FIG. 43 in the location 2268 of the storage memory 2204.

Referring to FIG. 41, block 2410 directs the tracker processor 2200 to determine a difference between the offset second-stage anomaly locations and the first-stage anomaly locations. In various embodiments, block 2410 may include code that is generally similar to that included in block 410 of the flowchart 400 shown in FIG. 15.

In some embodiments, block 2410 may direct the tracker processor 2200 tracker processor 2200 to determine a respective offset difference for each of the offset second-stage anomaly locations. For example, in some embodiments, block 2410 may direct the tracker processor 2200 to determine the difference between each offset second-stage anomaly location in the offset second-stage anomaly location record 2740 relative to a matched location from the first-stage anomaly location record stored in the location 2244 of the storage memory 2204 shown in FIG. 28.

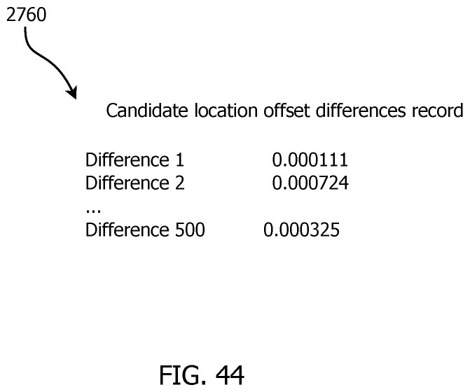

In various embodiments, block 2410 may direct the tracker processor 2200 to store the result in a candidate location offset differences record 2760 shown in FIG. 44, in the location 2272 of the storage memory 2204 shown in FIG. 28.

Referring to FIG. 31, in various embodiments, block 2412 may direct the tracker processor 2200 to associate a representation of the difference with the candidate location offset. In some embodiments, block 2412 may direct the tracker processor 2200 to use a cost function to determine the representation of the difference.

In some embodiments, block 2412 may direct the tracker processor 2200 to, for each of the offset differences, determine a respective weighted offset difference based on the offset difference and an anomaly weight associated with the offset difference. In some embodiments, block 2412 may direct the tracker processor 2200 to determine each of the respective anomaly weights based on a severity of an anomaly from which the associated offset difference was determined. In some embodiments, this may facilitate more accurate and/or consistent identifying of the determined location offset by emphasizing matching of more important or severe anomalies.

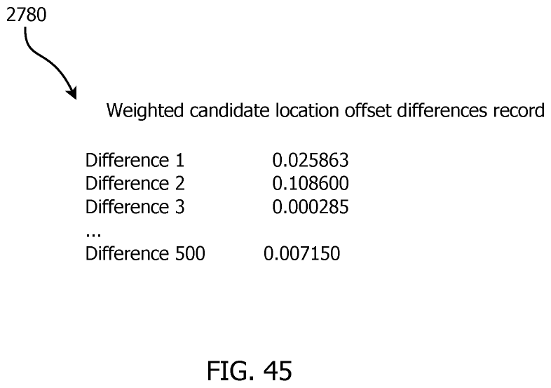

In some embodiments, block 2412 may direct the tracker processor 2200 to use the anomaly severity associated with the second-stage anomaly location from which the offset difference was determined as the anomaly weight. In various embodiments, block 2412 may direct the tracker processor 2200 to generate a weighted candidate location offset differences record 2780 as shown in FIG. 45 by multiplying each offset difference from the candidate location offset differences record 2760 by the anomaly severity associated with the second-stage anomaly location from which the offset difference was determined.

In various embodiments, block 2412 may direct the tracker processor 2200 to store the weighted candidate location offset differences record 2780 in the location 2272 of the storage memory 2204.

In various embodiments, block 2412 may direct the tracker processor 2200 to identify a representative subset of the weighted candidate location offset differences from the weighted candidate location offset differences record 2780 shown in FIG. 45 and to determine the representation of the difference based on the representative subset. In some embodiments, this may facilitate disregarding differences arising from second-stage anomalies that do not have a corresponding match in the first-stage anomalies, which may result in a better representation of the difference for ranking candidate location offsets.

In various embodiments, block 2412 may direct the tracker processor 2200 to identify the representative subset of the weighted candidate location offset differences based on the unweighted differences from which the weighted differences are derived. For example, in some embodiments, block 2412 may direct the tracker processor 2200 to use the candidate location offset differences record 2760 to identify the representative subset. In some embodiments, block 2412 may direct the tracker processor 2200 to identify the representative subset as the weighted differences derived from the lowest ones of the unweighted differences stored in the candidate location offset differences record 2760 shown in FIG. 44. In some embodiments, the representative subset may be a fraction of the determined weighted differences. For example, in some embodiments, the fraction may be 10%. In some embodiments, the number of differences included in the representative subset may be the greatest of the fraction and a minimum number, which may be previously determined and set to a value, such as, for example 20.

In some embodiments, block 2412 may direct the tracker processor 2200 to scale the summed subset of weighted candidate location offset differences. In various embodiments, this may facilitate comparing summed subsets determined for different candidate location offsets. In various embodiments, this may further facilitate comparing different candidate location offsets. For example, in some embodiments, block 2412 may direct the tracker processor 2200 to divide the sum of the representative subset of weighted candidate location offset differences by the total aggregate or summed weight of the second-stage anomalies included in the representative subset. In various embodiments, this may reduce favoring solutions that disregard the most severe second-stage anomalies, which may be the most useful landmarks in the web 2108. In some embodiments, block 2412 may direct the tracker processor 2200 to multiply the result or quotient by the total weight of all considered second-stage anomalies. In various embodiments, the resulting value may be used as the representation of the difference.

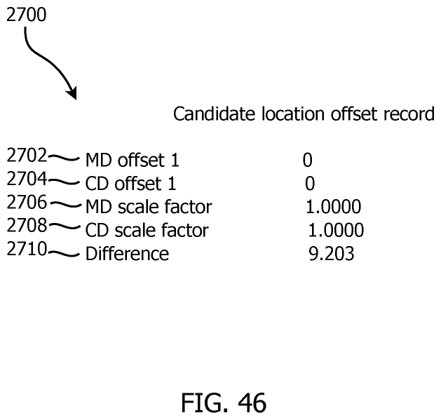

In various embodiments, block 2412 may direct the tracker processor 2200 to update the subject candidate location offset record 2700 in the location 2264 of the storage memory 2204 shown in FIG. 28 to include a representative difference field 2710 storing the determined representation of the difference, as shown in FIG. 46.

In various embodiments, after block 2412 has been executed, the tracker processor 2200 may be directed to return to block 2406 of the flowchart 2400 shown in FIG. 31 to consider a new candidate location offset as the subject candidate location offset and to repeat blocks 2406, 2407, and 2412 with the new candidate location offset. In various embodiments, block 2406 may direct the tracker processor 2200 to identify a new candidate location offset from a multidimensional grid including different values for MD offset, CD offset, MD scale factor, and CD scale factor. In some embodiments, MD offsets and CD offsets may be as described herein having regard to the flowchart 400 shown in FIG. 5. In some embodiments, MD scale factors between 0.996 and 1.002 may be considered. The MD scale factor grid step size could be 0.002, for example. Similarly, CD scale factors between 0.98 and 1.02 may be considered, for example. The CD scale factor grid step size may be 0.02, for example.

In some embodiments, the scale factors considered may not be centered around 1.000, as it may be that on average stretching or shrinking may be expected between the first web processing stage 2105 and the second web processing stage 2107 shown in FIG. 27. Alternatively or in addition, and specifically in case of the MD scale factor, it may be expected that the first and second location sensors 2122 and 2126 may not have been properly calibrated relative to each other, but instead one sensor may be expected to, on average, measure relatively longer values than the other for the same physical distance.

In various embodiments, blocks 2406, 2407, and 2412 of the flowchart 2400 shown in FIG. 31 may be repeated for further candidate location offsets. In some embodiments, once all grid locations in a first grid have been considered, the tracker processor 2200 may be directed to proceed to block 2414. In some embodiments, after the first grid has been considered, blocks 2406, 2407, and 2412 may be repeated for at least one additional grid that may be offset from the first grid by different offsets that may range between

$$- \frac{{g}_{d}}{2} and \frac{{g}_{d}}{2} ,$$

where g_{d} is the grid step size in the corresponding search dimension d. In various embodiments, this may facilitate successive search operations effectively using a differently offset grid, which may help to asymptotically cover the entire search space.

In various embodiments, the first grid may not be considered at all, but instead blocks 2406, 2407, and 2412 may be executed only for the at least one additional grid that may be offset from the first grid by different offsets that may range between

$$- \frac{{g}_{d}}{2} and \frac{{g}_{d}}{2}$$

in each search dimension d.

In some embodiments, the offset in each dimension d between the first grid and each additional grid may be a random value between

$$- \frac{{g}_{d}}{2} and \frac{{g}_{d}}{2}$$

that is generated separately for each dimension d of each grid that is being applied. In various embodiments, the offsets may be generated deterministically. For example, in some embodiments, successive offsets may be picked from recursive subdivisions of the search range

$$[ - \frac{{g}_{d}}{2} , \frac{{g}_{d}}{2} ] ,$$

such as, for example, similarly to how quadtrees may be constructed.

In various embodiments that may use a differently-offset grid for each search operation, the best (=lowest-cost) solution (e.g., the determined location offset record having the lowest value in the representative difference field) may be maintained between different searches, such that if a better solution having a lower value in the representative difference field is not found as the result of a new search, the previously found best solution may continue to be used.

In various embodiments, repeated execution of blocks 2406, 2407, and 2412 may result in many candidate location offset records having format generally similar to the candidate location offset record 2700 shown in FIG. 46 being stored in the location 2264 of the storage memory 2204 shown in FIG. 28.

Referring to FIG. 31, in various embodiments, after blocks 2406, 2407, and 2412 have been executed and more than one candidate location offset record is stored in the location 2264 of the storage memory 2204, the tracker processor 2200 may proceed to block 2414. Block 2414 directs the tracker processor 2200 to identify a determined location offset from the candidate location offsets based at least in part on the representations of the differences.

In some embodiments, block 2414 may be generally similar to block 414 of the flowchart 400 shown in FIG. 5 and may direct the tracker processor 2200 to identify the determined location offset by identifying a candidate location offset of the plurality of candidate location offsets that is associated with a smallest or minimum one of the representations of the differences.

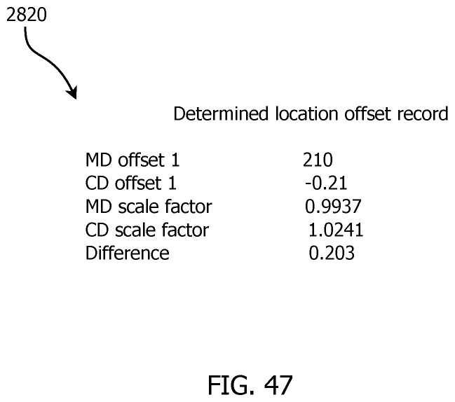

In various embodiments, block 2414 may direct the tracker processor 2200 to store an identified candidate location offset record as a determined location offset record 2820 shown in FIG. 47 in the location 2274 of the storage memory 2204 shown in FIG. 28.

In some embodiments, after block 2414 of the flowchart 2400 shown in FIG. 31 has been completed, the tracker processor 2200 may be directed to return to block 2406 and consider further candidate location offsets near the determined location offset as described herein having regard to the flowchart 400 shown in FIG. 5.

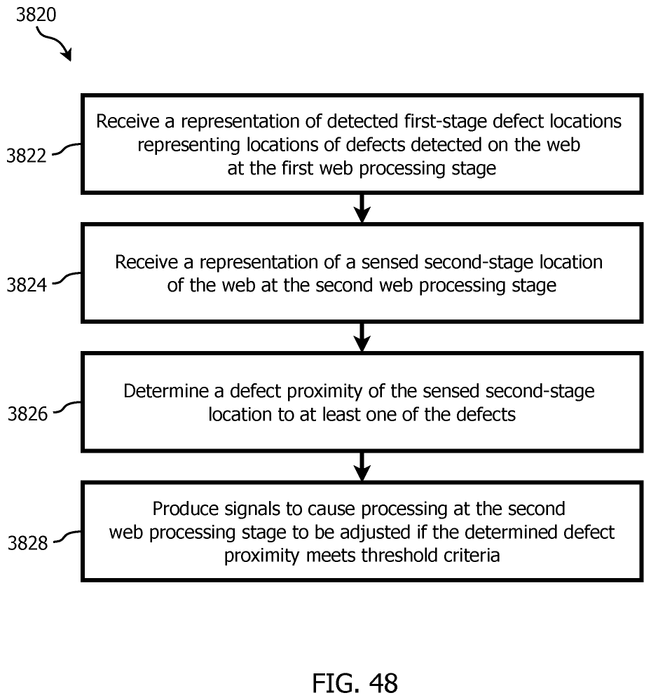

Referring to FIG. 48, there is shown a flowchart 3820 depicting blocks of code that in various embodiments may be executed after or during execution of the flowchart 2400 shown in FIG. 31. In various embodiments, the blocks of code included in the flowchart 3820 may include some elements generally similar to elements included in the flowchart 820 shown in FIG. 22. In various embodiments, the blocks of code shown in FIG. 48 may be included in the block of codes 2206 of the program memory 2202 shown in FIG. 28. In some embodiments, the blocks may be continuously executed as the web 2108 is processed at the second web processing stage 2107 shown in FIG. 1.

Referring to FIG. 48, the flowchart 3820 begins with block 3822, which directs the tracker processor 2200 to receive a representation of detected first-stage defect locations representing locations of defects detected on the web 2108 at the first web processing stage 2105. In various embodiments, block 3822 may be generally similar to block 822 of the flowchart 820 shown in FIG. 22 and block 3822 may direct the tracker processor 2200 to receive, via the interface 2220 of the I/O interface 2212 shown in FIG. 28, a representation of at least one detected first-stage defect location record from the first anomaly detector 2104 and to store the detected first-stage defect location records in the location 2276 of the storage memory 2204 shown in FIG. 28. In some embodiments, the first anomaly detector 2104 may act as a defect detector and may analyze the first-stage images stored in the location 3240 to determine the defect locations before sending representations of the defect locations to the tracker processor 2200 via the interface 3224 of the first anomaly detector 2104 shown in FIG. 29, for example.

Referring back to FIG. 48, block 3824 directs the tracker processor 2200 to receive a representation of a sensed second-stage location of the web at the second web processing stage 2107, the sensed second-stage location representing a current location of the web 2108 at the second web processing stage 2107 shown in FIG. 27. In various embodiments, block 3824 may be generally similar to block 824 described herein and shown in FIG. 22. In various embodiments, block 3824 may direct the tracker processor 200 to receive a representation of the sensed second-stage location via the interface 2226 shown in FIG. 28 from the second location sensor 2126 shown in FIG. 27. In various embodiments, block 3824 may direct the tracker processor 2200 to convert an increasing machine-direction location from the received sensed second-stage location to a decreasing machine-direction location before storing the sensed second-stage location in the location 2278 of the storage memory 2204 shown in FIG. 2.

Referring to FIG. 48, block 3826 directs the tracker processor 2200 to determine a defect proximity of the sensed second-stage location to at least one of the defects based on the determined location offset, the sensed second-stage location of the web, and the one or more detected first-stage defect locations. In some embodiments, the defect proximity may represent how close the location of the web 2108 currently being processed at the second web processing stage 2107 is to a predicted defect in the web 2108.

In some embodiments, block 3826 may direct the tracker processor 200 to determine the defect proximity by applying the determined location offset to the sensed second-stage location to determine an offset sensed location and comparing the one or more detected first-stage defect locations to the offset sensed location. In various embodiments, block 3826 may direct the tracker processor 2200 to read the determined location offset record 2820 shown in FIG. 47 from the location 2274 of the storage memory 2204 shown in FIG. 28 and to determine a machine-direction offset distance as described herein having regard to block 2408 of the flowchart 2400 shown in FIG. 41. In various embodiments, block 3828 may direct the tracker processor 2200 to add or apply the determined machine-direction offset distance to the sensed second-stage location from the location 2278 of the storage memory 2204. In various embodiments, block 3826 may direct the tracker processor 2200 to store the result as an offset sensed location in the location 2280 of the storage memory 2204 shown in FIG. 28.

In various embodiments, block 3826 may direct the tracker processor 2200 to identify one of the first-stage defect locations stored in the location 2276 of the storage memory 2204 shown in FIG. 28 as a closest defect location to the offset sensed location stored in the location 2280 of the storage memory 2204 shown in FIG. 2. In various embodiments, block 3826 may direct the tracker processor 2200 to identify the closest defect location as a closest upcoming defect location by requiring that the identified location have a lower machine-direction location than the offset sensed location. Block 3826 may direct the tracker processor 2200 to determine the defect proximity to be the difference or distance between the offset sensed location and the identified closest first-stage defect location. In some embodiments, block 3826 may direct the tracker processor 2200 to determine the defect proximity as the machine-direction difference or machine-direction distance between the offset sensed location and the identified closest first-stage defect location. In various embodiments, block 3826 may direct the tracker processor 2200 to store the determined defect proximity in the location 2282 of the storage memory 2204 shown in FIG. 28.

Referring back to FIG. 48, in various embodiments, block 3828 directs the tracker processor 2200 to produce signals to cause processing at the second web processing stage 2107 shown in FIG. 27 to be adjusted if the determined defect proximity meets threshold criteria. In various embodiments, block 3828 may be generally similar to block 828 as described herein and shown in FIG. 22. In some embodiments, a threshold distance stored in the location 2284 of the storage memory 2204 may be 2500 m and block 3828 may direct the tracker processor 2200 to produce signals via the interface 2224 shown in FIG. 28 to cause the web processing driver 2130 shown in FIG. 27 to start slowing down when the defect proximity is less than 2500 m and the current second web processing stage is within 2500 m of the next defect location identified in the first-stage defect location records stored in the location 2276, for example.

In various embodiments, as described herein having regard to block 828 of the flowchart 800 shown in FIG. 22, the threshold distance may be dependent on various factors, including, for example, a speed at which the web 2108 is traveling.

In various embodiments, the first and second anomaly detectors 2104 and 2106 may be configured to perform calibration generally similar to as described having regard to the flowchart 940 shown in FIG. 25, but modified to use any or all of the elements/principles described herein having regard to the flowcharts 2500 and/or 2590 shown in FIGS. 32 and 36. For example, in some embodiments, the flowchart 940 shown in FIG. 25 may include code for applying pixel specific anomaly identifying thresholds, each associated with a respective pixel position as described herein having regard to the flowchart 2500.

In various embodiments, a system that functions generally similarly to the system 100 shown in FIG. 1 and/or the system 2100 shown in FIG. 27 may include a single device that combines the functionality of the position tracker, the first anomaly detector and/or the second anomaly detector. In various embodiments, a system that functions generally similarly to the system 100 shown in FIG. 1 and/or the system 2100 shown in FIG. 27 may include multiple separate devices that are configured to perform different parts of the functionality described herein as performed by one of the position tracker, the first anomaly detector, and/or the second anomaly detector.

In various embodiments, a system generally similarly to the system 100 shown in FIG. 1 and/or the system 2100 shown in FIG. 27 may include one or more defect detectors separate from the first anomaly detector and configured to perform defect detection and/or determining defect locations at the first web processing stage. For example, in some embodiments, the defect detector may be configured to detect defect locations and to send representations of defect location records to a position tracker, the position tracker configured to execute blocks similar to those included in the flowchart 820 shown in FIG. 22. In some embodiments, it may be beneficial to combine functionality that is required for both anomaly detection and defect detection, such as image pre-processing, for example.

In various embodiments, the difference between the matched locations determined at block 410 of FIG. 15 and/or at block 2410 of FIG. 41 and/or the representation thereof determined at block 412 or block 2412 may be determined using another difference and/or representation of the difference, such as for example, by using an alternative cost function.

In various embodiments, machine-direction and cross-direction offsets that are expected to be unusual may be penalized relatively more. For example, in some embodiments, it may be possible, but unlikely, that a very large amount of paper is removed from the surface of a reel before unwinding is started (possibly on another winder machine, for example). In some embodiments, it may be beneficial to make such situations be detectable, but only if there is relatively more evidence (than is required to identify offsets that are smaller in magnitude).

In various embodiments, the flowchart 400 shown in FIG. 5 and/or the flowchart 2400 shown in FIG. 31 may include a block of codes for directing the tracker processor 200 or 2200 to set limits such that if the determined location offset is outside the limits (for example, the discovered machine-direction or cross-direction offset or one of the scale factors is not physically realistic), then the determined location offset may be deemed invalid. In various embodiments, the block of codes may direct the tracker processor 200 or 2200 to generate an alert to be transmitted to a user and/or to the web processing driver to indicate that synchronization may have been lost. In various embodiments, the web processing driver may have been configured to not adjust processing in such situations, for example. In some embodiments, in response, the web processing driver may stop automatic processing, and instead prompt and/or require that a user engages and controls the second web processing stage manually, for example until a valid determined location offset has been found again.

In some embodiments, after block 414 of the flowchart 400 shown in FIG. 5 and/or block 2414 of the flowchart 2400 shown in FIG. 31 has been completed, the tracker processor 200 or 2200 may be directed to return to block 406 or 2406 and consider a further candidate location offset near the determined location offset. In various embodiments, blocks 406, 407, and 412 and/or blocks 2406, 2407, and 2412 may be repeated with a further denser grid near the determined location offset, and a new determined location offset may be found when block 414 and/or 2414 is executed once more. In some embodiments, additional denser grids may be used.

In some embodiments, block 2664 shown in FIG. 40 may direct the tracker processor 2200 to divide the entire unwinding length seen so far into M equally-spaced (in machine direction) areas or lengths, and then choose for the subset an equal number of anomalies from each area or length. In some embodiments, when the desired subset size is not divisible by M, the number of anomalies from each area may not be equal, but instead there may be 1 more anomaly from areas where the next anomaly to be considered for inclusion is relatively more severe. In some embodiments, if there are no anomalies in some area, then a corresponding number of anomalies may be selected from other areas. For example, if 2 kilometers of the web 2108 has been unwound so far, and a desired area count is 20, then the 2 kilometers may be evenly divided into sections of 100 meters. If it is desirable for 500 anomalies to be chosen, for example, then the 25 most severe anomalies from each 100-meter section may be selected for the subset.

In some embodiments, it may be beneficial to similarly divide the total observed width into K equally-spaced (in cross-direction) areas, and then proceeding generally similarly as outlined above for the M equally-spaced (in machine direction) areas. This may be useful in cases where long “streaks” of anomalies may be occurring at particular cross-direction positions. In some embodiments, the entire area may be divided into MK areas, so that the impact (on matching the anomaly location maps) caused by both bursts and streaks of anomalies can be mitigated.

In various embodiments, after block 414 of the flowchart 400 shown in FIG. 5 and/or block 2414 of the flowchart 2400 shown in FIG. 31 has been completed, the tracker processor 200 or 2200 may be directed to calculate a gradient of the cost or difference function with respect to the parameters in the determined location offset. In various embodiments, the tracker processor 200 or 2200 may be directed to make a gradient descent step, i.e., find a new determined location offset as a vector sum of the determined location offset minus the gradient multiplied by a small scalar constant, such as 0.01, for example. In various embodiments, the tracker processor may then be directed to calculate a gradient of the cost function in the new determined location offset, and make a new gradient descent step. In various embodiments, gradient descent steps may be repeated for a pre-configured number of steps, for example, and/or until some convergence criterion is met. In some embodiments, gradient descent steps may be repeated for 100 steps, for example.

In various embodiments, instead of or in addition to using the above-described gradient descent method to find a new determined location offset, the tracker processor 200 or 2200 may be configured to perform optimization using alternative and/or more elaborate methods. For example, in various embodiments, the optimization method may use second-order information about the cost function. In some embodiments, the tracker processor 200 or 2200 may be configured to establish a new determined location offset by finding a minimum of the cost function using the Broyden-Fletcher-Goldfarb-Shanno optimization algorithm, for example.

In various embodiments, various combinations of the above-noted ways of choosing candidate location offsets may be used, such as, for example, where a first process is used to get a first determined location offset and further processes are applied near the first determined location offset to approach better determined location offsets.

While in various embodiments disclosed herein, the first and second anomaly detectors may receive machine-direction position or location information associated with each of the first-stage and second-stage images and the received machine-direction position may be used to determine anomaly locations for each image, in some embodiments, machine-direction position or location information for each anomaly may be derived from the images themselves. In some embodiments, dedicated location sensors may be omitted from the system 100 or 2100 shown in FIGS. 1 and 27 when the locations of anomalies may be derived from the image(s) of the web.

In some embodiments, the first-stage anomaly identifying sensitivity and/or the second-stage anomaly identifying sensitivity may be kept unchanged.

Accordingly, in various embodiments, blocks 506 and 508 of the flowchart 500 shown in FIG. 6 may be omitted and/or blocks 596 and 598 of the flowchart 590 shown in FIG. 10 may be omitted. In various embodiments, blocks 2506 and 2508 of the flowchart 2500 shown in FIG. 32 may be omitted and/or blocks 2596 and 2598 of the flowchart 2590 shown in FIG. 36 may be omitted.

In various embodiments, the first-stage anomaly locations and the second-stage anomaly locations may be switched and/or processed interchangeably. For example, in some embodiments, block 408 of the flowchart 400 shown in FIG. 5 may direct the tracker processor 200 to apply the candidate location offset to the second-stage anomaly locations to determine offset second-stage anomaly locations and block 410 may direct the tracker processor 200 to determine a difference between the offset second-stage anomaly locations and the first-stage anomaly locations. In various embodiments, similar switching may be done in the system 2100 shown in FIG. 27.

In various embodiments, blocks 404 and 406, 407, 412, and 414 of the flowchart 400 shown in FIG. 5 or 2404 and 2406, 2407, 2412, and 2414 of the flowchart 2400 shown in FIG. 31 may be executed continuously as the web is processed and further second-stage anomaly locations are received, such that the second-stage anomaly location records stored in the location 256 or 2256 of the storage memory 204 or 2204 are continuously added to and/or updated and the resulting data including a determined location offset record is continuously updated.

In various embodiments, the position tracker 102 or 2102 or a tracker generally similar to the position tracker 102 or 2102 may be included in a system for facilitating web tracking on sites other than paper mills producing paper products. For example, in various embodiments, the position tracker 102 or 2102 may facilitate tracking of liquid packaging board production between a board machine, one or more winder machines, and/or one or more rewinder machines. In various embodiments, the position tracker 102 or 2102 may facilitate tracking of tissue paper products between a tissue paper machine, and one or more converting lines. In some embodiments, the position tracker 102 or 2102 may facilitate tracking steel coils, or other metal coils, between different processing stages. In various embodiments, the web 108 and/or the web 2108 may include a paper web, a board web, a tissue paper web, a laminate web, a fiberglass mat, a metal strip, and/or another product that may contain minor imperfections and/or other landmarks that may be identifiable as anomalies in order to facilitate matching and/or tracking as described herein.

In various embodiments, the machine-direction offset stored in the machine-direction offset field of the determined location offset record may be used without considering cross-direction to determine predicted defect locations in the second web processing stage during processing. In various embodiments, this may reduce on computing requirements and may still provide satisfactory results. In various such embodiments, the candidate location offset may include a machine-direction scale factor, but not a cross-direction scale factor.

In some embodiments, the system 100 shown in FIG. 1 and/or the system 2100 shown in FIG. 27 may include a further location sensor for sensing position of the web at or near the second web processing stage. In various embodiments, block 826 of the flowchart 820 shown in FIG. 22 may direct the tracker processor 200 to receive the current location of the web 108 from the further location sensor.

In some embodiments, block 504 of the flowchart 500 shown in FIG. 6 or block 2504 of the flowchart 2500 shown in FIG. 32 may direct the detector processor 1200 or 3200 to calculate the difference as: new pixel value-reference pixel value. In various embodiments, an absolute value of the determined difference may be used as the anomalousness index value.

In various embodiments, instead of an anomaly density based on a count of anomalies, block 506 of the flowchart 500 shown in FIG. 6 may direct the detector processor 1200 to determine an anomalous-pixels density associated with the first first-stage anomaly identifying sensitivity. In various embodiments, block 506 of the flowchart 500 shown in FIG. 6 may direct the detector processor 1200 to determine the at least one anomaly density by determining a count of anomalous pixels included in anomalies represented by the first set of the plurality of first-stage anomaly locations. In various embodiments, block 506 may direct the detector processor 1200 to determine an anomalous-pixels density as anomalous pixels per length of the web 108 or as anomalous pixels per area of the web. In various such embodiments, block 508 may direct the detector processor 1200 to adjust the anomaly identifying threshold such that the anomaly identifying threshold is more sensitive if fewer anomalous pixels than desired are represented by the anomalous-pixels density or to adjust the anomaly identifying sensitivity such that the anomaly identifying sensitivity is less sensitive (and thus a higher threshold, for example) if more anomalous pixels than desired are represented by the anomalous-pixels density. For example, in some embodiments, a desired anomalous-pixels density may be 0.00001 pixels/meter*1600*800=12.8 pixels per meter. In various embodiments, block 596 may direct the detector processor 1400 to determine an anomalous-pixels density associated with the first second-stage anomaly identifying sensitivity in a way that is generally similar to that described above for the first first-stage anomaly identifying sensitivity.

In various embodiments, it may be possible to efficiently calculate in retrospect a new sensitivity or threshold that would have given the desired anomaly density. In various embodiments, the anomaly identifying sensitivity can be updated accordingly, for example using exponential smoothing, or FESSA.

In various embodiments, principles and/or features or elements of the systems 100 and 2100 shown in FIGS. 1 and 27 are described herein for exemplary purposes and may be interchangeable between the systems. In various embodiments, any or all of the principles and/or features or elements of the system 2100 may be incorporated in the system 100 and vice versa.

In various embodiments, the flowchart 940 shown in FIG. 25 or code generally similar to the flowchart 940 shown in FIG. 25 may be modified to incorporate functionality described herein having regard to the flowchart 500 shown in FIG. 6, the flowchart 590 shown in FIG. 10, the flowchart 2500 shown in FIG. 32, and/or the flowchart 2590 shown in FIG. 36. In various embodiments, the flowchart 940 shown in FIG. 25 or code generally similar to the flowchart 940 shown in FIG. 25 may be modified in any or all of the ways described herein having regard to the flowchart 500 shown in FIG. 6, the flowchart 590 shown in FIG. 10, the flowchart 2500 shown in FIG. 32, and/or the flowchart 2590 shown in FIG. 36.

In some embodiments, any or all of the cameras may include one or more line-scan cameras. In various such embodiments, the corresponding images may include 2048×1 pixels, for example.

While specific embodiments of the present disclosure have been described and illustrated, such embodiments should be considered illustrative of the present disclosure only and not as limiting the present disclosure as construed in accordance with the accompanying claims.

1. A method for facilitating web position tracking, the method comprising:
receiving a representation of a plurality of first-stage anomaly locations representing locations of anomalies detected on a web at a first web processing stage;
receiving a representation of a plurality of second-stage anomaly locations representing locations of anomalies detected on the web at a second web processing stage;
for each of a plurality of different candidate location offsets:
comparing the candidate location offset to the plurality of first-stage anomaly locations and the plurality of second-stage anomaly locations to determine a representation of a difference to be associated with the candidate location offset; and
associating the representation of the difference with the candidate location offset; and
identifying a determined location offset from the candidate location offsets based at least in part on the representations of the differences.

2. The method of claim 1 wherein comparing the candidate location offset to the plurality of first-stage anomaly locations and the plurality of second-stage anomaly locations comprises:
applying the candidate location offset to the plurality of first-stage anomaly locations to determine a plurality of offset first-stage anomaly locations; and
determining the difference between the plurality of offset first-stage anomaly locations and the plurality of second-stage anomaly locations.

3. The method of claim 2 wherein determining the difference comprises determining a respective offset difference for each of the plurality of offset first-stage anomaly locations.

4. The method of claim 2 wherein applying the candidate location offset comprises, for each of the plurality of first-stage anomaly locations, determining at least one candidate offset distance adjusted based on a location of the first-stage anomaly location and adding the at least one candidate offset distance to the first-stage anomaly location.

5. The method of claim 1 wherein comparing the candidate location offset to the plurality of first-stage anomaly locations and the plurality of second-stage anomaly locations comprises:
applying the candidate location offset to the plurality of second-stage anomaly locations to determine a plurality of offset second-stage anomaly locations; and
determining the difference between the plurality of offset second-stage anomaly locations and the plurality of first-stage anomaly locations.

6. The method of claim 5 wherein determining the difference comprises determining a respective offset difference for each of the plurality of offset second-stage anomaly locations.

7. The method of claim 5 wherein applying the candidate location offset comprises, for each of the plurality of second-stage anomaly locations, determining at least one candidate offset distance adjusted based on a location of the second-stage anomaly location and adding the at least one candidate offset distance to the second-stage anomaly location.

8. The method of claim 3 wherein comparing the candidate location offset to the plurality of first-stage anomaly locations and the plurality of second-stage anomaly locations comprises, for each of the offset differences, determining a respective weighted offset difference based on the offset difference and an anomaly weight associated with the offset difference.

9. The method of claim 8 comprising, for each of the offset differences, determining the respective associated anomaly weight based on a severity of an anomaly from which the associated offset difference was determined.

10. The method of claim 1 wherein receiving the representation of the plurality of second-stage anomaly locations comprises receiving a representation of a plurality of candidate second-stage anomaly locations and determining the plurality of second-stage anomaly locations as a subset of the plurality of candidate second-stage anomaly locations.

11. The method of claim 10 wherein determining the plurality of second-stage anomaly locations comprises ranking the plurality of candidate second-stage anomaly locations and choosing the subset as one or more highest ranking candidate second-stage anomaly locations.

12. The method of claim 11 wherein ranking the plurality of candidate second-stage anomaly locations comprises ranking each of the plurality of candidate second-stage anomaly locations based at least in part on a proximity of the second-stage anomaly location to a location of the web currently at the second web processing stage.

13. The method of claim 11 wherein ranking the plurality of candidate second-stage anomaly locations comprises ranking each of the plurality of candidate second-stage anomaly locations based at least in part on a severity of an anomaly associated with the second-stage anomaly location.

14. The method of claim 1 wherein the second web processing stage is downstream of the first web processing stage.

15. The method of claim 1 wherein identifying the determined location offset comprises identifying a candidate location offset of the plurality of candidate location offsets that is associated with a smallest one of the representations of the differences.

16. The method of claim 1 wherein:
receiving the representation of the plurality of first-stage anomaly locations comprises:
receiving one or more sets of first-stage images of the web at the first web processing stage; and
determining the plurality of first-stage anomaly locations based at least in part on application of at least one first-stage anomaly identifying sensitivity to the one or more sets of first-stage images.

17. The method of claim 16 wherein:
the one or more sets of first-stage images include a first set of first-stage images and a second set of first-stage images;
the at least one first-stage anomaly identifying sensitivity includes a first first-stage anomaly identifying sensitivity and a second first-stage anomaly identifying sensitivity, the second first-stage anomaly identifying sensitivity being different from the first first-stage anomaly identifying sensitivity; and
determining the plurality of first-stage anomaly locations comprises:
determining a first set of first-stage anomaly locations based at least in part on application of the first first-stage anomaly identifying sensitivity to the first set of first-stage images; and
determining a second set of first-stage anomaly locations based at least in part on application of the second first-stage anomaly identifying sensitivity to the second set of first-stage images.

18. The method of claim 17 wherein each of the first and second first-stage anomaly identifying sensitivities includes a plurality of anomaly identifying thresholds, each associated with a respective pixel position.

19. The method of claim 17 comprising determining at least one anomaly density associated with the first first-stage anomaly identifying sensitivity and determining the second first-stage anomaly identifying sensitivity based at least in part on the at least one anomaly density associated with the first first-stage anomaly identifying sensitivity and the first first-stage anomaly identifying sensitivity.

20. The method of claim 19 wherein determining the at least one anomaly density comprises determining a count of anomalies represented by the first set of the plurality of first-stage anomaly locations.

21. The method of claim 19 wherein determining the at least one anomaly density comprises determining at least one count of anomalous pixels included in anomalies represented by the first set of the plurality of first-stage anomaly locations.

22. The method of claim 19 comprising determining at least one difference between the at least one anomaly density associated with the first first-stage anomaly identifying sensitivity and a desired first-stage anomaly density and wherein determining the second first-stage anomaly identifying sensitivity comprises determining the second first-stage anomaly identifying sensitivity based at least in part on the determined at least one difference.

23. The method of claim 22 wherein:
receiving the representation of the plurality of second-stage anomaly locations comprises:
receiving one or more sets of second-stage images of the web at the second web processing stage; and
determining the plurality of second-stage anomaly locations based at least in part on application of at least one second-stage anomaly identifying sensitivity to the one or more sets of second-stage images;
the one or more sets of second-stage images include a first set of second-stage images and a second set of second-stage images;
the at least one second-stage anomaly identifying sensitivity includes a first second-stage anomaly identifying sensitivity and a second second-stage anomaly identifying sensitivity;
determining the plurality of second-stage anomaly locations comprises:
determining a first set of second-stage anomaly locations based at least in part on application of the first second-stage anomaly identifying sensitivity to the first set of second-stage images; and
determining a second set of second-stage anomaly locations based at least in part on application of the second second-stage anomaly identifying sensitivity to the second set of second-stage images;
the method comprises determining at least one anomaly density associated with the first second-stage anomaly identifying sensitivity and determining the second second-stage anomaly identifying sensitivity based at least in part on the at least one anomaly density associated with the first second-stage anomaly identifying sensitivity and the first second-stage anomaly identifying sensitivity;
the method comprises determining a difference between the at least one anomaly density associated with the first second-stage anomaly identifying sensitivity and a desired second-stage anomaly density, the desired second-stage anomaly density being less than 90% of the desired first-stage anomaly density; and
determining the second second-stage anomaly identifying sensitivity comprises determining the second second-stage anomaly identifying sensitivity based at least in part on the determined difference between the at least one anomaly density associated with the first second-stage anomaly identifying sensitivity and the desired second-stage anomaly density.

24. The method of claim 23 wherein determining the at least one anomaly density associated with the first second-stage anomaly identifying sensitivity comprises determining a count of anomalous pixels included in anomalies represented by the first set of the plurality of second-stage anomaly locations.

25. The method of claim 23 wherein determining the at least one anomaly density associated with the first second-stage anomaly identifying sensitivity comprises determining a count of anomalies represented by the first set of the plurality of second-stage anomaly locations.

26. The method of claim 23 wherein each of the first and second second-stage anomaly identifying sensitivities includes a plurality of anomaly identifying thresholds, each associated with a respective pixel position.

27. The method of claim 1 wherein:
receiving the representation of the plurality of second-stage anomaly locations comprises:
receiving one or more sets of second-stage images of the web at the second web processing stage; and
determining the plurality of second-stage anomaly locations based at least in part on application of at least one second-stage anomaly identifying sensitivity to the one or more sets of second-stage images.

28. The method of claim 27 wherein:
the one or more sets of second-stage images include a first set of second-stage images and a second set of second-stage images;
the at least one second-stage anomaly identifying sensitivity includes a first second-stage anomaly identifying sensitivity and a second second-stage anomaly identifying sensitivity, the second second-stage anomaly identifying sensitivity being different from the first second-stage anomaly identifying sensitivity; and
determining the plurality of second-stage anomaly locations comprises:
determining a first set of second-stage anomaly locations based at least in part on application of the first second-stage anomaly identifying sensitivity to the first set of second-stage images; and
determining a second set of second-stage anomaly locations based at least in part on application of the second second-stage anomaly identifying sensitivity to the second set of second-stage images.

29. The method of claim 28 comprising determining at least one anomaly density associated with the first second-stage anomaly identifying sensitivity and determining the second second-stage anomaly identifying sensitivity based at least in part on the at least one anomaly density associated with the first second-stage anomaly identifying sensitivity and the first second-stage anomaly identifying sensitivity.

30. The method of claim 29 wherein determining the at least one anomaly density comprises determining a count of anomalies represented by the first set of the plurality of second-stage anomaly locations.

31. The method of claim 29 wherein determining the at least one anomaly density comprises determining at least one count of anomalous pixels included in anomalies represented by the first set of the plurality of second-stage anomaly locations.

32. The method of claim 29 comprising determining at least one difference between the at least one anomaly density associated with the first second-stage anomaly identifying sensitivity and a desired second-stage anomaly density and wherein determining the second second-stage anomaly identifying sensitivity comprises determining the second second-stage anomaly identifying sensitivity based at least in part on the determined at least one difference.

33. The method of claim 28 wherein each of the first and second first-stage anomaly identifying sensitivities includes a plurality of anomaly identifying thresholds, each associated with a respective pixel position.

34. The method of claim 1 comprising:
receiving a calibration set of first-stage images of the web at the first web processing stage;
determining at least one first-stage calibration anomaly density based at least in part on application of a first-stage calibration anomaly identifying sensitivity to the calibration set of first-stage images; and
determining a calibration-based first-stage anomaly identifying sensitivity based at least in part on the first-stage calibration anomaly identifying sensitivity and the at least one first-stage calibration anomaly density.

35. The method of claim 34 wherein determining the at least one first-stage calibration anomaly density comprises:
determining a first-stage calibration set of anomaly locations based at least in part on application of the calibration first-stage anomaly identifying sensitivity to the calibration set of first-stage images; and
determining a count of anomalies represented by the first-stage calibration set of anomaly locations.

36. The method of claim 34 wherein determining the at least one first-stage calibration anomaly density comprises determining a count of anomalous pixels included in anomalies included in the calibration set of first-stage images.

37. The method of claim 34 wherein each of the first-stage calibration anomaly identifying sensitivity and the calibration-based first-stage anomaly identifying sensitivities includes a plurality of anomaly identifying thresholds, each associated with a respective pixel position.

38. The method of claim 34 wherein determining the calibration-based first-stage anomaly identifying sensitivity comprises determining at least one difference between the at least one first-stage calibration anomaly density and a desired first-stage calibration anomaly density and determining the calibration-based first-stage anomaly identifying sensitivity based at least in part on the determined at least one difference.

39. The method of claim 34 wherein the first set of first-stage images includes at least one of the calibration set of first-stage images.

40. The method of claim 39 wherein the first set of first-stage images and the calibration set of first-stage images are the same images.

41. The method of claim 1 comprising:
receiving a representation of one or more detected first-stage defect locations representing locations of defects detected on the web at the first web processing stage;
receiving a representation of a sensed second-stage location of the web at the second web processing stage, the sensed second-stage location representing a current location of the web at the second web processing stage;
determining a defect proximity of the sensed second-stage location to at least one of the defects based on the determined location offset, the sensed second-stage location of the web, and the one or more detected first-stage defect locations; and
producing signals to cause processing at the second web processing stage to be adjusted if the determined defect proximity meets threshold criteria.

42. The method of claim 41 wherein determining the defect proximity comprises applying the determined location offset to the one or more detected first-stage defect locations to determine one or more predicted second-stage defect locations representing locations of defects predicted for the web at the second web processing stage and comparing the one or more predicted second-stage defect locations to the sensed second-stage location.

43. The method of claim 41 wherein determining the defect proximity comprises applying the determined location offset to the sensed second-stage location to determine an offset sensed location and comparing the one or more detected first-stage defect locations to the offset sensed location

44. A system for facilitating web position tracking, the system comprising at least one processor configured to:
receive a representation of a plurality of first-stage anomaly locations representing locations of anomalies detected on a web at a first web processing stage;
receive a representation of a plurality of second-stage anomaly locations representing locations of anomalies detected on the web at a second web processing stage;
for each of a plurality of different candidate location offsets:
compare the candidate location offset to the plurality of first-stage anomaly locations and the plurality of second-stage anomaly locations to determine a representation of a difference to be associated with the candidate location offset; and
associate the representation of the difference with the candidate location offset; and
identify a determined location offset from the candidate location offsets based at least in part on the representations of the differences.

45. A non-transitory computer-readable medium having stored thereon codes that when executed by at least one processor cause the at least one processor to:
receive a representation of a plurality of first-stage anomaly locations representing locations of anomalies detected on a web at a first web processing stage;
receive a representation of a plurality of second-stage anomaly locations representing locations of anomalies detected on the web at a second web processing stage;
for each of a plurality of different candidate location offsets:
compare the candidate location offset to the plurality of first-stage anomaly locations and the plurality of second-stage anomaly locations to determine a representation of a difference to be associated with the candidate location offset; and
associate the representation of the difference with the candidate location offset; and
identify a determined location offset from the candidate location offsets based at least in part on the representations of the differences.

46. A system for facilitating web position tracking, the system comprising:
means for receiving a representation of a plurality of first-stage anomaly locations representing locations of anomalies detected on a web at a first web processing stage;
means for receiving a representation of a plurality of second-stage anomaly locations representing locations of anomalies detected on the web at a second web processing stage;
means for, for each of a plurality of different candidate location offsets:
comparing the candidate location offset to the plurality of first-stage anomaly locations and the plurality of second-stage anomaly locations to determine a representation of a difference to be associated with the candidate location offset; and
associating the representation of the difference with the candidate location offset; and
means for identifying a determined location offset from the candidate location offsets based at least in part on the representations of the differences.
